(19) United States
(12) Patent Application Publication
(10) Pub. No.: US 2022/0306812 A1
(43) Pub. Date: Sep. 29, 2022

(54) COVALENT ORGANIC FRAMEWORK AND METHODS OF FABRICATION AND USES THEREOF

(71) Applicant: National University of Singapore, Singapore (SG)

(72) Inventors: Kian Ping Loh, Singapore (SG); Xing Li, Singapore (SG)

(21) Appl. No.: 17/603,682

(22) PCT Filed: Apr. 15, 2020
(86) PCT No.: PCT/SG20/50236

§ 371 Date: Oct. 14, 2021

(30) Foreign Application Priority Data
Apr. 15, 2019 (SG) 10201903377U

(51) Int. Cl. C08G 83/00; C08G 12/06

(52) U.S. Cl. CPC C08G 83/008; C08G 12/06

(57) ABSTRACT

The present invention relates to, in general, methods of fabricating a covalent organic framework (COF) and the COF thereof. In particular, the method comprises forming an acylhydrazone bond with an optionally substituted 2-alkoxybenzohydrazidyl moiety. The resultant COF has an x-ray diffraction 2-theta peak at about 3° with a full width half maximum (FWHM) of about 0.2° to about 0.4°.

### TECHNICAL FIELD

The present invention relates, in general terms, to covalent organic frameworks (COFs). The present invention also relates to methods of fabricating COFs and its uses thereof.

### BACKGROUND

Covalent organic frameworks (COFs) are small organic molecular building units that can be extended into highly ordered, porous frameworks via strong covalent interactions. These frameworks can be held together by interlayer reversible bonds. Extensive research has been conducted to construct COFs with different topologies, ranging from two- and three-dimensional (2D and 3D, respectively) to interwoven structures. COFs find use in a wide variety of applications due to its low densities, high surface areas and thermal stabilities, such as in gas separation, energy storage, emission, catalysis, ion conduction, drug delivery and nonlinear optics. COFs can also be functionalized into lightweight materials for diverse applications. Despite considerable advances, the practical application of COFs is hampered by a lack of scalable synthesis methods, such as slow growth rate (e.g. over several days) and poor crystallinity.

The challenging aspect of COF synthesis is that the crystallization process competes with the more facile polymerization process. To suppress random polymerization, the crystallization process must proceed under self-correcting conditions, where the bonds can be dynamically repaired. This is necessary to minimize defects and to form crystalline materials. Currently, the growth of highly crystalline COFs usually takes from 3 to 7 days to more than a month under sealed, undisturbed conditions, and only limited quantities (<100 mg) can be synthesized at any one time.

The growth of covalent COF crystals relies on short range and long range bonding forces. In the synthesis of two dimensional (2D) COF, the stacking of layers of COF has to be highly regular to ensure good crystallinity. Research focus in the past has mainly looked at the type of in-plane (short range) linkages used for linking the COF crystals in the 2-D plane, these include for example, boronate ester type linkages and imine type linkages. The interactions between the layers out-of-plane are attributed to mainly π-π interactions and accounts for the long range bonding. During the growth of COF, both in-plane growth as well as out-of-plane growth must proceed well to ensure good crystallinity. Most research efforts thus far have focused on the in-plane growth, and little is known about how out-of-plane forces control the growth.

A molecular docking sites strategy and synchronized offset stacking strategy have previously been proposed for constructing highly crystalline COF. However the growth rate of such strategies is slow and not suitable for scaling up. A hydrogen bonding assisted growth of COF has also been explored using a 2-hydroxylbenzoaldehyde moiety, however the short linkage and localized conjugation inhibit the linkage from twisting to form hydrogen bonding vertically between planes.

Accordingly, there is a need for improving the design of the building blocks to ensure fast crystallization without compromising the crystallinity of COFs.

Currently, the most reliable way to synthesize COFs is through freeze-pump-thaw techniques and under sealed solvothermal conditions, which are not cost-effective for scalable production. Therefore, there is the need for a robust and cost effective method to produce high-quality COFs beyond the laboratory scale.

In particular, there is a need for large scale production of hydrazone-linked COFs. However, the structures of hydrazone COFs reported to date are rather limited and the reported synthesis time typically requires 3 days. This is not viable for an industrial process.

It would be desirable to overcome or alleviate at least one of the above-described problems, or at least to provide a useful alternative.

### SUMMARY

Disclosed are methods and compositions for the design and synthesis of building blocks (monomers) that enable covalent organic framework (COF) crystal to grow in a short amount of time with high crystallinity. This is based on the inventor's understanding that incorporating specific moieties which can undergo hydrogen bonding in the plane and out of the plane can assist in inter-planar assembly and accordingly crystal growth. In particular, the inventors have found that using optionally substituted 2-alkoxybenzohydrazide containing building unit to form dispersive inter-planar hydrogen bonding, allows for COF assembly which can be observed as crystal formation at least 15 to 30 mins after synthesis. This allows for large scale production of homogeneous, high crystallinity and quality COF under robust condition with stirring and open to air. This also fulfils commercial requirements such as simple synthetic conditions, high quality control, and efficient cost.

The present invention provides a method of fabricating a covalent organic framework (COF), comprising:

stirring a first monomer comprising an optionally substituted 2-alkoxybenzohydrazidyl moiety with second monomer comprising a benzaldehydyl moiety under heat and in open air for at least 15 min in order to form an acylhydrazone bond;

wherein the COF is formable after about 15 min; and

wherein the optionally substituted 2-alkoxybenzohydrazidyl moiety is selected from optionally substituted 2-(C₁-C₆)alkoxybenzohydrazidyl or 2-benzyloxybenzohydrazidyl.

The present invention provides a method of fabricating a covalent organic framework (COF), comprising:

stirring a first monomer comprising an optionally substituted 2-alkoxybenzohydrazidyl moiety with second monomer comprising a benzaldehydyl moiety under heat and in open air for at least 15 min in order to form an acylhydrazone bond;

wherein the COF is formable after about 15 min; and

wherein the optionally substituted 2-alkoxybenzohydrazidyl moiety is selected from optionally substituted 2-(C₃-C₆)alkoxybenzohydrazidyl or 2-benzyloxybenzohydrazidyl.

In some embodiments, the first monomer is selected from one of the following:

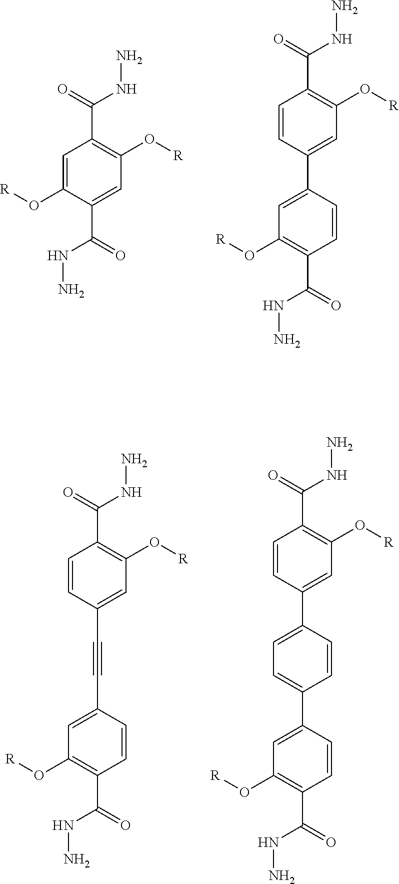

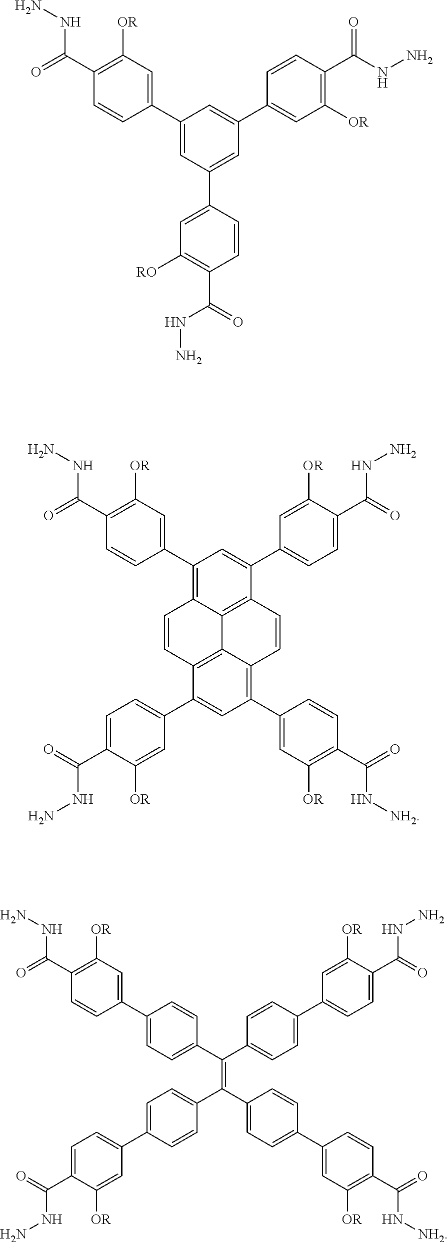

In some embodiments, the optionally substituted 2-alkoxybenzohydrazidyl moiety is optionally substituted 2-(C₃)alkoxybenzohydrazidyl or 2-benzyloxybenzohydrazidyl.

In some embodiments, the optionally substituted 2-alkoxybenzohydrazidyl moiety is 2-propoxybenzohydrazidyl, 2-allyloxybenzohydrazidyl, 2-propargyloxybenzohydrazidyl or 2-benzyloxybenzohydrazidyl.

In some embodiments, the second monomer is selected from:

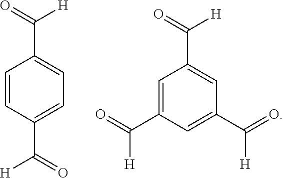

In some embodiments, the stirring is performed under heat at not less than 100° C.

In some embodiments, stirring is performed in the presence of 17M acetic acid at about 1:50 (V/Vₛₒₗᵥₑₙₜ).

The present invention also provides a method of fabricating a covalent organic framework (COF), comprising:

stirring a first monomer comprising an optionally substituted 2-alkoxybenzohydrazidyl moiety with second monomer comprising a benzaldehydyl moiety under heat and in open air for at least 15 min in order to form an acylhydrazone bond;

wherein the COF is formable after about 15 min;

wherein the first monomer and the second monomer has a total topicity of at least 5;

wherein the first monomer and the second monomer both independently have a conjugated pi bond system; and

wherein the optionally substituted 2-alkoxybenzohydrazidyl moiety is selected from optionally substituted 2-(C₁-C₆)alkoxybenzohydrazidyl or 2-benzyloxybenzohydrazidyl.

The present invention also provides a method of fabricating a covalent organic framework (COF), comprising:

stirring a first monomer comprising an optionally substituted 2-alkoxybenzohydrazidyl moiety with second monomer comprising a benzaldehydyl moiety under heat and in open air for at least 15 min in order to form an acylhydrazone bond;

wherein the COF is formable after about 15 min;

wherein the first monomer and the second monomer has a total topicity of at least 5;

wherein the first monomer and the second monomer both independently have a conjugated pi bond system; and

wherein the optionally substituted 2-alkoxybenzohydrazidyl moiety is selected from optionally substituted 2-(C₃-C₆)alkoxybenzohydrazidyl or 2-benzyloxybenzohydrazidyl.

In some embodiments, first monomer is selected from one of the following:

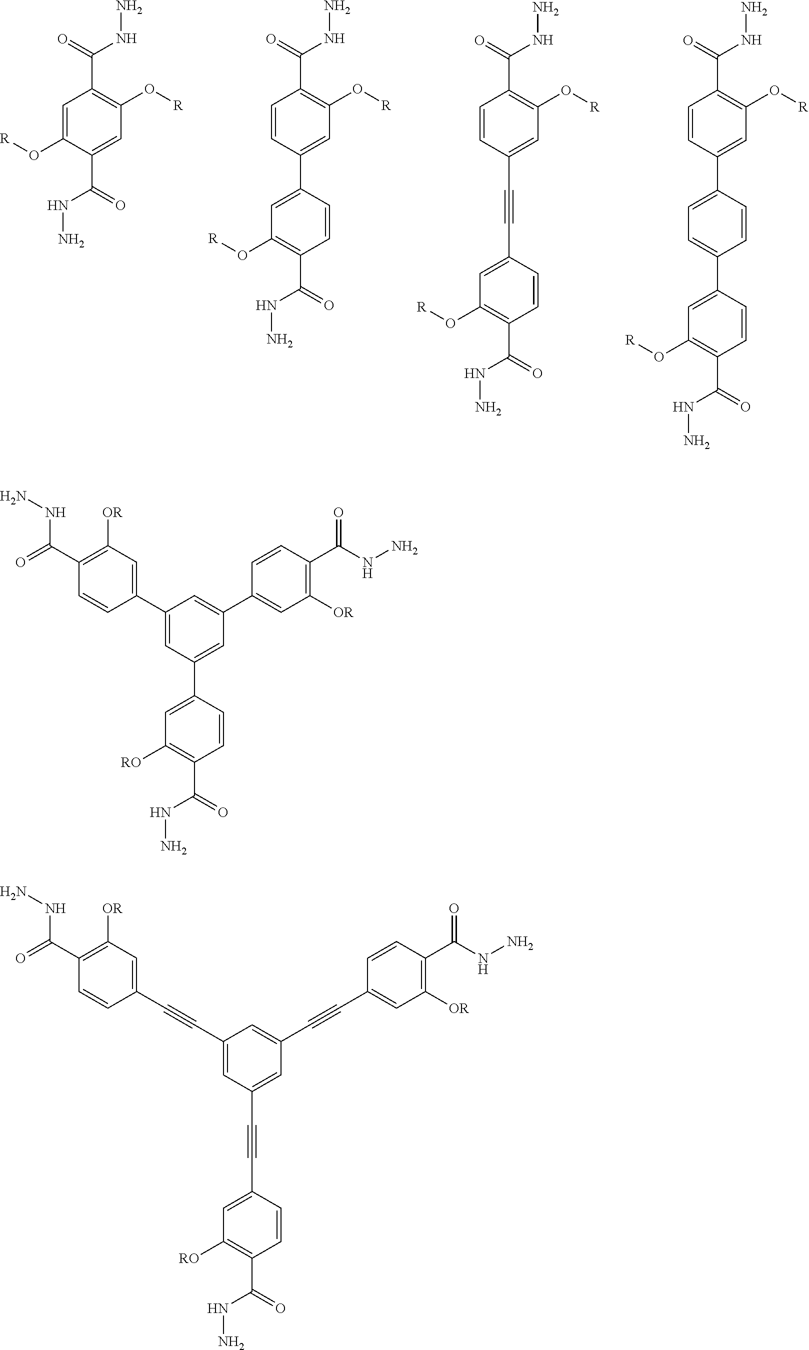

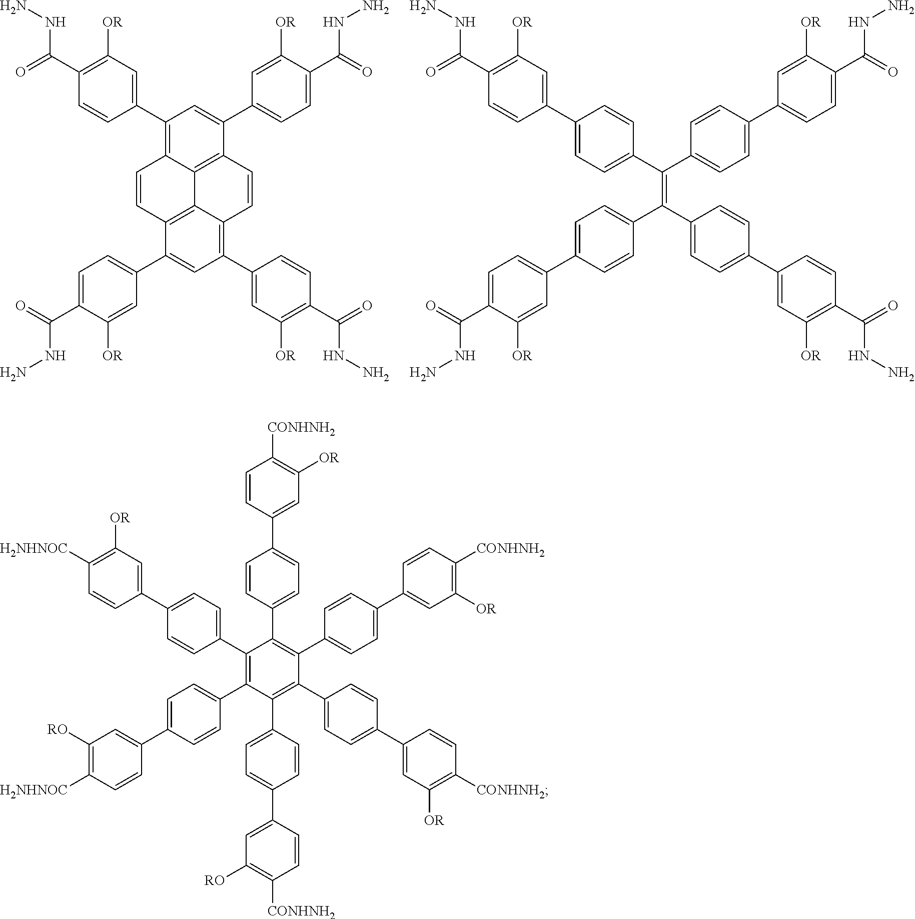

wherein R is optionally substituted (C₃-C₆)alkyl or optionally substituted benzyl.

In some embodiments, the optionally substituted 2-alkoxybenzohydrazidyl moiety is selected from 2-propoxybenzohydrazidyl, 2-allyloxybenzohydrazidyl, 2-propargyloxybenzohydrazidyl, 2-benzyloxybenzohydrazidyl, and 2-(ethylthio)propoxybenzohydrazidyl.

In some embodiments, the second monomer is selected from:

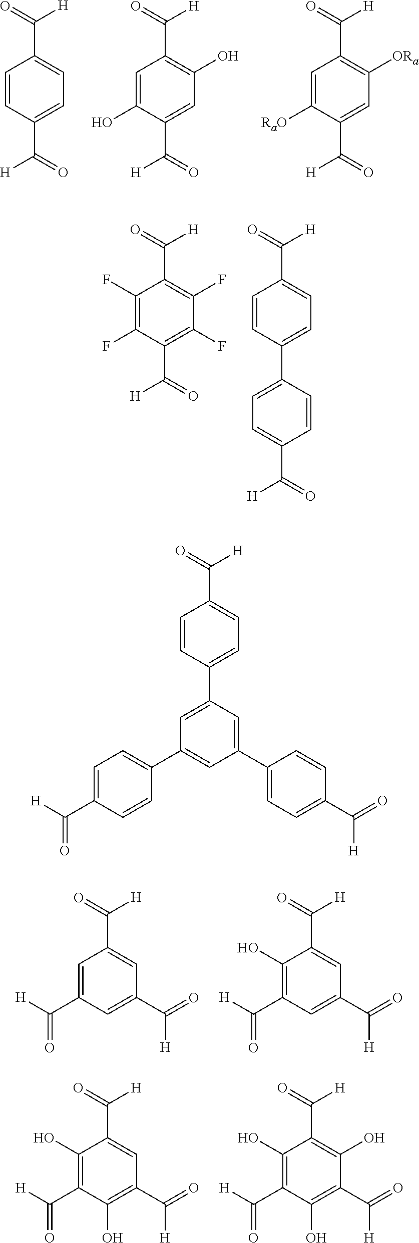

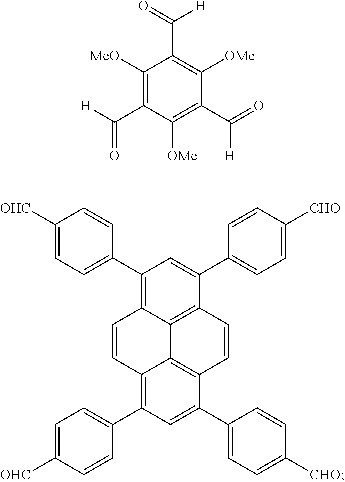

wherein Rₐ is optionally substituted C₁-C₆ alkyl.

In some embodiments, the stirring is performed in the presence of acetic acid from about 1:20 (V/Vₛₒₗᵥₑₙₜ) to about 1:100 (V/Vₛₒₗᵥₑₙₜ).

In some embodiments, the stirring is performed in the presence of acetic acid, the acetic acid having a concentration of about 1 M to about 17 M.

In some embodiments, the first monomer and the second monomer have a combined concentration of about 15 g L⁻¹ to about 60 g L⁻¹.

In some embodiments, the stirring is performed under heat of about 60° C. to about 200° C.

In some embodiments, the stirring is performed in an aprotic non-polar solvent.

In some embodiments, the aprotic non-polar solvent is 1,2-dichlorobenzene or mesitylene.

In some embodiments, solvent is added at a hydrazide:solvent mole ratio of about 1:200 to about 1:400.

In some embodiments, the stirring is performed in an aromatic solvent selected from toluene, xylenes, mesitylene, mono, di and trichlorobenzene, or a combination thereof.

In some embodiments, the stirring is performed in a polar protic solvent selected from water, C₁-C₄ alcohols, or a combination thereof.

In some embodiments, the stirring is performed in a solvent mixture, the solvent mixture selected from mesitylene/1,4-dioxane, ortho-dichlorobenzene (o-DCB)/n-butanol and mesitylene/acetonitrile.

The present invention also provides a covalent organic framework (COF) comprising an optionally substituted 2-alkoxybenzohydrazonylene moiety of Formula (Ia):

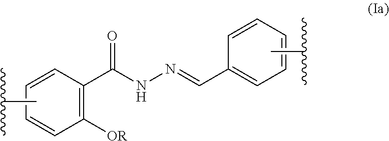

wherein R is optionally substituted (C₁-C₆)alkyl or benzyl; and

wherein [symbol] represents a linkage to the rest of the COF; and

wherein the COF has a x-ray diffraction 2-theta peak at about 3° with a full width half maximum (FWHM) of about 0.2° to about 0.4°.

The present invention also provides a covalent organic framework (COF) comprising an optionally substituted 2-alkoxybenzohydrazonylene moiety of Formula (Ia):

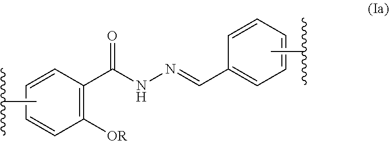

wherein R is optionally substituted (C₃-C₆)alkyl or benzyl; and

wherein [symbol] represents a linkage to the rest of the COF; and

wherein the COF has a x-ray diffraction 2-theta peak at about 3° with a full width half maximum (FWHM) of about 0.2° to about 0.4°.

In some embodiments, R is selected from propyl, allyl, propargyl or benzyl.

In some embodiments, the COF is selected from one of the following:

wherein R is selected from propyl, allyl, propargyl or benzyl.

The present invention also provides a COF comprising an optionally substituted 2-alkoxybenzohydrazonylene moiety of Formula (Ia):

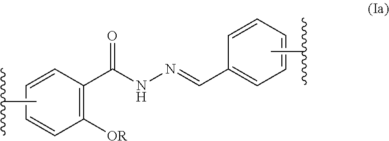

wherein R is optionally substituted (C₁-C₆)alkyl or benzyl; and

wherein [symbol] represents a linkage to the rest of the COF;

wherein the COF has a x-ray diffraction 2-theta peak at about 3° corresponding to a (100) facet with a full width half maximum (FWHM) of about 0.2° to about 0.6°.

The present invention also provides a COF comprising an optionally substituted 2-alkoxybenzohydrazonylene moiety of Formula (Ia):

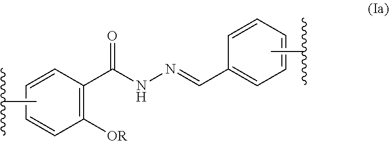

wherein R is optionally substituted (C₃-C₆)alkyl or benzyl; and

wherein [symbol] represents a linkage to the rest of the COF;

wherein the COF has a x-ray diffraction 2-theta peak at about 3° corresponding to a (100) facet with a full width half maximum (FWHM) of about 0.2° to about 0.6°.

In some embodiments, the COF has an X-ray diffraction pattern which corresponds to (110), (200) and (001) facets.

In some embodiments, the X-ray diffraction pattern is indicative of an antiparallel stacked configuration.

In some embodiments, the COF has a Brunauer-Emmett-Teller (BET) surface areas of about 150 m²g⁻¹ to about 850 m²g⁻¹.

In some embodiments, the COF is stable in 1M HCl and/or 1M NAOH for at least 7 days.

### BRIEF DESCRIPTION OF THE DRAWINGS

Embodiments of the present invention will now be described, by way of non-limiting example, with reference to the drawings in which:

FIG. 1 illustrates an exemplary 2D COF with intra- and interlayer hydrogen bonding;

FIG. 2 illustrates powder XRD patterns of exemplary crystalline COFs with narrow full-width-half-maximum (FWHM);

FIG. 3 illustrates fluorescent microscopic images of examples of COFs under visible light and UV light irradiation with absolute photoluminescence quantum yield shown below;

FIG. 4 illustrates the growth of highly crystalline COFs via dipole-induced antiparallel stacking and its simulation results;

FIG. 5 illustrates rotationally regulated synthesis of COFs using three isoreticular structures as models to demonstrate different degrees of bond rotation restriction under ultrafast or undisturbed prolonged conditions;

FIG. 6 illustrates powder X-ray diffraction (PXRD) patterns and TEM images of exemplary COFs with ditopic building units;

FIG. 7 illustrates XPS spectra of (A, B) Tf-DHzOAll COF and (C, D) Tf-DHz;

FIG. 8 illustrates the results from exemplary synthesis of highly crystalline COFs with tritopic hydrazides;

FIG. 9 illustrates the results of a one-pot synthesis of highly crystalline COFs in gram scale;

FIG. 10 illustrates charge density of DFT-optimized Tf-DHzOAll COF with antiparallel and eclipse stacking; and

FIG. 11 illustrates PXRD of Tf-DHzOPr grown in different solvents.

### DETAILED DESCRIPTION

Conventional COF crystal growth are directed by a dynamic bond forming and breaking process, which are responsible for in-plane growth, as well as π-π stacking for vertical growth. Generally, it takes a long time and strictly undisturbed condition to grow high quality crystals due to randomization process induced by bond rotations in the building units. This greatly prevents the large-scale production of high quality COFs.

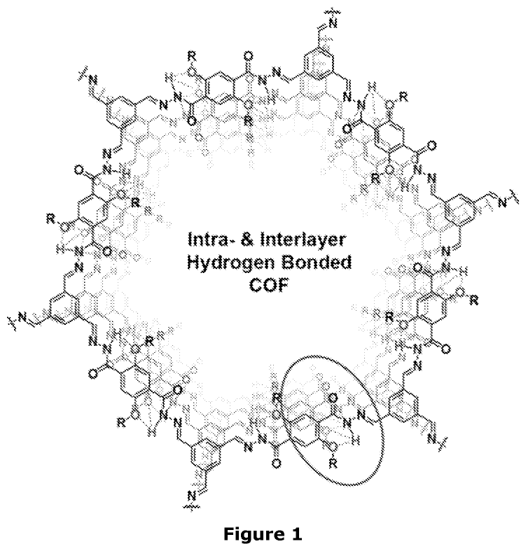

In this regard, without wanting to be bound by theory, the inventors have found that by incorporating tethering moieties in the molecular blocks that allows for long range attractive forces in the vertical direction to the 2D plane of the COF, the tethering moieties can serve the role of templating the molecular block into the lowest energy packing configuration. This is due to the abilities of these types of building blocks to impose both in-plane and out-of-plane bonding interactions in the COF crystals (see FIG. 1). The tethering moieties can, for example, be selected based on their abilities to undergo hydrogen bonding or long range dispersive interactions. These include for example 2-alkoxybenzohydrazide containing building units, which have the following structure shown as Formula (I):

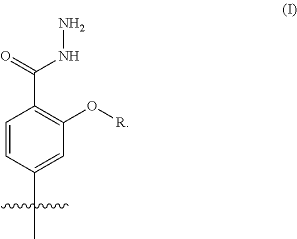

In particular, it was found, for example, that the installation of 2-(C₃)alkoxybenzohydrazide containing building units is particularly advantageous for allowing the 2D COF to be grown in much shorter time and achieve better crystallinity due to out-of-plane hydrogen bonding interactions, which also slows down the bond rotations process. in particular, and in certain embodiments, optionally substituted 2-(C₃)alkoxybenzohydrazide-containing and/or 2-benzyloxybenzohydrazide-containing building units of Formula (I) can be used which allow the bonding interactions between the building blocks when they stack and form layers to be strengthened. This removes the need for highly regulated synthetic growth conditions, and also leads to improved crystallinity and a higher rate growth of the COFs. This is in contrast to prior methodologies, in which the reaction must be conducted under sealed conditions and over an extended period of time as molecular vibrations and random walking results in a system with high entropy.

Accordingly, the present invention provides a method of fabricating a covalent organic framework (COF), comprising:

stirring a first monomer comprising an optionally substituted 2-alkoxybenzohydrazidyl moiety with second monomer comprising a benzaldehydyl moiety under heat and in open air for at least 15 min in order to form an acylhydrazone bond;

wherein the COF is formable after about 15 min; and

wherein the optionally substituted 2-alkoxybenzohydrazidyl moiety is selected from optionally substituted 2-(C₁-C₆)alkoxybenzohydrazidyl or 2-benzyloxybenzohydrazidyl.

In this regard, the (C₁-C₆)alkoxy moiety can be methoxy and ethoxy.

The present inventions also provides a method of fabricating a covalent organic framework (COF), comprising:

stirring a first monomer comprising an optionally substituted 2-alkoxybenzohydrazidyl moiety with second monomer comprising a benzaldehydyl moiety under heat and in open air for at least 15 min in order to form an acylhydrazone bond;

wherein the COF is formable after about 15 min; and

wherein the optionally substituted 2-alkoxybenzohydrazidyl moiety is selected from optionally substituted 2-(C₃-C₆)alkoxybenzohydrazidyl or 2-benzyloxybenzohydrazidyl.

Advantageously, the 2-alkoxybenzohydrazidyl moiety allows for the bonding interactions both in the plane and between the planes when they stack and form layers to be strengthened, leading to improved crystallinity and a higher rate growth of the COFs. It is believed that the out-of-plane bonding interactions, due mainly to inter-layer hydrogen bonding interactions between functional groups in the 2-alkoxybenzohydrazidyl moiety. This can be, for example, hydrogen bonding occurring between hydrogen donor (examples include NH, NH₂) of one layer and hydrogen acceptor moieties (examples include: aldehydes, ketones, ethers eg. —R—O—R, R₂C═O, RHC═O) of another layer. This provides a templating effect for the fast-growth of the crystals. The templating effect from 2-alkoxybenzohydrazidyl allow monomers to be locked in place fast during crystal growth, it also slows down bond rotation processes involving the linkage groups, eg. imine linkages, thus reducing the randomization process in crystal growth and allows the most thermodynamically favoured stacking configuration to be reached fast. Accordingly, COF can be obtained in relatively short amount of time compared to traditional methods (more than 7 days). Better crystallinity can also be achieved due to out-of-plane hydrogen bonding interactions, which also slows down the bond rotations process.

“Alkoxy” refers to the group alkyl-O— where the alkyl group is as described above. Examples include, methoxy, ethoxy, n-propoxy, iso-propoxy, n-butoxy, tert-butoxy, sec-butoxy, n-pentoxy, n-hexoxy, 1,2-dimethylbutoxy, and the like.

In this specification “optionally substituted” is taken to mean that a group may or may not be further substituted or fused (so as to form a condensed polycyclic group) with one or more groups selected from hydroxyl, acyl, alkyl, alkoxy, alkenyl, alkenyloxy, alkynyl, alkynyloxy, amino, aminoacyl, thio, arylalkyl, arylalkoxy, aryl, aryloxy, carboxyl, acylamino, cyano, halogen, nitro, phosphono, sulfo, phosphorylamino, phosphinyl, heteroaryl, heteroarylalkyl, heteroaryloxy, heterocyclyl, heterocyclylalkyl, heterocyclyloxy, oxyacyl, oxime, oxime ether, hydrazone, oxyacylamino, oxysulfonylamino, aminoacyloxy, trihalomethyl, trialkylsilyl, pentafluoroethyl, trifluoromethoxy, difluoromethoxy, trifluoromethanethio, trifluoroethenyl, mono- and di-alkylamino, mono-and di-(substituted alkyl)amino, mono- and di-arylamino, mono- and di-heteroarylamino, mono- and di-heterocyclyl amino, and unsymmetric di-substituted amines having different substituents selected from alkyl, aryl, heteroaryl and heterocyclyl, and the like, and may also include a bond to a solid support material, (for example, substituted onto a polymer resin). For instance, an “optionally substituted amino” group may include amino acid and peptide residues.

In this regard, ‘optionally substituted alkoxy’ includes, but is not limited to, carbon chains with a double bond such as allyloxy, carbon chains with a triple bond such as propargyloxy, and aryl substituted alkoxy.

As used herein, ‘open air’ refers to unenclosed conditions. This can refer to being under atmospheric conditions and also can include being exposed to water vapour.

In some embodiments, first monomer is selected from one of the following:

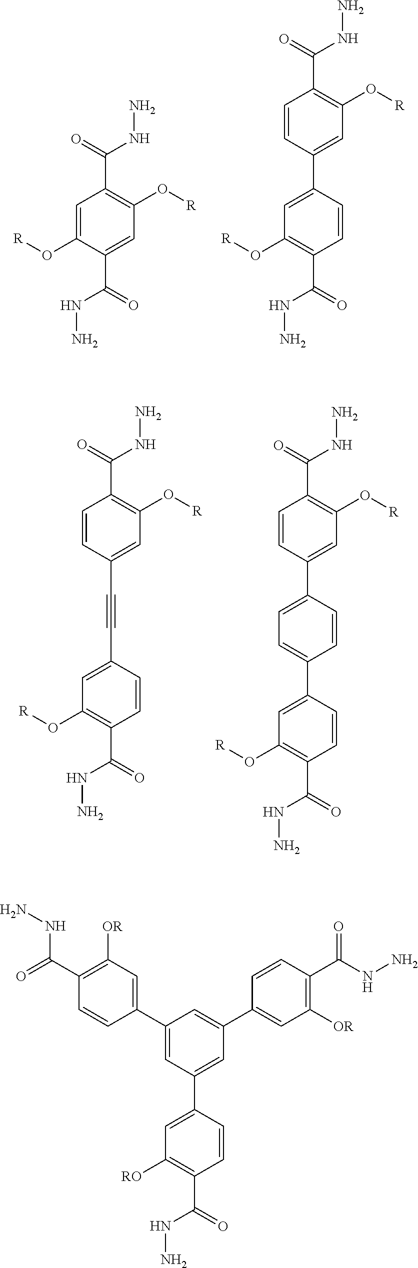

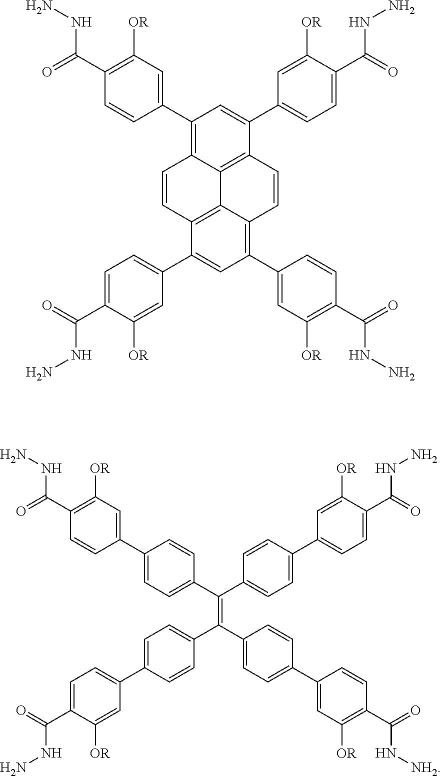

In some embodiments, the optionally substituted 2-alkoxybenzohydrazidyl moiety is optionally substituted 2-(C₃-C₆)alkoxybenzohydrazidyl. In other embodiments, the optionally substituted 2-alkoxybenzohydrazidyl moiety is alkyl 2-propoxybenzohydrazidyl. In other embodiments, the R group can be any organic or inorganic functionalities. In other embodiments, the optionally substituted 2-alkoxybenzohydrazidyl moiety is 2-allyloxybenzohydrazidyl, 2-propargyloxybenzohydrazidyl or 2-benzyloxybenzohydrazidyl.

In some embodiments, the second monomer is selected from:

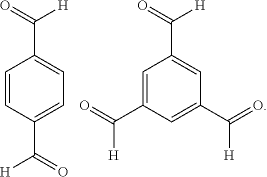

In some embodiments, the first monomer and the second monomer are in molar equivalence.

In some embodiments, the stirring is performed for at least 15 min. In other embodiments, the stirring is performed for about 15 min to about 1 h.

In some embodiments, the stirring is performed at atmospheric pressure and in air. In other embodiments, the stirring is performed under heat at not less than 100° C., 110° C. or 120° C. In other embodiments, the stirring is performed under heat at more than 100° C., 110° C. or 120° C. In other embodiments, the stirring is performed under heat of about 100° C. to about 120° C.

In some embodiments, the stirring is performed in a solvent. The solvent can be added at a hydrazide:solvent mole ratio of about 1:200 to about 1:400. In other embodiments, the mole ratio is about 1:200 to about 1:350 or about 1:200 to about 1:300. The solvent can be 1,4-dioxane or mesitylene.

In some embodiments, the stirring step further comprises a catalyst. The catalyst can be acetic acid. For example, acetic acid at 1:50 (V/Vₛₒₗᵥₑₙₜ) can be added. For example, 17M acetic acid can be used.

In some embodiments, the COF is formable after about 20 min, about 30 min, about 40 min or about 50 min.

Accordingly, in some embodiments, the method comprises:

stirring a first monomer comprising an optionally substituted 2-alkoxybenzohydrazidyl moiety with second monomer comprising a benzaldehydyl moiety under heat at not less than 100° C. and in open air for at least 15 min in the presence of acetic acid in order to form an acylhydrazone bond;

wherein the COF is formable after about 15 min; and

wherein the optionally substituted 2-alkoxybenzohydrazidyl moiety is selected from optionally substituted 2-(C₁-C₆)alkoxybenzohydrazidyl or 2-benzyloxybenzohydrazidyl.

In some embodiments, the method comprises:

stirring a first monomer comprising an optionally substituted 2-alkoxybenzohydrazidyl moiety with second monomer comprising a benzaldehydyl moiety under heat at not less than 100° C. and in open air for at least 15 min in the presence of acetic acid in order to form an acylhydrazone bond;

wherein the COF is formable after about 15 min; and

wherein the optionally substituted 2-alkoxybenzohydrazidyl moiety is selected from optionally substituted 2-(C₃-C₆)alkoxybenzohydrazidyl or 2-benzyloxybenzohydrazidyl.

In some embodiments, the method comprises:

stirring a first monomer comprising an optionally substituted 2-alkoxybenzohydrazidyl moiety with second monomer comprising a benzaldehydyl moiety under heat at not less than 100° C. and in open air for at least 15 min in the presence of acetic acid in order to form an acylhydrazone bond;

wherein the COF is formable after about 30 min; and

wherein the optionally substituted 2-alkoxybenzohydrazidyl moiety is selected from optionally substituted 2-(C₃-C₆)alkoxybenzohydrazidyl or 2-benzyloxybenzohydrazidyl.

In some embodiments, the method comprises:

stirring a first monomer comprising an optionally substituted 2-alkoxybenzohydrazidyl moiety with second monomer comprising a benzaldehydyl moiety under heat at not less than 100° C. and in open air for at least 15 min in the presence of acetic acid in order to form an acylhydrazone bond;

wherein the COF is formable after about 15 min; and

wherein the optionally substituted 2-alkoxybenzohydrazidyl moiety is selected from optionally substituted 2-(C₃)alkoxybenzohydrazidyl or 2-benzyloxybenzohydrazidyl.

In some embodiments, the method comprises:

stirring a first monomer comprising an optionally substituted 2-alkoxybenzohydrazidyl moiety with second monomer comprising a benzaldehydyl moiety under heat at not less than 100° C. and in open air for at least 15 min in the presence of acetic acid in order to form a acylhydrazone bond;

wherein the COF is formable after about 15 min;

wherein the first monomer is selected from the following:

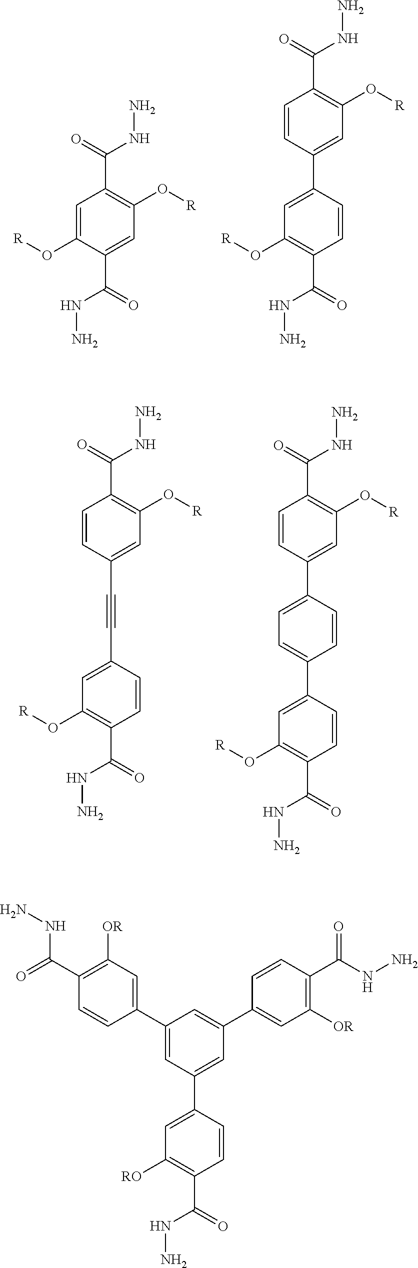

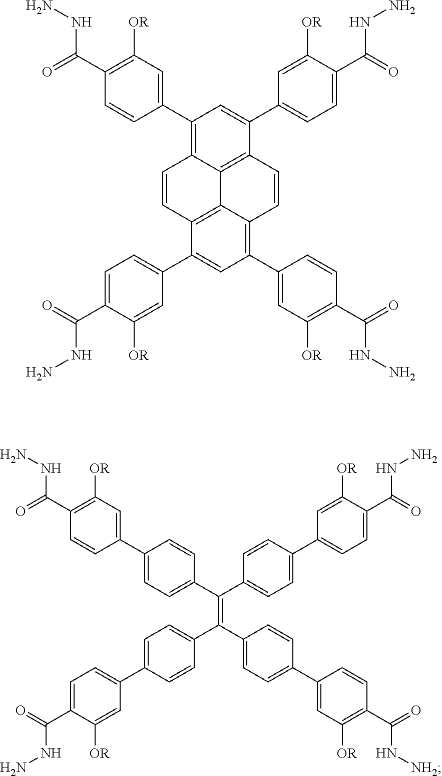

wherein R is optionally substituted C₃-alkyl or benzyl.

In some embodiments, the method comprises: stirring a first monomer comprising an optionally substituted 2-alkoxybenzohydrazidyl moiety with second monomer comprising a benzaldehydyl moiety under heat at not less than 100° C. and in open air for at least 15 min in the presence of acetic acid in order to form an acylhydrazone bond;

wherein the COF is formable after about 30 min;

wherein the first monomer is selected from the following:

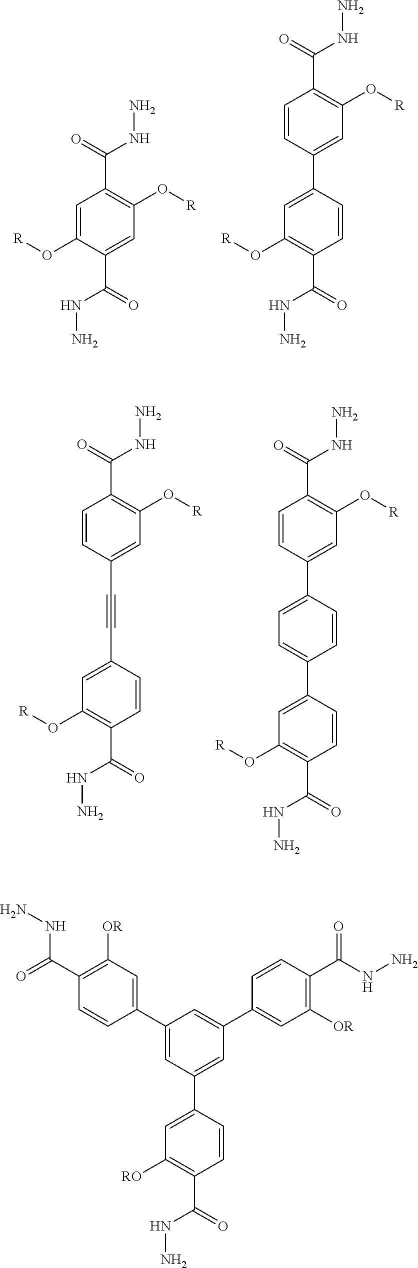

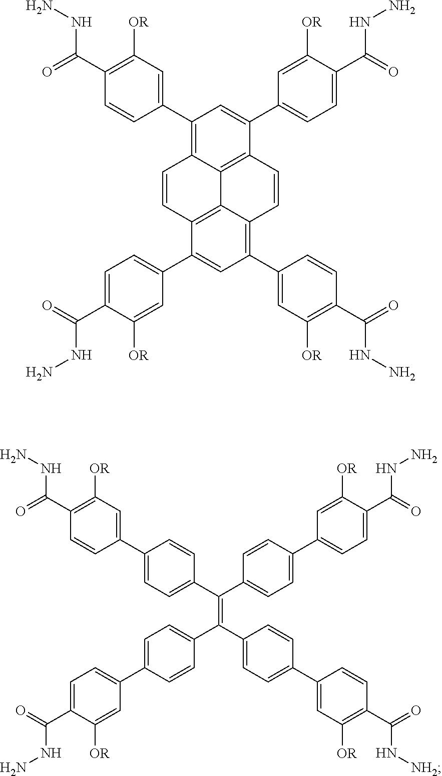

wherein R is optionally substituted C₃-alkyl or benzyl.

In some embodiments, the method comprises:

stirring a first monomer comprising a optionally substituted 2-alkoxybenzohydrazidyl moiety with second monomer comprising a benzaldehydyl moiety under heat at not less than 100° C. and in open air for at least 15 min in the presence of acetic acid in order to form a acylhydrazone bond;

wherein the optionally substituted 2-alkoxybenzohydrazidyl moiety is selected from 2-propoxybenzohydrazidyl, 2-allyloxybenzohydrazidyl, 2-propargyloxybenzohydrazidyl or 2-benzyloxybenzohydrazidyl; and

wherein the COF is formable after about 15 min.

In some embodiments, the method comprises:

stirring a first monomer comprising a optionally substituted 2-alkoxybenzohydrazidyl moiety with second monomer comprising a benzaldehydyl moiety under heat at not less than 100° C. and in open air for at least 15 min in the presence of acetic acid in order to form an acylhydrazone bond;

wherein the optionally substituted 2-alkoxybenzohydrazidyl moiety is selected from 2-propoxybenzohydrazidyl, 2-allyloxybenzohydrazidyl, 2-propargyloxybenzohydrazidyl or 2-benzyloxybenzohydrazidyl; and

wherein the COF is formable after about 30 min.

In some embodiments, the method comprises:

stirring a first monomer comprising an optionally substituted 2-alkoxybenzohydrazidyl moiety with second monomer comprising a benzaldehydyl moiety under heat at not less than 100° C. and in open air for at least 15 min in the presence of acetic acid in order to form an acylhydrazone bond;

wherein the COF is formable after about 15 min;

wherein the first monomer is selected from the following:

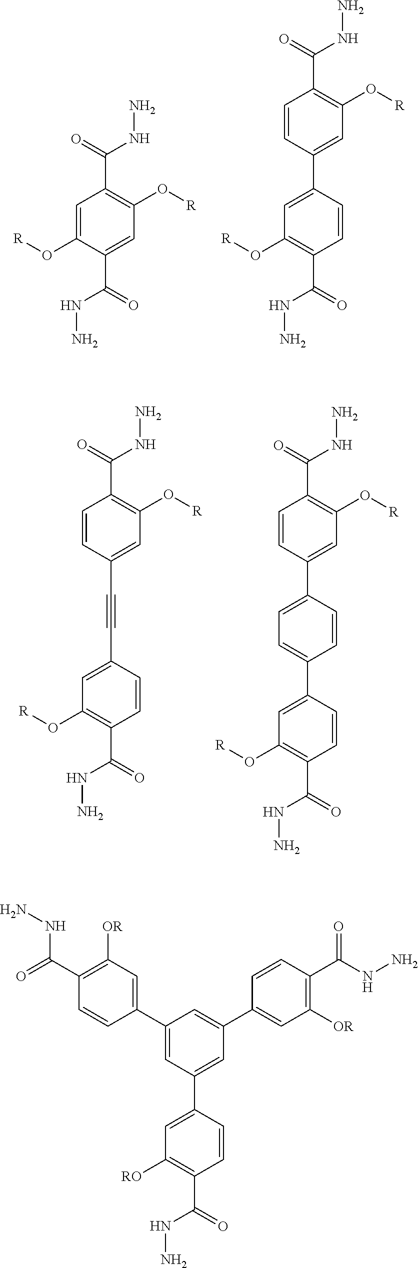

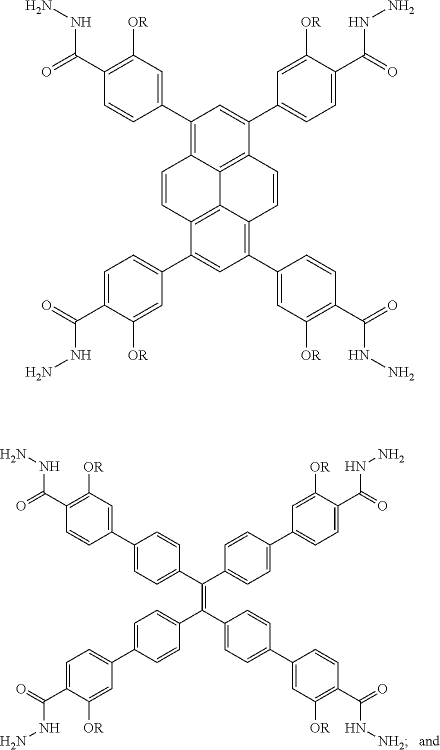

wherein R is selected from propyl, allyl, propargyl or benzyl.

In some embodiments, the method comprises:

stirring a first monomer comprising an optionally substituted 2-alkoxybenzohydrazidyl moiety with second monomer comprising a benzaldehydyl moiety under heat at not less than 100° C. and in open air for at least 15 min in the presence of acetic acid in order to form an acylhydrazone bond;

wherein the COF is formable after about 30 min;

wherein the first monomer is selected from the following:

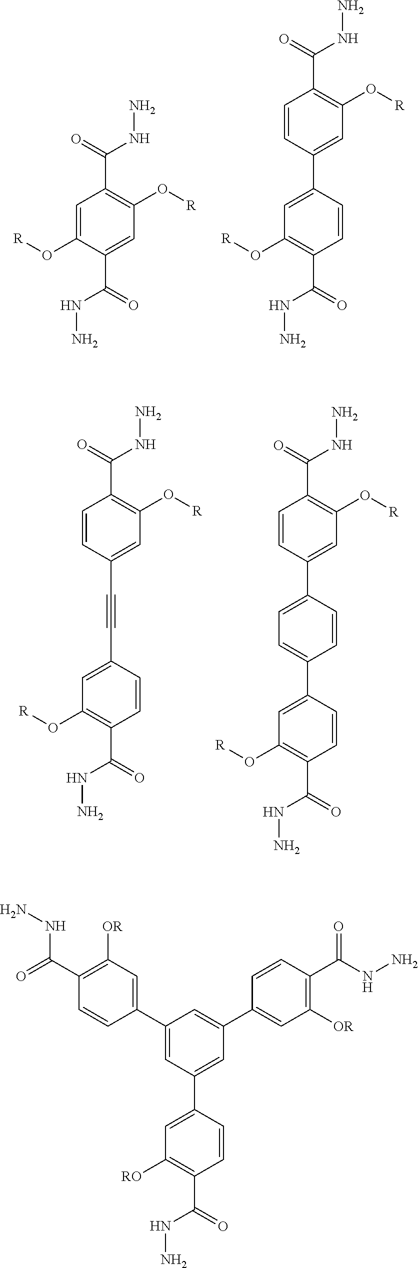

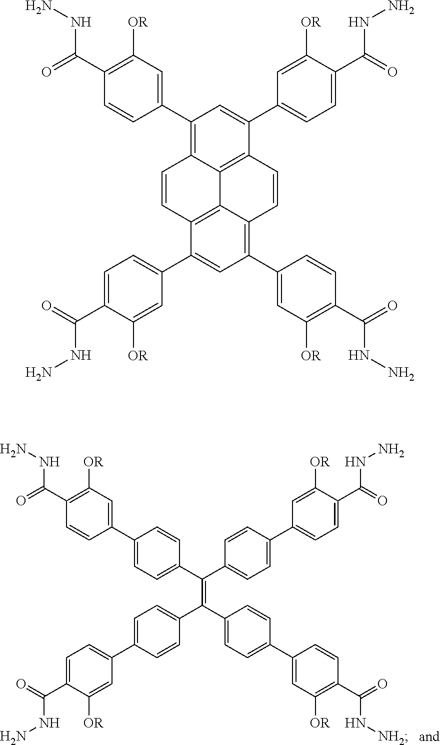

wherein R is selected from propyl, allyl, propargyl or benzyl.

In some embodiments, the method comprises:

stirring a first monomer comprising an optionally substituted 2-alkoxybenzohydrazidyl moiety with second monomer comprising a benzaldehydyl moiety under heat at not less than 100° C. and in open air for at least 15 min in the presence of acetic acid in order to form an acylhydrazone bond;

wherein the COF is formable after about 15 min; and

wherein the first monomer is selected from the following:

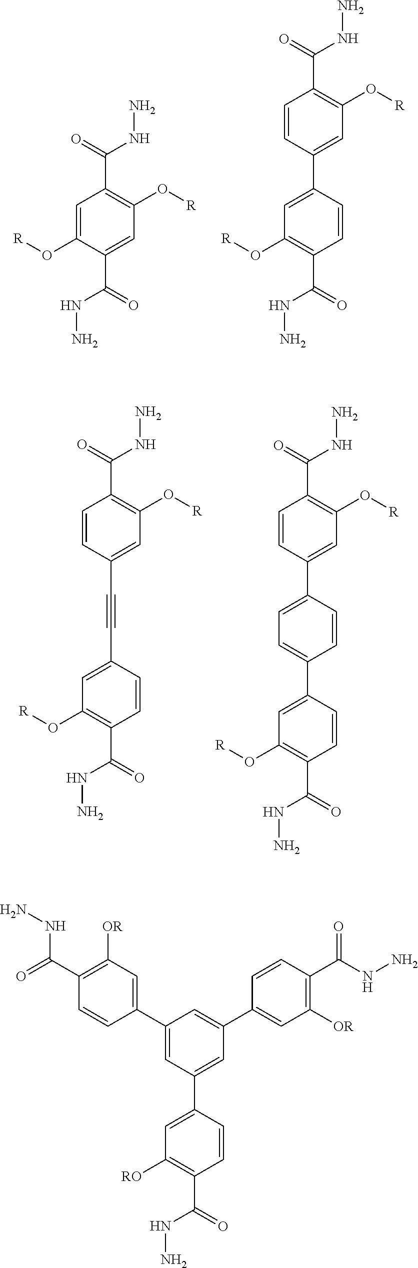

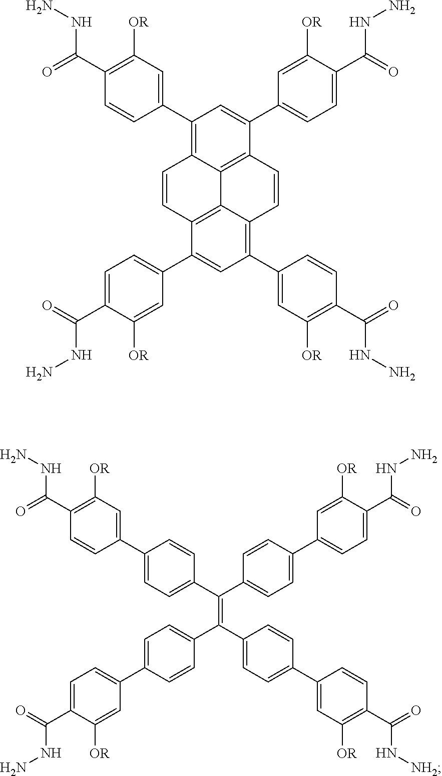

wherein R is selected from propyl, allyl, propargyl or benzyl; and

the second monomer is selected from:

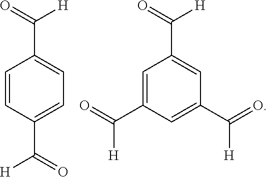

In some embodiments, the method comprises:

stirring a first monomer comprising an optionally substituted 2-alkoxybenzohydrazidyl moiety with second monomer comprising a benzaldehydyl moiety under heat at not less than 100° C. and in open air for at least 15 min in the presence of acetic acid in order to form an acylhydrazone bond;

wherein the COF is formable after about 30 min; and

wherein the first monomer is selected from the following:

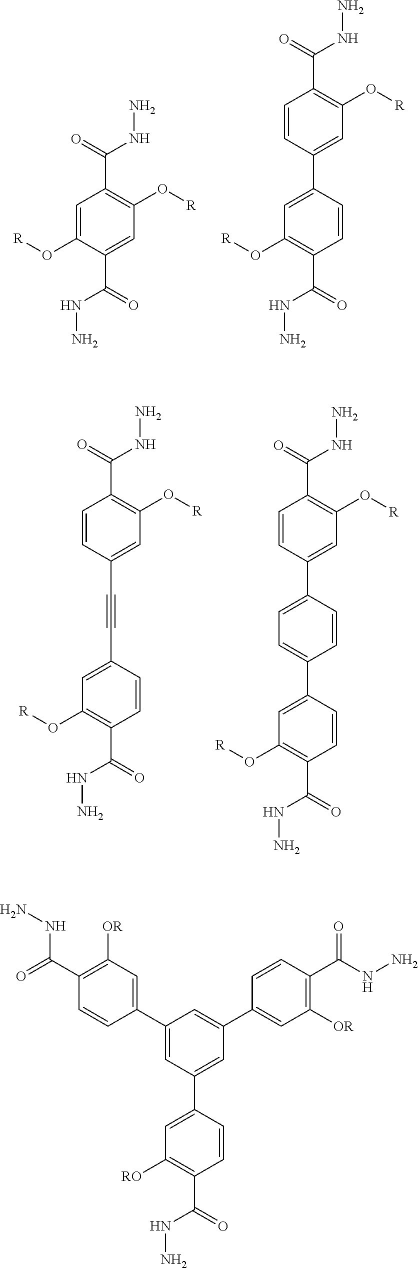

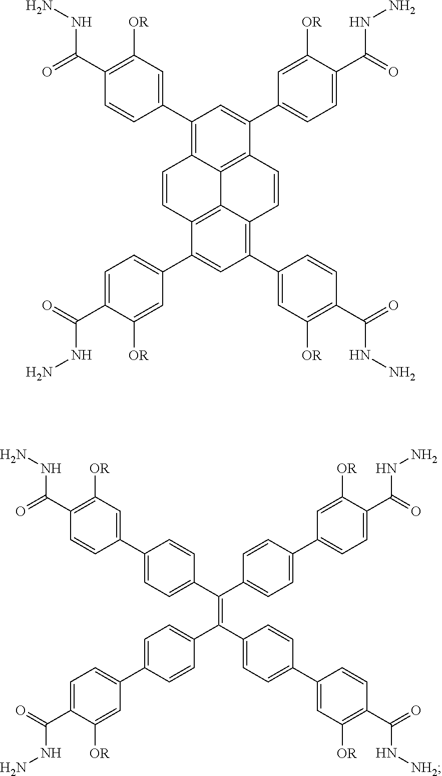

wherein R is selected from propyl, allyl, propargyl or benzyl; and

the second monomer is selected from:

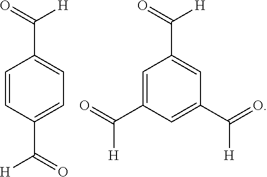

According to the invention, in another aspect, the method comprises:

stirring a first monomer comprising an optionally substituted 2-alkoxybenzohydrazidyl moiety with second monomer comprising a benzaldehydyl moiety under heat at not less than 100° C. and in open air for at least 15 min in the presence of acetic acid in order to form an acylhydrazone bond;

wherein the COF is formable after about 15 min; and

wherein the first monomer is selected from the following:

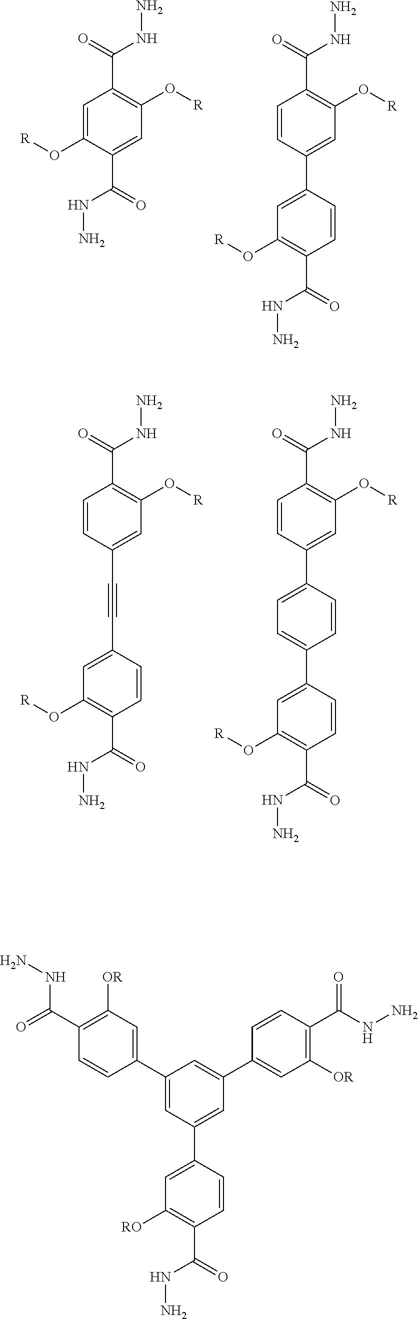

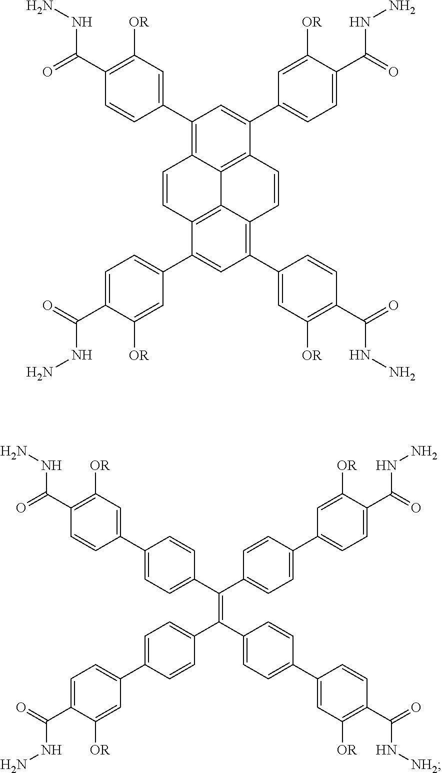

wherein R is selected from propyl, allyl, propargyl or benzyl; and

the second monomer is selected from:

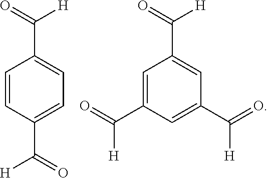

In another aspect, the method comprises:

stirring a first monomer comprising an optionally substituted 2-alkoxybenzohydrazidyl moiety with second monomer comprising a benzaldehydyl moiety under heat at not less than 100° C. and in open air for about 15 min to about 1 h in the presence of acetic acid in order to form a acylhydrazone bond;

wherein the COF is formable after about 15 min; and

wherein the first monomer is selected from the following:

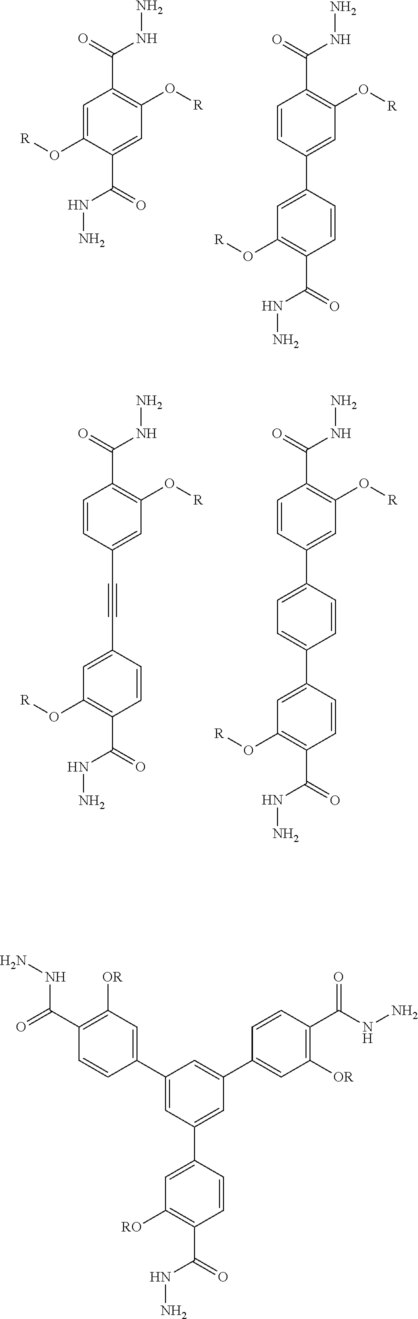

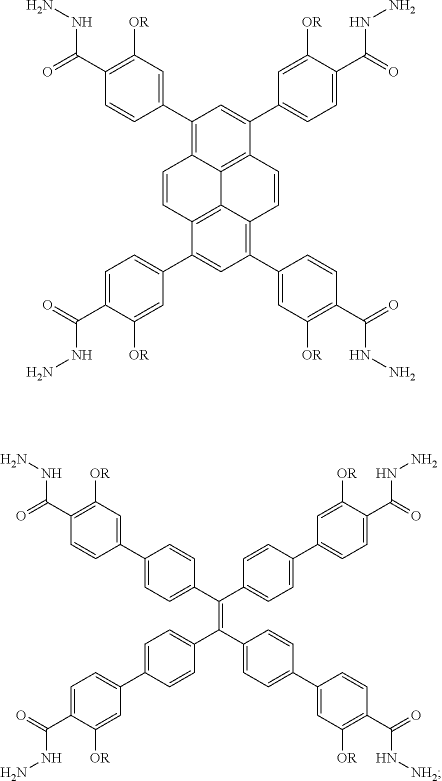

wherein R is selected from propyl, allyl, propargyl or benzyl; and

the second monomer is selected from:

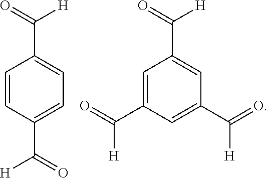

In another aspect, the method comprises:

stirring a first monomer comprising an optionally substituted 2-alkoxybenzohydrazidyl moiety with second monomer comprising a benzaldehydyl moiety under heat at not less than 100° C. and in open air for about 15 min to about 1 h in the presence of 17M acetic acid in order to form an acylhydrazone bond;

wherein the COF is formable after about 15 min; and

wherein the first monomer is selected from the following:

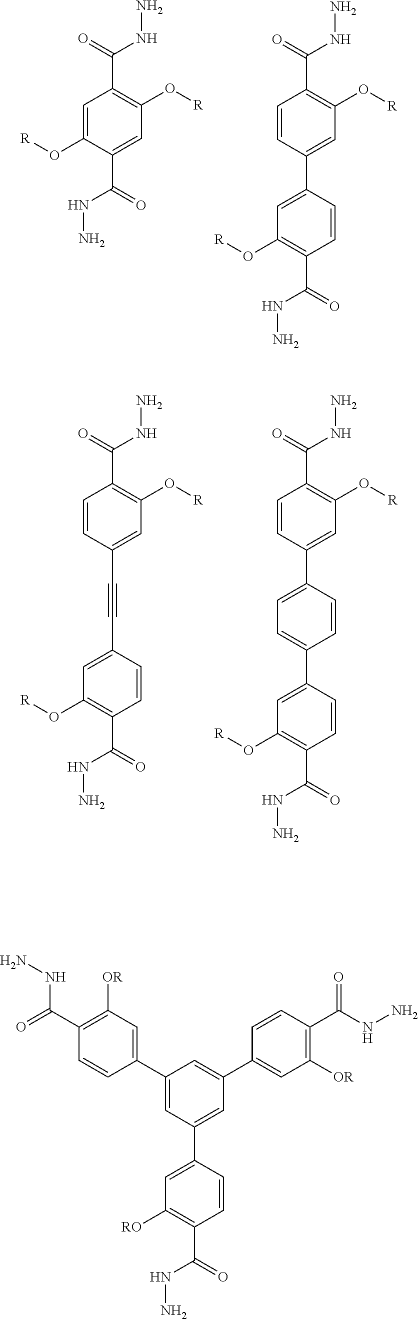

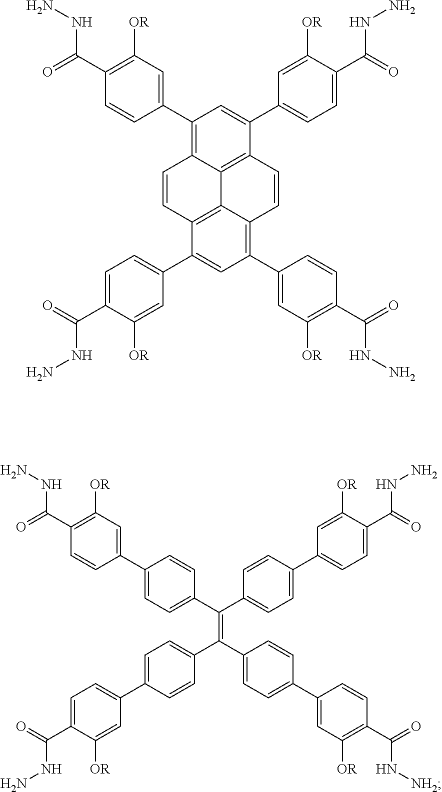

wherein R is selected from propyl, allyl, propargyl or benzyl; and

the second monomer is selected from:

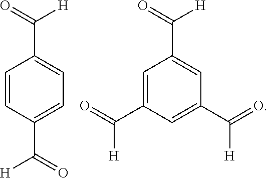

The present invention also provides a covalent organic framework (COF) comprising an optionally substituted 2-alkoxybenzohydrazonylene moiety of Formula (Ia):

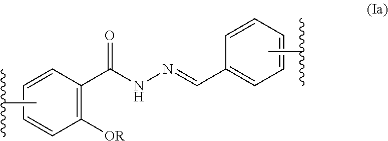

wherein R is optionally substituted (C₁-C₆)alkyl or benzyl; and

wherein [symbol] represents a linkage to the rest of the COF.

The present invention also provides a covalent organic framework (COF) comprising an optionally substituted 2-alkoxybenzohydrazonylene moiety of Formula (Ia):

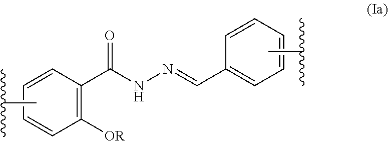

wherein R is optionally substituted (C₃-C₆)alkyl or benzyl; and

wherein [symbol] represents a linkage to the rest of the COF.

The present invention also provides a covalent organic framework (COF) comprising an optionally substituted 2-alkoxybenzohydrazonylene moiety of Formula (Ia):

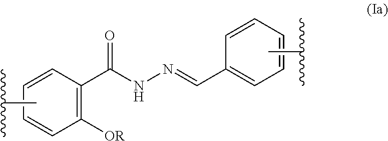

wherein R is optionally substituted (C₁-C₆)alkyl or benzyl; and

wherein [symbol] represents a linkage to the rest of the COF;

wherein the COF has a x-ray diffraction 2-theta peak at about 3° with a full width half maximum (FWHM) of about 0.2° to about 0.4°.

The present invention also provides a covalent organic framework (COF) comprising an optionally substituted 2-alkoxybenzohydrazonylene moiety of Formula (Ia):

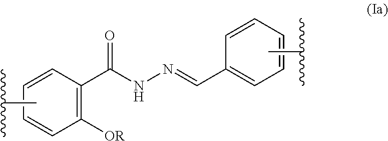

wherein R is optionally substituted (C₃-C₆)alkyl or benzyl; and

wherein [symbol] represents a linkage to the rest of the COF;

wherein the COF has a x-ray diffraction 2-theta peak at about 3° with a full width half maximum (FWHM) of about 0.2° to about 0.4°.

In some embodiments, R is selected from C₃-C₆ alkyl. In other embodiments, R is selected from C₃ alkyl. In other embodiments, R is selected from propyl, allyl or propargyl. In other embodiments, R is benzyl.

In some embodiments, the COF has a x-ray diffraction 2-theta peak with a full width half maximum of about 0.2° to about 0.4°, about 0.25° to about 0.4°, about 0.3° to about 0.4°, about 0.31° to about 0.4°, about 0.32° to about 0.4°, or about 0.33° to about 0.4°. In other embodiments, the COF has a x-ray diffraction 2-theta peak with a full width half maximum of about 0.3°, about 0.35°, or about 0.4°.

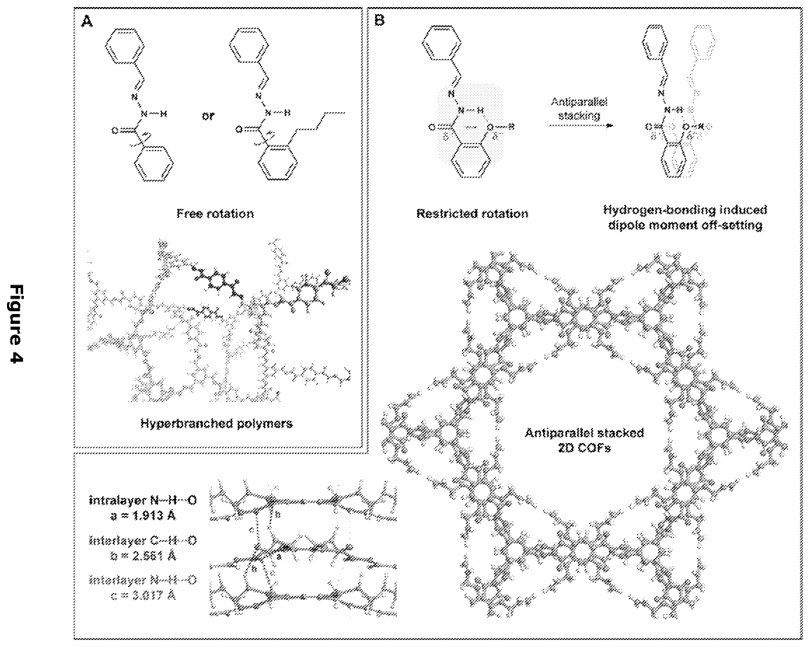

In some embodiments, the COFs of the present invention are fluorescent (see FIG. 3). In other embodiments, the COFs have an absolute photoluminescence (PL) quantum yield of at least 2%. In other embodiments, the PL quantum yield is at least 4%, at least 6%, at least 8%, at least 10% or at least 12%. In other embodiments, the PL quantum yield is about 2% to about 20%, or about 2% to about 18%.

As mentioned above, the COF is made up of at least two monomers, a first monomer comprising a 2-alkoxybenzohydrazidyl moiety with second monomer comprising a benzaldehydyl moiety. In this regard, the 2-alkoxybenzohydrazonylene moiety of Formula (I) can be represented as Formula (Ib):

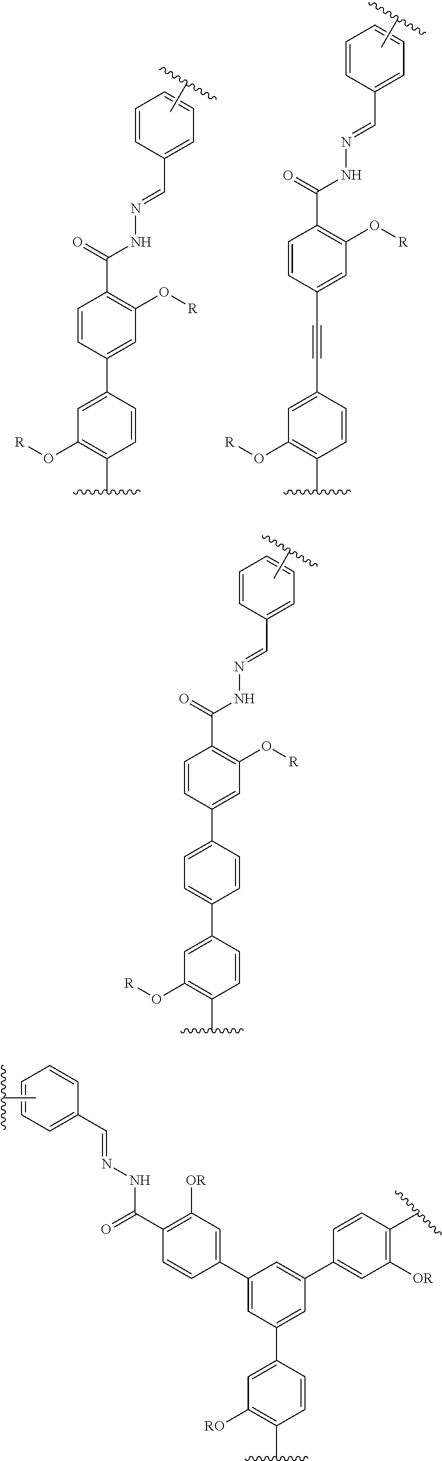

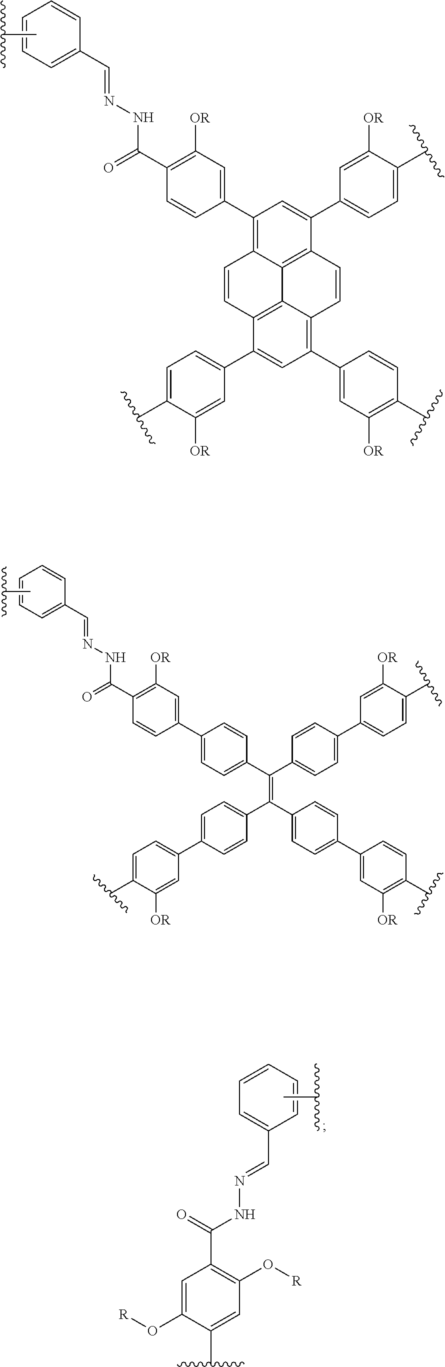

wherein [symbol] represents a linkage to the rest of the COF.

In other embodiments, when 1,4-diformylbenzene is used, the 2-alkoxybenzohydrazonylene moiety of Formula (I) can be represented as Formula (Ib′):

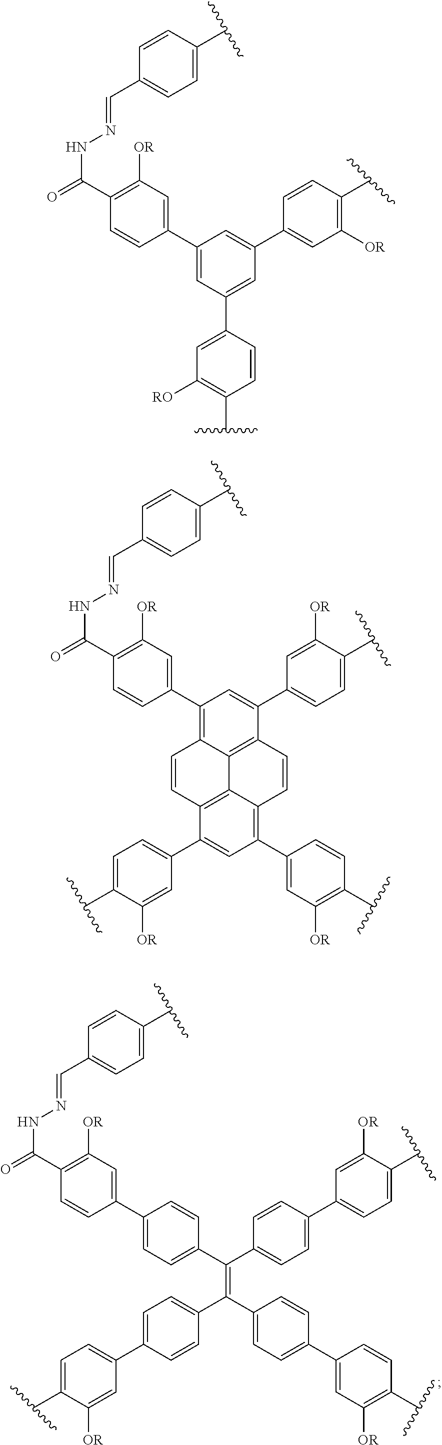

wherein [symbol] represents a linkage to the rest of the COF.

In other embodiments, when 1,3,5-triformylbenzene is used, the 2-alkoxybenzohydrazonylene moiety of Formula (I) can be represented as Formula (Ib″):

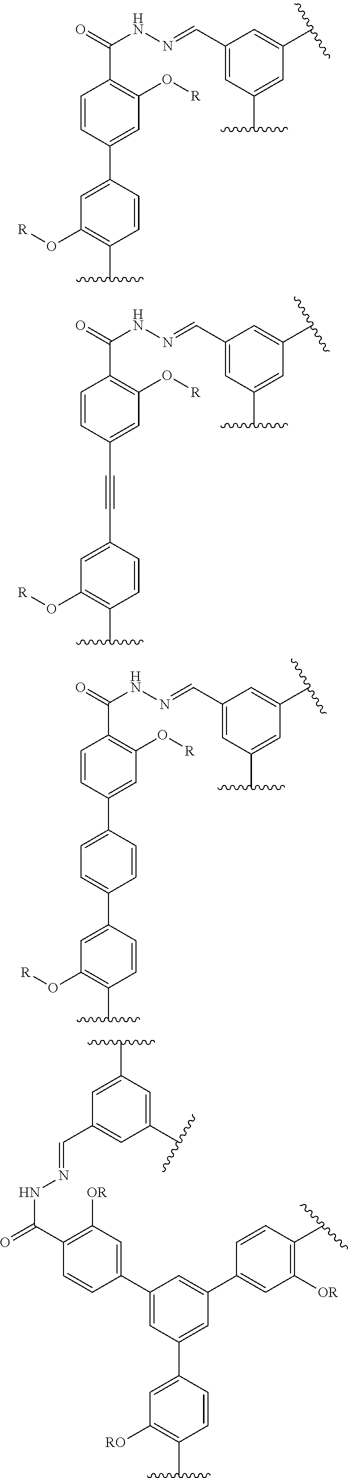

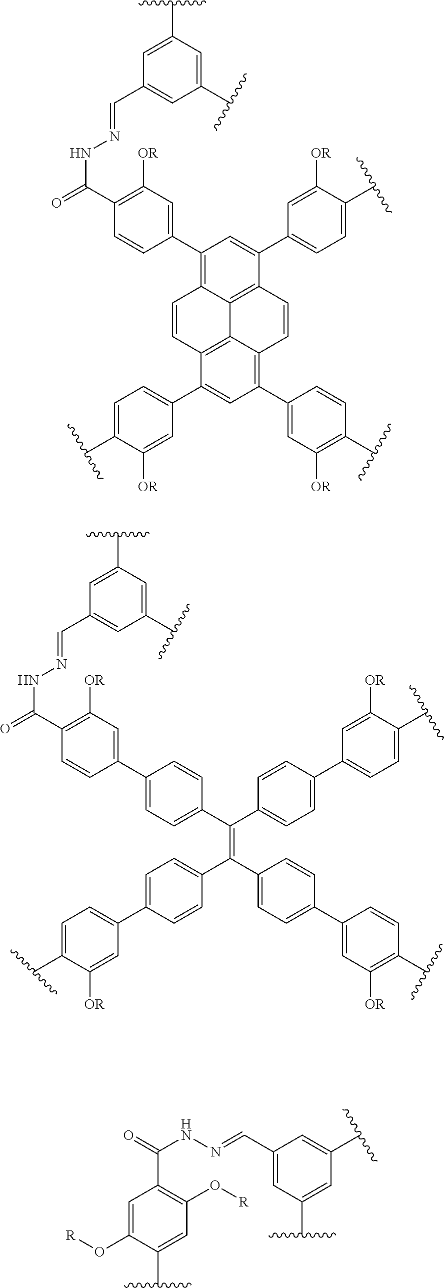

wherein [symbol] represents a linkage to the rest of the COF.

Accordingly, in some embodiments, the COF comprising an optionally substituted 2-alkoxybenzohydrazonylene moiety of Formula (Ia):

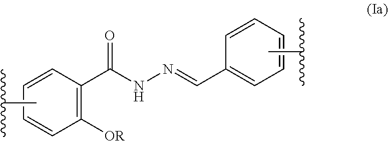

wherein R is selected from propyl, allyl, propargyl or benzyl; and

wherein [symbol] represents a linkage to the rest of the COF;

wherein the COF has a x-ray diffraction 2-theta peak at about 3° with a full width half maximum (FWHM) of about 0.3° to about 0.4°.

In some embodiments, the COF comprising an optionally substituted 2-alkoxybenzohydrazonylene moiety of Formula (Ia):

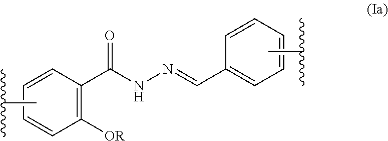

wherein R is selected from propyl, allyl, propargyl or benzyl; and

wherein [symbol] represents a linkage to the rest of the COF;

wherein the COF has a x-ray diffraction 2-theta peak at about 3° with a full width half maximum (FWHM) of about 0.3° to about 0.4°; and

wherein the COFs have an absolute photoluminescence (PL) quantum yield of at least 2%.

In some embodiments, the COF comprising an optionally substituted 2-alkoxybenzohydrazonylene moiety of Formula (Ib):

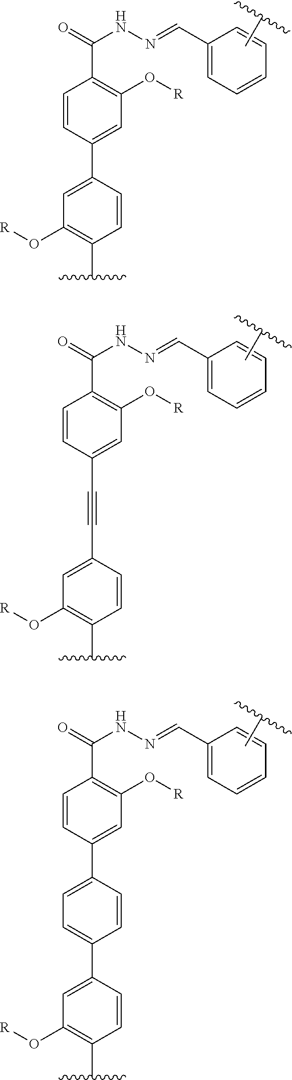

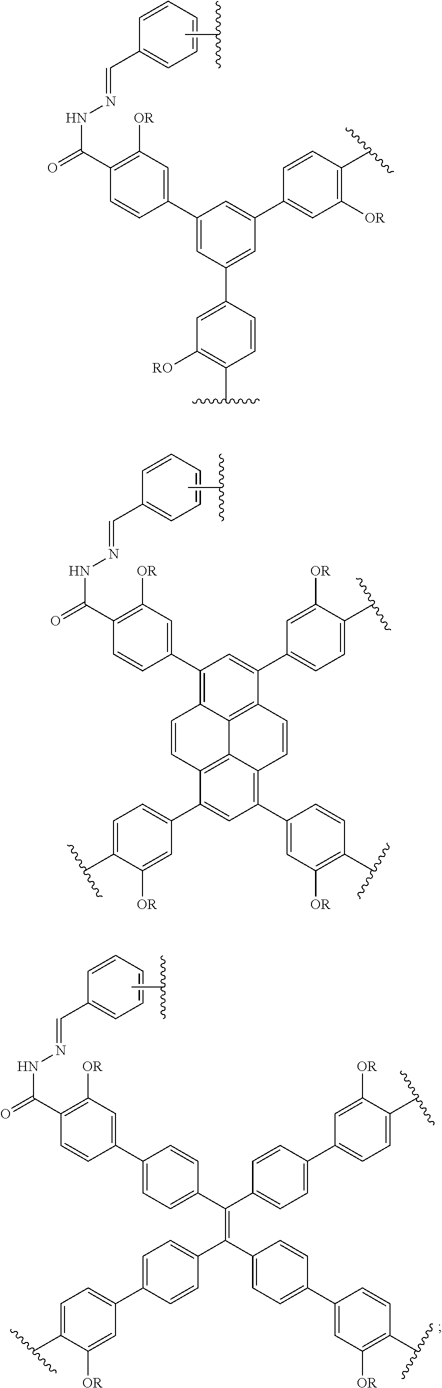

wherein R is selected from propyl, allyl, propargyl or benzyl; and

wherein [symbol] represents a linkage to the rest of the COF;

wherein the COF has a x-ray diffraction 2-theta peak at about 3° with a full width half maximum (FWHM) of about 0.3° to about 0.4°.

Some examples of COF are as follows:

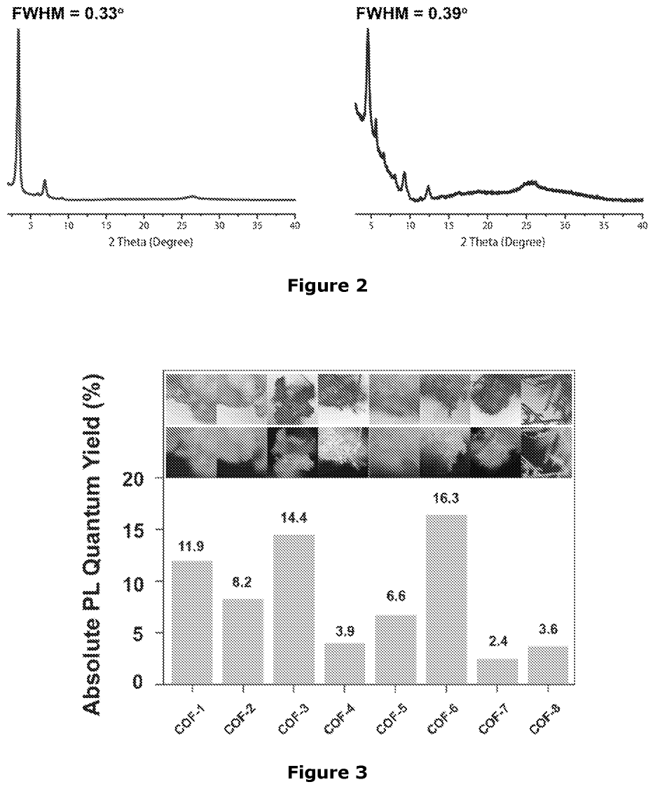

The presence of 2-alkoxybenzohydrazide allows hydrogen bonding interactions between individual layers of the COF, these have the effect of slowing down bond rotation of linker groups such as imine. In this regard, the effects of randomization process are reduced and crystal growth can proceed faster. Further, through the inter-layer (layer-to-layer) hydrogen bonding afforded by the alkoxybenzohydrazide moieties, a templating effect is provided for the vertical stacking of the COF crystals in a highly ordered 2D manner, resulting in fast crystal growth and high quality crystal. FIG. 2 shows for example the powder XRD of COF synthesized, of which the full-width-at-maximum (FWHM) is about 0.2°-0.4°, which is much narrower than COFs synthesized by conventional methods.

Through the hydrogen bonding afforded by the alkoxybenzohydrazide moieties, the porosities of COF can also be increased due to the improved packing densities.

The long-range attractive forces between layers can also be adapted to a wide variety of crystalline molecular frameworks with new properties. The advantage of fast crystalline COF growth can translate to lower time and cost of production, thus opening up large scale and fast fabrication possibilities. The advantage of crystalline COF with high porosity means that these COF can be used for gas storage, e.g. carbon dioxide capture. The COFs can be applied to various applications by tuning the sidechain functionality and with post synthetic modification. As these COFs can be easy to functionalization, various application requirement can be fulfilled easily.

The inventors have performed further studies and hypothesised that since a self-correction process is the rate-determining step for obtaining highly crystalline COFs, the key to achieving a high rate of crystallization lies in minimizing error. The major source of error during 2D COF growth is attributed to hyperbranching owing to the rotation of molecular bonds in the building units (FIG. 4) as well as random stacking owing to the small energy differences between different stacking orders. This is illustrated in FIG. 4A, which shows the formation of amorphous polymers from rotationally unrestricted building units. Due to the free intramolecular bond rotation, the covalent extension of the building unit is not confined in 2D space, leading to hyperbranched 3D polymers. The inventors have found that a rapid crystallization method based on using molecular building blocks with intra- and interlayer hydrogen bonding and dipole induced antiparallel stacking of the COF layers can be advantageous In FIG. 4B, COF formation via rotationally regulated synthesis is shown. DFT-optimized COF exhibits antiparallel stacking and intramolecular hydrogen bonding restricts bond rotation, confining the formation of covalent linkages in 2D space; the intermolecular hydrogen bond further limits the random sliding of each of the COF layers, leading to a periodically stacked structure.

By exploiting these bondings and arrangements, a rapid, scalable production of highly crystalline 2D acylhydrazone COFs via acylhydrazide linkers with different side chain functionalities, topicities, and geometries can be obtained. The experiments and density functional theory (DFT) calculations showed herein demonstrates that the combination of dipole-induced antiparallel stacking and intra and interlayer hydrogen bonding is advantageous for fast growth in acylhydrazone COFs.

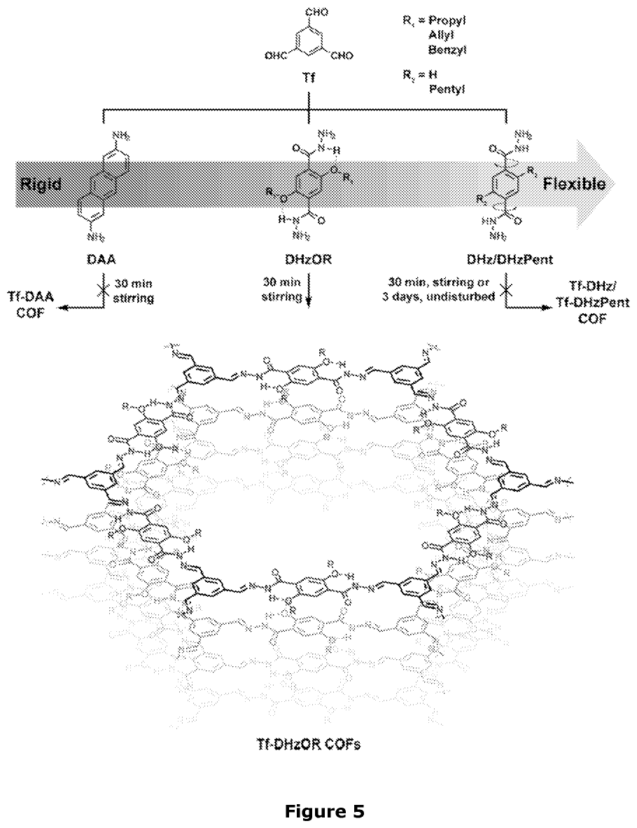

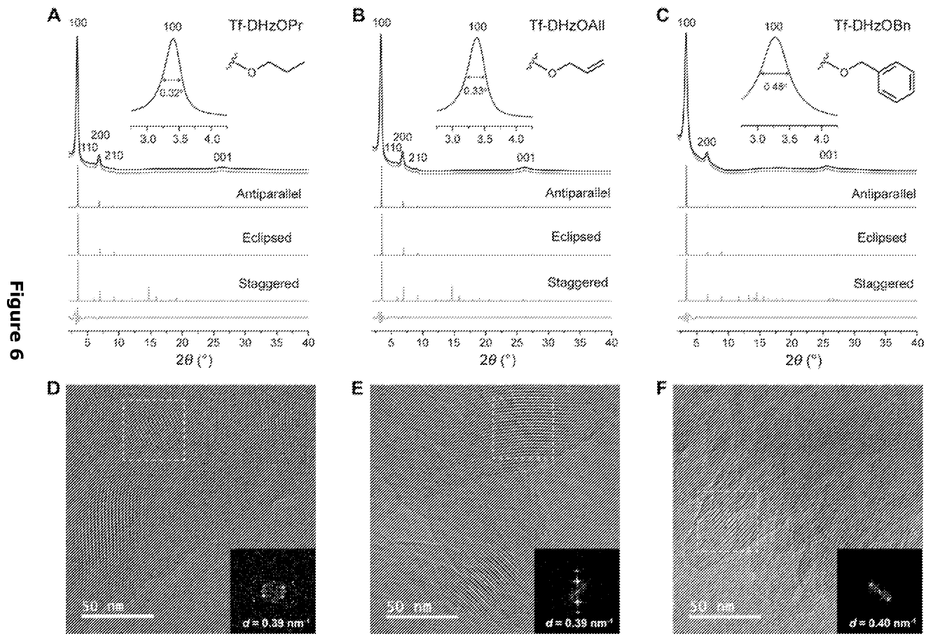

To access both intra- and interlayer hydrogen bonding in the COF system for fast crystallization, it is expected that both in-plane rigidity and out-of-plane flexibility are required for the building blocks. To prove this hypothesis, COFs from three isoreticular structures were prepared with different degrees of rotational freedom (FIG. 5) under standard solvothermal growth conditions (see ‘Examples’). Three isoreticular materials were synthesized using three types of building units having highly similar geometry but different rigidities and with the commonly used 1,3,5-triformylbenzene (Tf) as the linker. Anthracene-2,6-diamine (DAA) has the greatest number of bonds frozen in the fused benzene rings of the backbone, thus it is the most rigid among the three types of building units used. Terephthalohydrazide (DHz) or 2,5-dipentylterephthalohydrazide (DHzPent), which is incapable of hydrogen bonding, is the most flexible building unit among the three. 2,5-Dialkyloxylterephthalohydrazide (DHzOR, R=propyl, allyl, and benzyl) possesses both rigidity and flexibility due to regulated bond rotation via intramolecular hydrogen bonding in a six membered ring. Powder X-ray diffraction (PXRD) analysis is used for crystallinity confirmation and the structural determination of COFs. The full width at half-maximum (fwhm) of the strongest (100) peak to determine the quality of the COF crystals, which was estimated by the Bruker software diffraceva-v5.1.

Under standard solvothermal growth conditions, the condensation of Tf and DHz/DHzPent affords only amorphous products, suggesting that a highly flexible building unit with unconstrained bond rotation reduces crystallinity. Meanwhile, Schiff base condensation of Tf and DAA affords COFs with good-to moderate crystallinity (fwhm₁₀₀=0.49-0.69°) under standard long-duration solvothermal growth conditions, indicating that the restriction of molecular bond rotation is beneficial to COF growth. Using Tf and DHzOR (R=Pr, All, or Bn), hydrazone COFs with different side-chain functionalities, including propoxy, allyloxy, and benzyloxy, can be synthesized. When grown under standard long duration conditions, the isolated Tf-DHzOR COF products exhibit excellent crystallinity with intense PXRD peaks and fwhm₁₀₀ values of 0.36, 0.25, and 0.56° for Tf-DHzOPr, Tf-DHzOAll, and Tf-DHzOBn, respectively.

The effect of bond rotation restriction in enhancing crystallization was tested by growing COFs under ultrafast and robust conditions. The building units were heated under stirring in air for 30 min in different solvents using concentrated acetic acid as the catalyst. Both DAA and DHz/DHzPent afforded amorphous polymers upon condensation with Tf, suggesting insufficient time for self correction. The FT-IR spectra of Tf-DHzOR prepared under ultrafast robust conditions are consistent with those prepared for longer times, suggesting that the polymerization of Tf-DHzOR was completed in 30 min. Unexpectedly, condensations of Tf and the DHzOR species afford highly homogeneous and crystalline COFs, as confirmed by the intense PXRD peaks with the narrow fwhm₁₀₀ (FIG. 6). This suggests that the restriction of bond rotation via intra- and interlayer hydrogen bonding is an efficient method to shorten the time needed for crystallization. Besides, this method can be used to produce high-quality COFs bearing propoxy, allyloxy, and benzyloxy side-chain functionalities with narrow XRD fwhm₁₀₀ values of 0.32, 0.33, and 0.48°, respectively (FIG. 6), indicating good tolerance to variable side-chain functionalities. The high tolerance of side-chain functionalities suggests the great value of this type of COF for the application-led design of the materials.

Specifically, FIG. 6 illustrates powder X-ray diffraction (PXRD) patterns of exemplary COFs with ditopic building units. PXRD characterization of (A) Tf-DHzOPr COF with a propoxy side chain, (B) Tf-DHzOAll COF with an allyloxy side chain, and (C) Tf-DHzOBn COF with a benzyloxy side chain. The plots show the experimental results (dark plot), Pawley-refined (lighter plot), simulated antiparallel stacking, simulated eclipsed stacking, simulated staggered stacking, and the difference between experimental and Pawley-refined PXRD patterns (bottom most plot).

PXRD patterns exhibited the most intense peaks at 3.41, 3.37, and 3.27° for the fast-produced Tf-DHzOPr, Tf-DHzOAll, and Tf-DHzOBn, respectively, corresponding to their (100) facets. Tf-DHzOPr showed another four peaks at 5.93, 6.91, 9.18, and 26.43°, corresponding to the (110), (200), (210), and (001) facets. Similarly, Tf-DHzOAll displayed another four peaks at 5.93, 6.85, 9.12, and 26.43°, corresponding to the (110), (200), (210), and (001) facets. Tf-DHzOBn exhibited another three peaks at 6.60, 8.77, and 25.67°, corresponding to the (200), (210), and (001) facets. Structures based on antiparallel, eclipsed, and staggered stacking have been simulated for the three COFs. The PXRD patterns of antiparallel and eclipsed structures agree well with experiments.

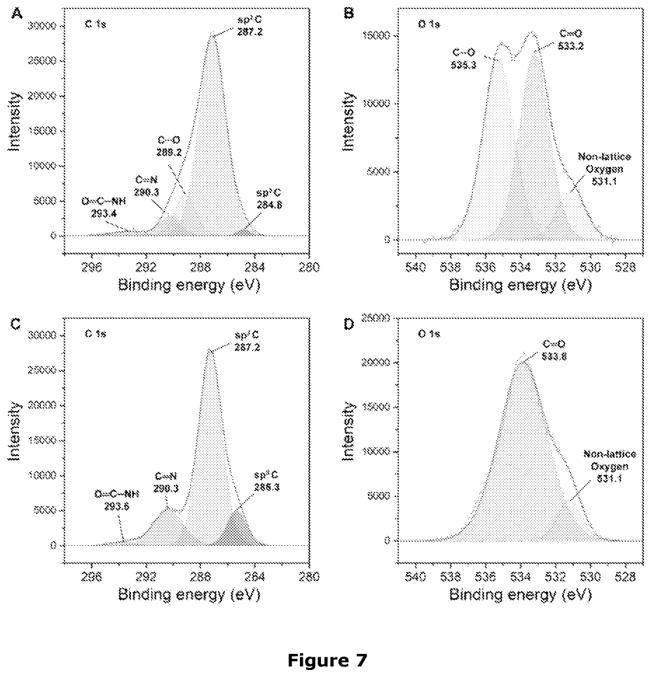

To further confirm the COF structures, single crystals of model compounds were grown (using benzaldehyde) and DFT simulations performed. The single-crystal structures of the model compounds revealed that the intramolecular hydrogen-bonded fragments exhibited antiparallel packing, while the non-hydrogen-bonded molecules show parallel packing. This suggests that intramolecular hydrogen bonding facilitates antiparallel stacking, which may be explained by the fact that the restriction of bond rotation increases in-plane rigidity and allows the bond dipole moments due to C(δ+)=O(δ−) and O(δ−)—R(δ+) to spatially orient in the in-plane direction. This allows strong dipole-dipole interaction with the antiparallel stacked layers. Moreover, simulations revealed that the total energy of DFT optimized antiparallel stacked Tf-DHzOAll is 3.07 eV per unit cell (containing two layers) more stable than the eclipsed stacked structure. Besides, simulated structures based on DFT optimization or universal force field calculation exhibited a π-π interlayer distance of 3.4-3.5 Å for antiparallel stacked structures, in stark contrast to 3.7-3.8 Å for eclipsed stacked structures, where the former agrees well with our experimental PXRD results. The DFT-optimized antiparallel stacked Tf-DHzOAll suggests the existence of interlayer hydrogen bonding between the acyl oxygen and the side-chain hydrogen in the adjacent layer, which is consistent with the X ray photoelectron spectroscopy (XPS) and the solid-state 13C NMR spectra. The O 1s spectra reveal the binding energy for C═O shifts from 533.8 eV (non-hydrogen-bonded Tf-DHz) to 533.2 eV (Tf-DHzOAll) (FIG. 7), indicating a change in the chemical environment of the acyl oxygen due to interlayer hydrogen bonding. FIG. 7 shows (A) C 1s spectrum of Tf-DHzOAll, (B) O 1s spectrum of Tf-DHzOAll. The binding energy at 535.3 eV is assigned to the allyoxy oxygen. FIG. 7 shows at (C) C 1s spectrum of Tf-DHz, and (D) O 1s spectrum of Tf-DHz.

Furthermore, solid-state ¹³C NMR spectra reveal a chemical shift of acyl carbon from 164.1 ppm (Tf-DHz) to 156.5 ppm (Tf-DHzOAll). This is because the interlayer hydrogen bonding in Tf-DHzOAll weakens the electron-withdrawing ability of the acyl oxygen, resulting in a stronger electron shielding of the acyl carbon and therefore the upfield shift. In addition, comparing the 13C NMR spectra of Tf-DHzOAll COF and DHzOAll model compound, the chemical shift of the acyl carbon is at 161.42 ppm for the major DHzOAll model isomer, while it is at 156.5 ppm for Tf-DHzOAll COF. This strongly suggests that COFs adopt antiparallel stacking to facilitate interlayer hydrogen bonding involving acyl oxygen. The Pawley refinement based on antiparallel structures displayed good consistency with the experimental PXRD patterns, with (Rp, Rwp) values of (4.49%, 5.64%), (3.50%, 4.28%), and (2.46%, 3.08%) for Tf-DHzOPr, Tf-DHzOAll, and Tf-DHzOBn, respectively. The Tf-DHzOR COFs all adopt antiparallel stacking with Pawley refined cells belonging to the P6CC space group and cell parameters of a=b=29.62 Å and c=6.98 Å for Tf-DHzOPr, a=b=29.86 Å and c=7.07 Å for Tf-DHzOAll, and a=b=30.18 Å and c=7.04 Å for Tf-DHzOBn.

The low-dose cryogenic transmission electron microscopy (TEM) also confirmed the good crystallinity of the COFs obtained under ultrafast conditions (FIG. 6D-F). FIG. 6 shows TEM images of (D) Tf-DHzOPr COF, (E) Tf-DHzOAll COF, and (F) Tf-DHzOBn COF. The samples were imaged at cryogenic temperature with liquid nitrogen cooling, with the insets showing FFT of the lattice fringes. The fast Fourier transform (FFT) of the lattice fringes suggests d spacings of 25.4, 25.5, and 25.0 Å for Tf-DHzOPr, Tf-DHzOAll, and Tf-DHzOBn, respectively, which are consistent with the d spacings of 25.9, 26.2, and 27.0 Å derived from PXRD patterns of the (100) facets for Tf-DHzOPr, Tf-DHzOAll, and Tf-DHzOBn, respectively.

The quality of COFs obtained via ultrafast synthesis was further evaluated by nitrogen sorption experiments at 77 K. The sorption isotherms exhibit mainly type-I adsorption profiles with abrupt increases at P/P0<0.1, indicating the microporosity of the materials. The Brunauer-Emmett-Teller (BET) surface areas of Tf-DHzOPr and Tf-DHzOAll are 701 and 501 m²g⁻¹, respectively, comparable to the corresponding values of 747 and 461 m²g⁻¹ obtained for COFs synthesized over longer periods. Compared to these, Tf-DHzOBn has a lower BET surface area of between 163 and 254 m²g⁻¹, which is due to the bulky benzyl groups on the pore walls. On the basis of the nonlocalized density functional theory (NLDFT) calculation, the pore widths have the greatest distributions centered at 1.69, 1.69, and 1.41 nm for Tf-DHzOPr, Tf-DHzOAll, and Tf-DHzOBn, respectively, indicating good uniformity of the pores. The hysteresis in the isotherms suggests that there are also mesopores in the COFs, which is due to the flexible side chains on the pore walls, and these cause capillary condensation of the gas adsorbed.

The structural key to achieving ultrafast synthesis of highly crystalline COFs is the intramolecular N—H . . . O bonding formed in a six-membered ring in the alkyloxy-substituted hydrazide system. This molecular scaffold is fundamental to the construction of intra- and interlayer hydrogen bonding in 2D COFs as well as facilitating dipole-dipole interactions in antiparallel stacked configurations. First, intralayer hydrogen bonding helps restrict molecular bond rotation and rigidifies the structure, confining the covalent extension of COF to a 2D plane. Second, the in-plane rigidity allows the bond dipole moments to lie in-plane, facilitating antiparallel stacking between the COF layers to minimize the total energy. Third, the interlayer hydrogen bonding between the acyl oxygen and the side chain/hydrazone linkage from adjacent layers prevents the layers from sliding out of alignment and generating stacking faults. The interplay between different degrees of intra- and interlayer hydrogen bonding modulates the rigidities of the COF layers, leading to high structural adaptability for fast crystallization. Therefore, a molecular scaffold with the ability for intralayer/interlayer H bonding should be a useful building block for the fast growth of 2D COF. Accordingly, a tritopic building unit, THzOPr was designed and synthesized (Scheme 1).

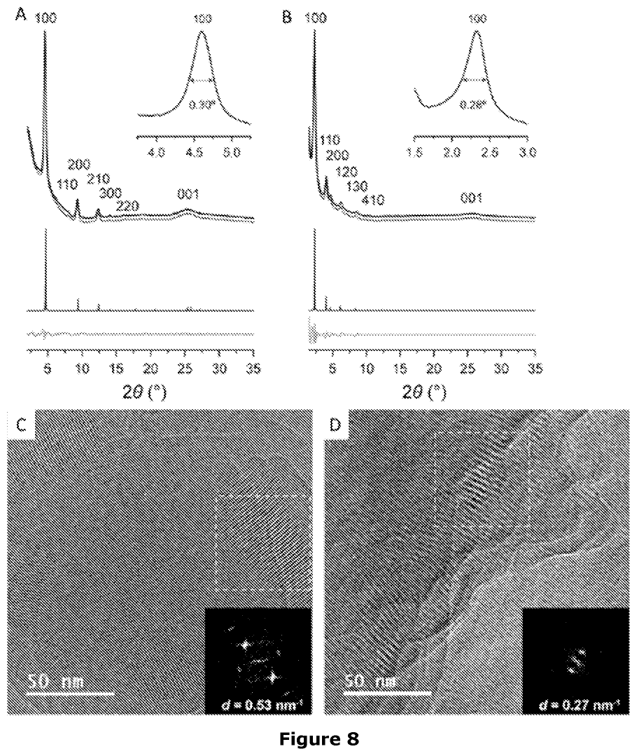

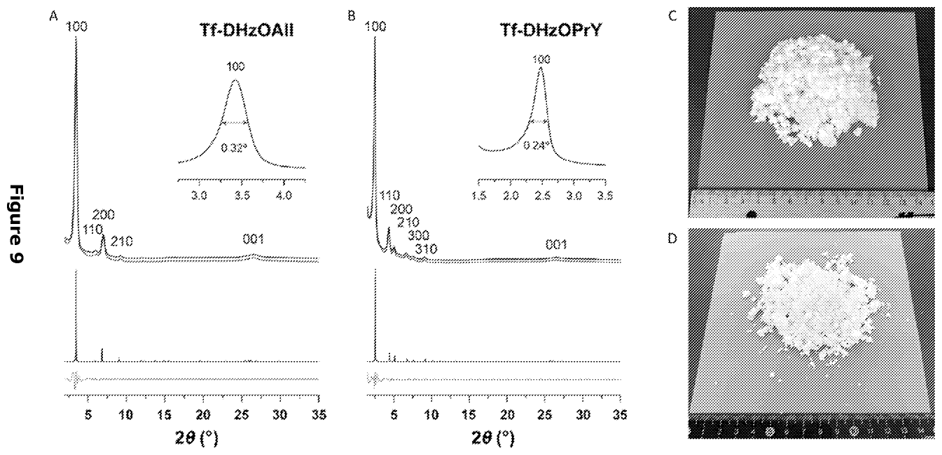

A tritopic building unit with three sites of rotation regulation via hydrogen bonding, THzOPr, was designed and synthesized. Under ultrafast robust conditions, it can form highly crystalline COFs with linkers possessing different symmetries. As shown in FIG. 8(A), the PXRD patterns of (A) Tf-THzOPr COF and (B) Df-THzOPr COF illustrates a highly crystalline form (from top to bottom: experimental; Pawley-refined; simulated antiparallel stacking; difference in experimental and Pawley-refined PXRD).

To construct network structures in COFs, the total topicity of the building units should be no less than 5. From the synthesis viewpoint, a tritopic hydrazide building unit is more versatile because both ditopic and tritopic aldehydes can be reacted with THzOPr to form COFs. Using the most common tritopic aldehyde Tf and ditopic aldehyde, terephthalaldehyde (Df), as examples, highly crystalline COFs can be produced in only 30 min via condensation between THzOPr and C3-symmetric Tf or C2-symmetric Df, respectively. The PXRD patterns of Tf-THzOPr and Df-THzOPr COFs exhibit narrow fwhm₁₀₀ values of 0.30 and 0.28°, respectively, confirming their excellent crystallinities. Tf-THzOPr showed seven PXRD peaks at 4.61, 7.97, 9.31, 12.30, 14.04, 16.17, and 25.41°, corresponding to the (100), (110), (200), (210), (300), (220), and (001) facets. Df-THzOPr displayed seven peaks at 2.32, 4.06, 4.69, 6.25, 8.50, 10.28, and 25.79°, corresponding to the (100), (110), (200), (120), (130), (410), and (001) facets. Structures based on antiparallel, eclipsed, and staggered stacking have been simulated for Tf-THzOPr and Df-THzOPr. The experimental PXRD patterns agreed well with the simulated antiparallel stacking ones. The Pawley refinement based on the antiparallel structures displayed good consistency with the experimental PXRD patterns, with (Rp, Rwp) values of (2.15%, 2.89%) and (3.81%, 5.03%) for Tf-THzOPr and Df-DHzOPr, respectively. Both COFs adopt antiparallel stacking with Pawley-refined cell parameters of a=b=21.75 Å and c=6.99 Å with the P3C1 space group for Tf-THzOPr and a=b=43.86 Å and c=6.70 Å with the P6 space group for Df-THzOPr.

SEM images revealed highly uniform spherical morphologies for THzOPr COFs. The excellent crystallinity of THzOPr COFs was also verified by TEM (FIG. 8C,D). FIG. 8 shows TEM images of (D) Tf-THzOPr COF and (E) Df-THzOPr COF. The samples were imaged at cryogenic temperature with liquid nitrogen cooling, and the insets shows FFT of the lattice fringes. The fast Fourier transform (FFT) of the lattice fringes suggests d spacings of 19.0 and 37.3 Å for Tf-THzOPr and Df-THzOPr, respectively, which are consistent with the d spacings of 19.2 and 38.1 Å derived from PXRD patterns of the (100) facets for Tf-THzOPr and Df-THzOPr, respectively.

Additionally, nitrogen sorption studies revealed a type-I isotherm for Tf-THzOPr COF and a type-IV isotherm for Df-THzOPr COF, typical for microporous and mesoporous materials, respectively. The estimated BET surface areas were 842 and 595 m²g⁻¹ for Tf-THzOPr COF and Df-THzOPr COF, respectively. The pore size calculation also reveals that the pores are uniformly distributed around 1.13 and 2.77 nm for Tf-THzOPr COF and Df-THzOPr, respectively, consistent with the simulated values. These results provide strong evidence that the restriction of bond rotation can be generalized to construct 2D COFs with diverse structures.

The ultrafast method under open, robust conditions is desirable for the large-scale production of high-quality COFs and in principle can be scaled up to any amount depending on the requirement. As a proof of concept, two highly crystalline COFs on the gram scale were synthesized under the ultrafast conditions, with one-pot yields of 1.4 and 1.09 g for Tf-DHzOAll and Tf-DHzOPrY, respectively (Scheme 2).

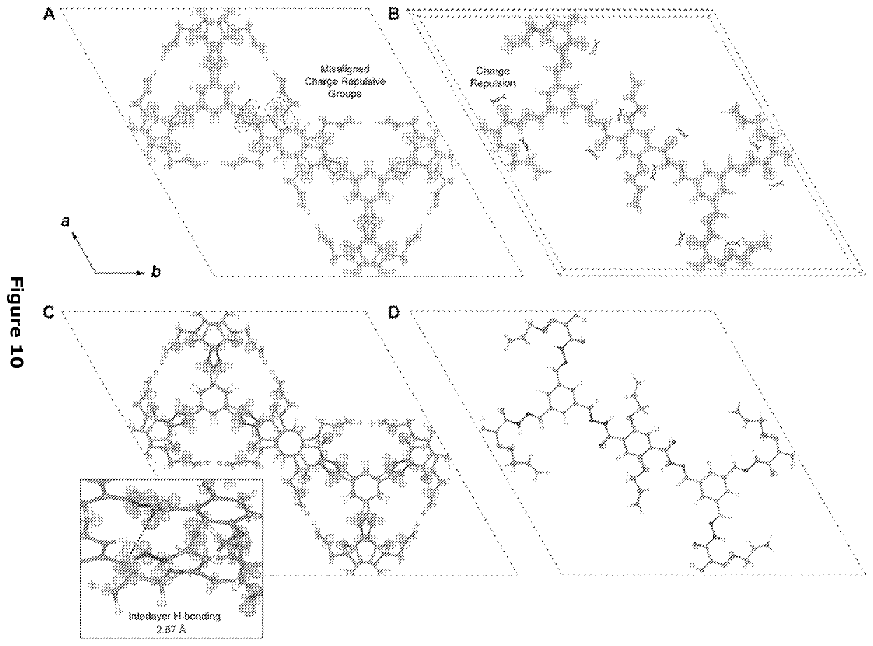

FIG. 9 illustrates the results of a one-pot synthesis of highly crystalline COFs in gram scale. PXRD patterns of (A) Tf-DHzOAll COF and (B) Tf-DHzOPrY COF are shown (from top to bottom: experimental; Pawley-refined; simulated antiparallel stacking; difference of experimental and Pawley-refined PXRD), and photographic images of the gram-scale produced (C) Tf-DHzOAll COF and (D) Tf-DHzOPrY COF.

The newly designed DHzOPrY building unit possesses two acylhydrazide groups that are hydrogen bonded to the propyoxy side chains and linked by an acetylene group. The PXRD patterns of Tf-DHzOPrY exhibit a narrow fwhm₁₀₀ of 0.24°, suggesting good crystallinity. Seven PXRD peaks were observed at 2.49, 4.33, 5.00, 6.72, 7.67, 9.10, and 26.27°, which correspond to the (100), (110), (200), (210), (300), (310), and (001) facets, respectively. Antiparallel, eclipsed, and staggered stacked Tf-DHzOPrY structures have been simulated. The experimental PXRD patterns agreed well with the simulated antiparallel stacking one. The Pawley refinement based on the antiparallel structure displayed good consistency with the experimental PXRD patterns, with (Rp, Rwp) values of (3.59%, 4.64%) for Tf-DHzOPrY. The Tf-DHzOPrY COF adopts antiparallel stacking with Pawley-refined cells belong to the P6CC space group and cell parameters of a=b=40.07 Å and c=6.94 Å. The nitrogen sorption studies reveal a typical type-IV isotherm for Tf-DHzOPrY, suggesting its mesoporosity. The BET surface area of Tf-DHzOPrY was estimated to be 759 m²g⁻¹. According to the NLDFT calculation, the pore size distribution of Tf-DHzOPrY was localized at 2.66 nm, suggesting the uniformity of the pores.

Since the dipole-induced antiparallel stacking and intra- and interlayer hydrogen bonding are essential for the restriction of molecular bond rotation in COF crystallization, disrupting these should interfere with the crystallization of hydrazone COFs. To verify this, Tf-DHzOPr COF was grown in various polar solvents with large dipole moments under ultrafast conditions. Polar solvent molecules with large dipole serve as hydrogen bond acceptors, thus is hypothesied to interfer with intra- and intermolecular hydrogen bonding as well as dipole-induced antiparallel stacking. For COFs synthesized in aprotic nonpolar solvents, such as 1,2-dichlorobenzene (o-DCB) and mesitylene, PXRD patterns revealed that the products are highly crystalline over a short synthesis period and thus are particularly advantageous. In contrast, those prepared in polar solvents, such as 1,4-dioxane and dimethyl sulfoxide (DMSO) require a longer synthesis period for crystallisation (FIG. 11). Furthermore, the side-chain effect on the fast crystallization of COFs was studied. COFs were constructed using three different hydrazide building units (DHzOMe, DHzOEt, and DHzOPrSEt) with different side chains of methoxy, ethoxy, and (ethylthio)propoxy, representing various side-chain lengths. Under the ultrafast condition, Tf-DHzOMe did not form COF, Tf-DHzOEt (COF-42) showed slight crystallinity, and only Tf-DHzPrSEt (COF-LZU8) exhibited high crystallinity over the short synthesis period. Tf-DHzOMe and Tf-DHzOEt both require longer synthesis times for the COFs to be formed in open air conditions. One explanation is that steric hindrance due to side chains reduces monomer rotation in the COFs, preventing hyperbranching. More importantly, the DFT optimized COF structure suggests that there is significant interlayer hydrogen bonding between the acyl oxygen and the hydrogen on the second carbon of the side chain from adjacent layers (FIG. 4B). This explains why COF can be only fast crystallized when the side-chain carbon number is more than 2. Therefore, both antiparallel stacking and hydrogen bonding are critical to the ultrafast robust synthesis of highly crystalline COFs.

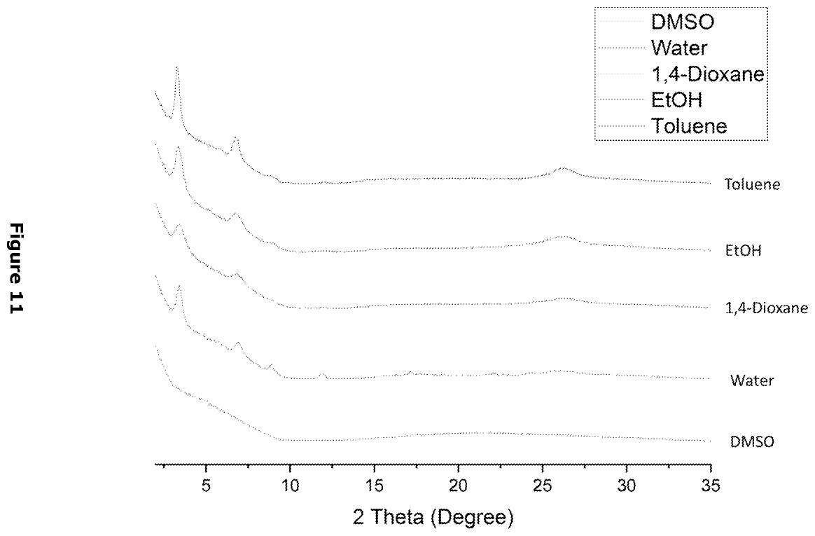

Fortified by dipole-induced antiparallel stacking and hydrogen bonding, acylhydrazone COFs exhibit good stability toward acids and bases. The good crystallinity of Tf-DHzOPr was retained after immersion in 1M HCl or 1MNaOH for 7 days. In contrast, the crystallinity of Tf-DAA COF was badly degraded after immersion in 1MHCl or 1 M NaOH for only 1 day. To obtain insights into how the crystallization of COFs is affected by hydrogen bonding, we have carried out a series of DFT calculations. To investigate how intralayer hydrogen bonding restricts bond rotation in COF layers, DFT simulations were conducted on monolayer Tf-DHzPent, which is incapable of hydrogen bonding, and Tf-DHzOAll, which can hydrogen bond. The intralayer-hydrogen-bonded COF monolayer exhibits a planarized conformation and a large rotational energy barrier against distortion, while the nonhydrogen-bonded COF monolayer displays a contorted conformation with a low rotational energy barrier. The charge density map and interlayer differential charge density of Tf-DHzOAll COF with antiparallel and eclipsed structures was calculated to study the effect of stacking (FIG. 10).

FIG. 10A shows the total charge density of Tf-DHzOAll with antiparallel stacking. Electron-rich groups are misalign to stabilize the system. FIG. 10B shows the total charge density of Tf-DHzOAll with eclipsed stacking. Charge repulsion between the electron-rich units prevents close stacking. FIG. 10C shows interlayer differential charge density of Tf-DHzOAll with antiparallel stacking. FIG. 10D shows differential charge density of Tf-DHzOAll with eclipsed stacking (green, decrease in electron density; red, increase in electron density.) The total charge density (A and B) and differential charge density (C and D) are visualized using isosurfaces of 0.25 and 0.001 e Bohr⁻³, respectively.

In the eclipsed structure, electrostatic repulsion between electron-rich groups (FIG. 10B) increases the interlayer distance (3.75 Å for eclipsed stacking). This results in weak interlayer interactions (FIG. 10D). In contrast, antiparallel stacking avoids charge repulsion (FIG. 10A) and instead allows for electrostatic interactions between layers (FIG. 10C). In the antiparallel structure, there is a significant decrease in electron density on the acyl oxygen and the hydrogen on the second carbon of the side chain in the adjacent layer and an increase in electron density on the outer shell of the acyl oxygen, which is consistent with the interlayer hydrogen bonding.

Accordingly, the present invention also provides a method of fabricating a covalent organic framework (COF), comprising:

stirring a first monomer comprising an optionally substituted 2-alkoxybenzohydrazidyl moiety with second monomer comprising a benzaldehydyl moiety under heat and in open air for at least 15 min in order to form an acylhydrazone bond;

wherein the COF is formable after about 15 min;

wherein the first monomer and the second monomer has a total topicity of at least 5;

wherein the first monomer and the second monomer both independently have a conjugated pi bond system; and

wherein the optionally substituted 2-alkoxybenzohydrazidyl moiety is selected from optionally substituted 2-(C₁-C₆)alkoxybenzohydrazidyl or 2-benzyloxybenzohydrazidyl.

In this regard, the (C₁-C₆)alkoxy can be methoxy and ethoxy.

The present invention also provides a method of fabricating a covalent organic framework (COF), comprising:

stirring a first monomer comprising an optionally substituted 2-alkoxybenzohydrazidyl moiety with second monomer comprising a benzaldehydyl moiety under heat and in open air for at least 15 min in order to form an acylhydrazone bond;

wherein the COF is formable after about 15 min;

wherein the first monomer and the second monomer has a total topicity of at least 5;

wherein the first monomer and the second monomer both independently have a conjugated pi bond system; and

wherein the optionally substituted 2-alkoxybenzohydrazidyl moiety is selected from optionally substituted 2-(C₃-C₆)alkoxybenzohydrazidyl or 2-benzyloxybenzohydrazidyl.

In stereochemistry, topicity is the stereochemical relationship between substituents and the structure to which they are attached. Depending on the relationship, such groups can be heterotopic, homotopic, enantiotopic, or diastereotopic. In this regard, the ‘topicity’ can also refer to the number of hydrazine or aldehyde functional groups on the first or second monomer.

A conjugated pi bond system is a system of connected p orbitals with delocalized electrons in a molecule, which in general lowers the overall energy of the molecule and increases stability. It is conventionally represented as having alternating single and multiple bonds. Lone pairs, radicals or carbenium ions may be part of the system, which may be cyclic, acyclic, linear or mixed. Conjugation is the overlap of one p orbital with another across an intervening a bond (in transition metals d orbitals can be involved). A conjugated system has a region of overlapping p orbitals, bridging the inter adjacent locations that simple diagrams illustrate as not having a n bond. They allow a delocalization of n electrons across all the adjacent aligned p orbitals. The n electrons do not belong to a single bond or atom, but rather to a group of atoms.

The present invention also provides a method of fabricating a COF comprising: stirring a first monomer comprising an optionally substituted 2-alkoxybenzohydrazidyl moiety with second monomer comprising a benzaldehydyl moiety under heat and in open air for at least 15 min in aprotic non-polar solvent in order to form an acylhydrazone bond;

wherein the COF is formable after about 15 min; and

wherein the optionally substituted 2-alkoxybenzohydrazidyl moiety is selected from optionally substituted 2-(C₁-C₆)alkoxybenzohydrazidyl or 2-benzyloxybenzohydrazidyl.

The present invention also provides a method of fabricating a COF comprising: stirring a first monomer comprising an optionally substituted 2-alkoxybenzohydrazidyl moiety with second monomer comprising a benzaldehydyl moiety under heat and in open air for at least 15 min in aprotic non-polar solvent in order to form an acylhydrazone bond;

wherein the COF is formable after about 15 min; and

wherein the optionally substituted 2-alkoxybenzohydrazidyl moiety is selected from optionally substituted 2-(C₃-C₆)alkoxybenzohydrazidyl or 2-benzyloxybenzohydrazidyl.

In some embodiments, first monomer is selected from one of the following:

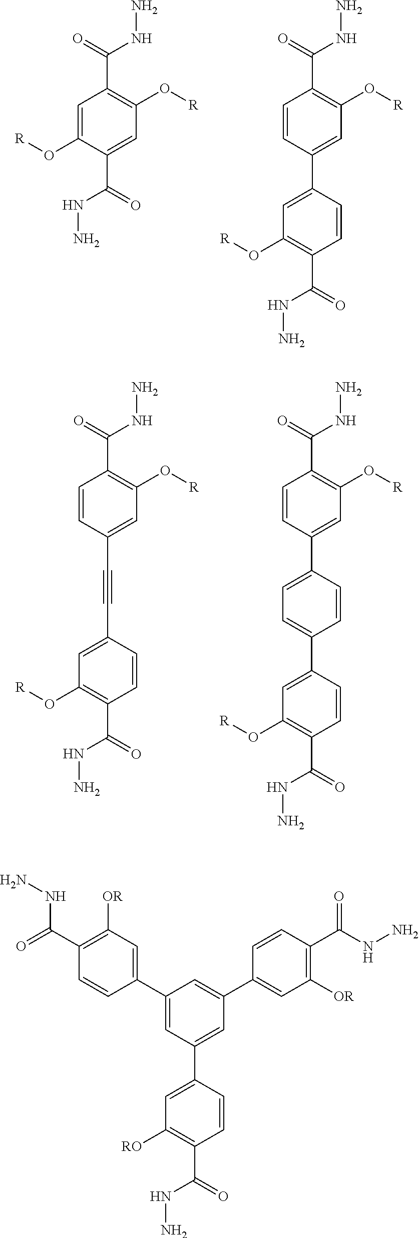

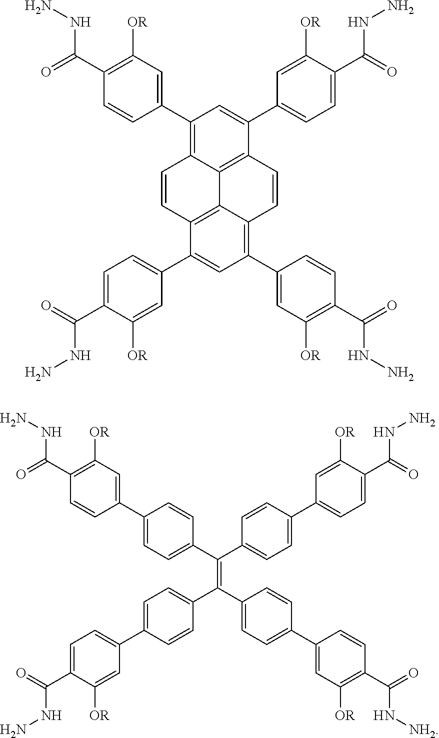

In other embodiments, the optionally substituted 2-alkoxybenzohydrazidyl moiety is an optionally substituted 2-(C₃-C₈)alkoxybenzohydrazidyl moiety. For example, the optionally substituted 2-alkoxybenzohydrazidyl moiety can be 2-propoxybenzohydrazidyl, 2-allyloxybenzohydrazidyl, 2-propargyloxybenzohydrazidyl or 2-(ethylthio)propoxybenzohydrazidyl. In other embodiments, optionally substituted 2-alkoxybenzohydrazidyl moiety is 2-benzyloxybenzohydrazidyl.

In some embodiments, first monomer is selected from one of the following:

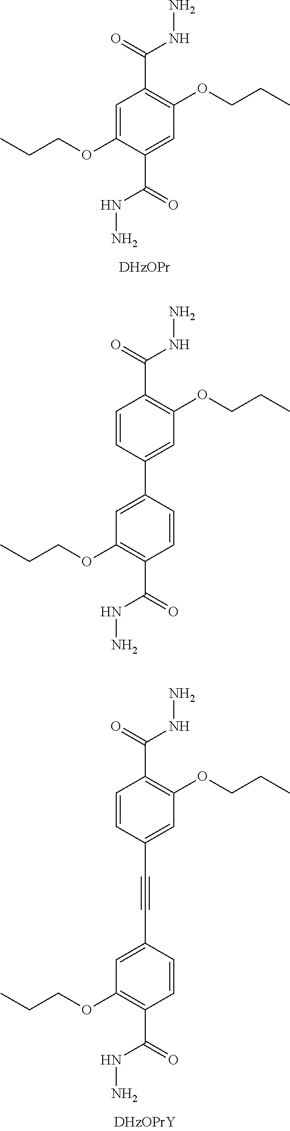

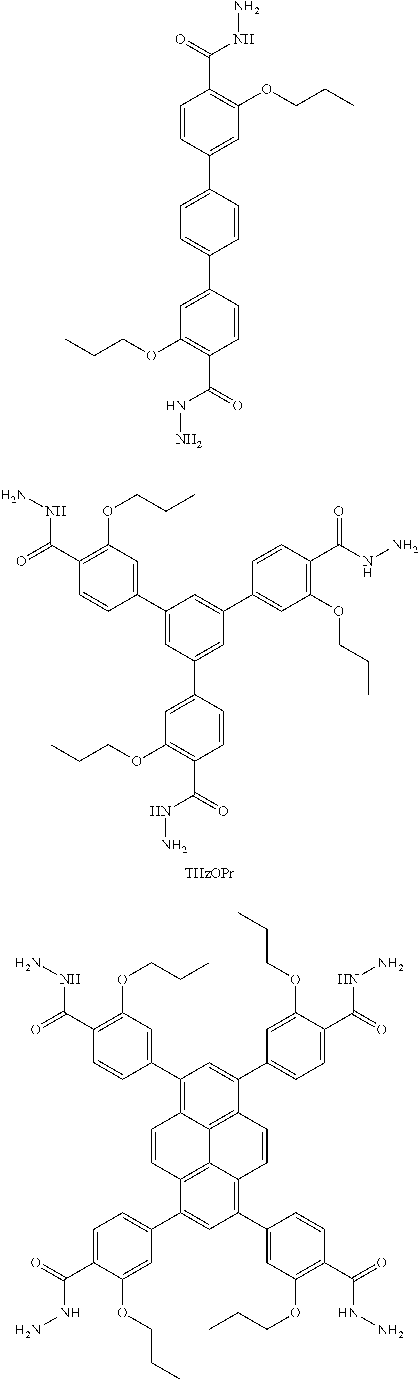 [SMILES: CCCOc1cc(-c2ccc(-c3ccc(C(=O)NN)c(OCCC)c3)cc2)ccc1C(=O)NN ; CCCOc1cc(-c2cc(-c3ccc(C(=O)NN)c(OCCC)c3)cc(-c3ccc(C(=O)NN)c(OCCC)c3)c2)ccc1C(=O)NN ; CCCOc1cc(-c2cc(-c3ccc(C(=O)NN)c(OCCC)c3)c3ccc4c(-c5ccc(C(=O)NN)c(OCCC)c5)cc(-c5ccc(C(=O)NN)c(OCCC)c5)c5ccc2c3c54)ccc1C(=O)NN]

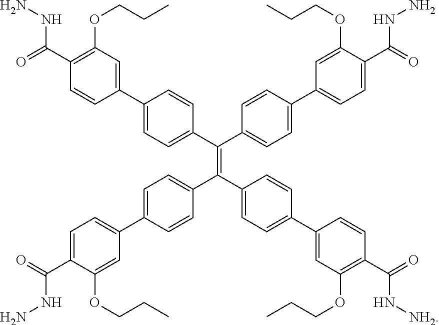 [SMILES: CCCOc1cc(-c2ccc(C(=C(c3ccc(-c4ccc(C(=O)NN)c(OCCC)c4)cc3)c3ccc(-c4ccc(C(=O)NN)c(OCCC)c4)cc3)c3ccc(-c4ccc(C(=O)NN)c(OCCC)c4)cc3)cc2)ccc1C(=O)NN]

In some embodiments, first monomer is selected from one of the following:

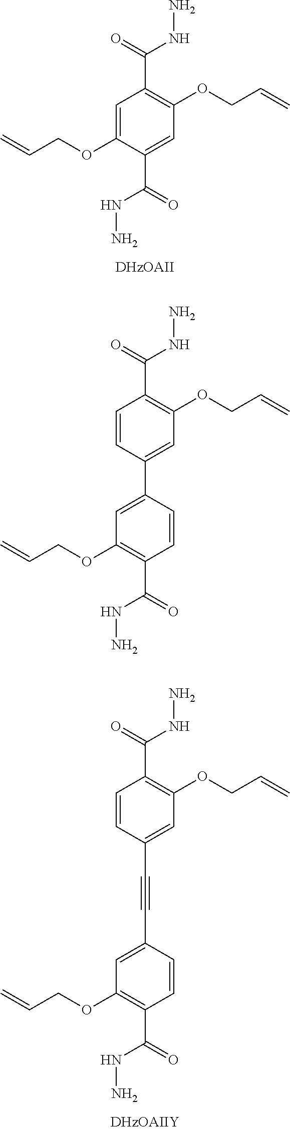

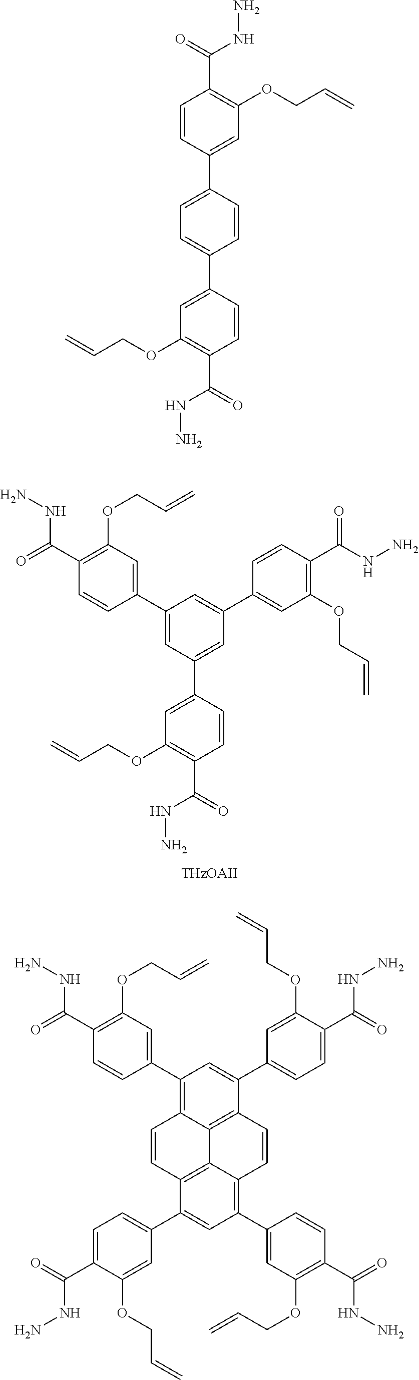 [SMILES: C=CCOc1cc(-c2ccc(-c3ccc(C(=O)NN)c(OCC=C)c3)cc2)ccc1C(=O)NN ; C=CCOc1cc(-c2cc(-c3ccc(C(=O)NN)c(OCC=C)c3)cc(-c3ccc(C(=O)NN)c(OCC=C)c3)c2)ccc1C(=O)NN ; C=CCOc1cc(-c2cc(-c3ccc(C(=O)NN)c(OCC=C)c3)c3ccc4c(-c5ccc(C(=O)NN)c(OCC=C)c5)cc(-c5ccc(C(=O)NN)c(OCC=C)c5)c5ccc2c3c54)ccc1C(=O)NN]

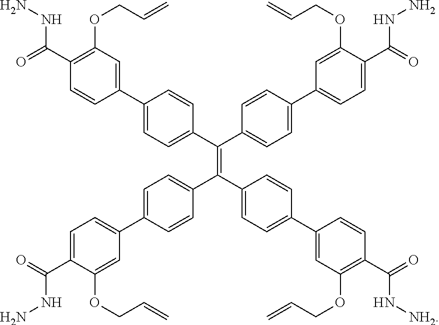 [SMILES: C=CCOc1cc(-c2ccc(C(=C(c3ccc(-c4ccc(C(=O)NN)c(OCC=C)c4)cc3)c3ccc(-c4ccc(C(=O)NN)c(OCC=C)c4)cc3)c3ccc(-c4ccc(C(=O)NN)c(OCC=C)c4)cc3)cc2)ccc1C(=O)NN]

In some embodiments, first monomer is selected from one of the following:

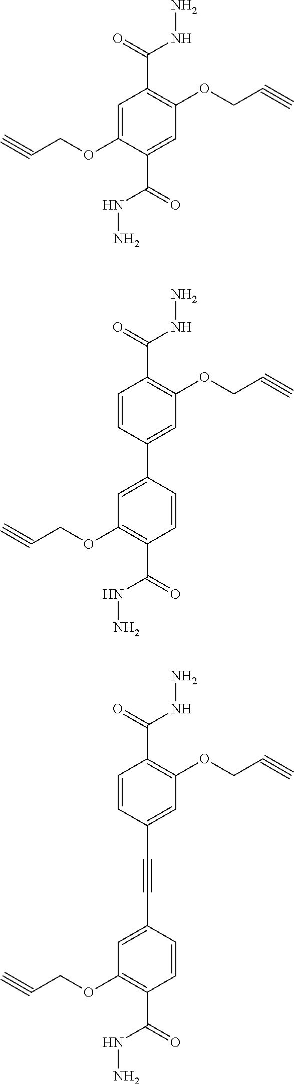

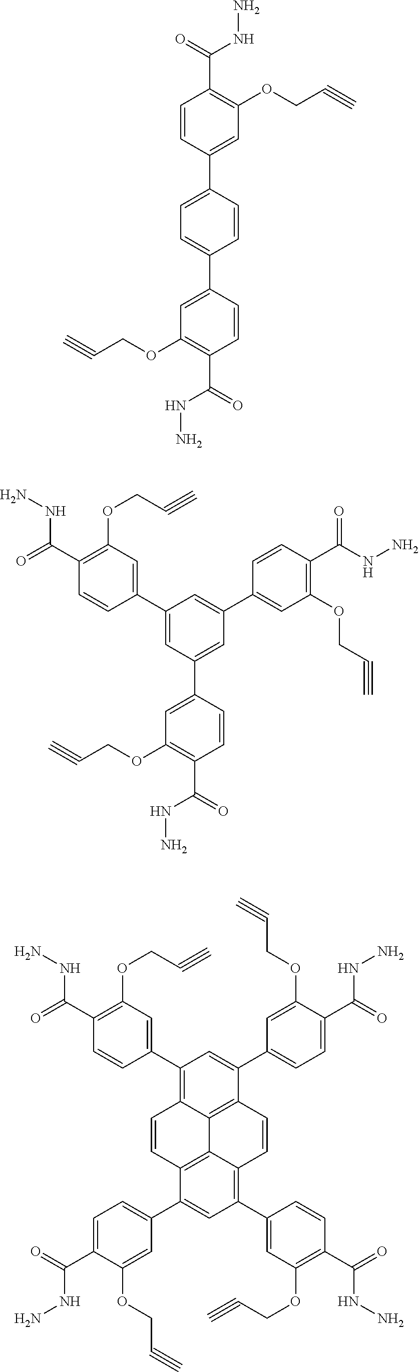 [SMILES: C#CCOc1cc(-c2ccc(-c3ccc(C(=O)NN)c(OCC#C)c3)cc2)ccc1C(=O)NN ; C#CCOc1cc(-c2cc(-c3ccc(C(=O)NN)c(OCC#C)c3)cc(-c3ccc(C(=O)NN)c(OCC#C)c3)c2)ccc1C(=O)NN ; C#CCOc1cc(-c2cc(-c3ccc(C(=O)NN)c(OCC#C)c3)c3ccc4c(-c5ccc(C(=O)NN)c(OCC#C)c5)cc(-c5ccc(C(=O)NN)c(OCC#C)c5)c5ccc2c3c54)ccc1C(=O)NN]

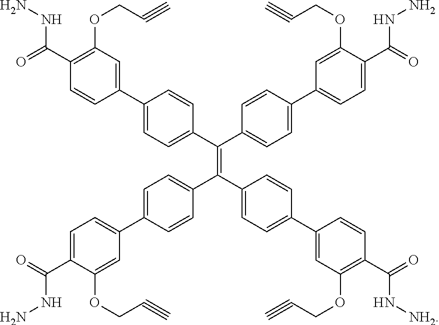 [SMILES: C#CCOc1cc(-c2ccc(C(=C(c3ccc(-c4ccc(C(=O)NN)c(OCC#C)c4)cc3)c3ccc(-c4ccc(C(=O)NN)c(OCC#C)c4)cc3)c3ccc(-c4ccc(C(=O)NN)c(OCC#C)c4)cc3)cc2)ccc1C(=O)NN]

In some embodiments, first monomer is selected from one of the following:

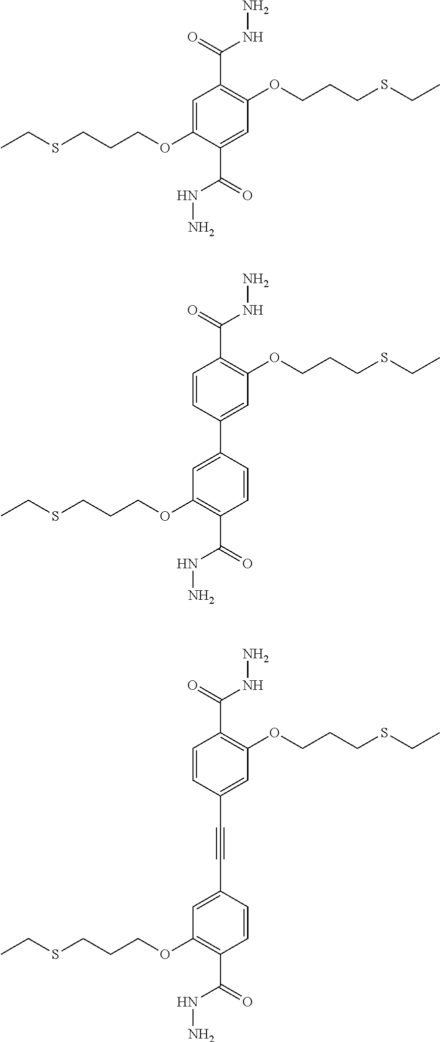

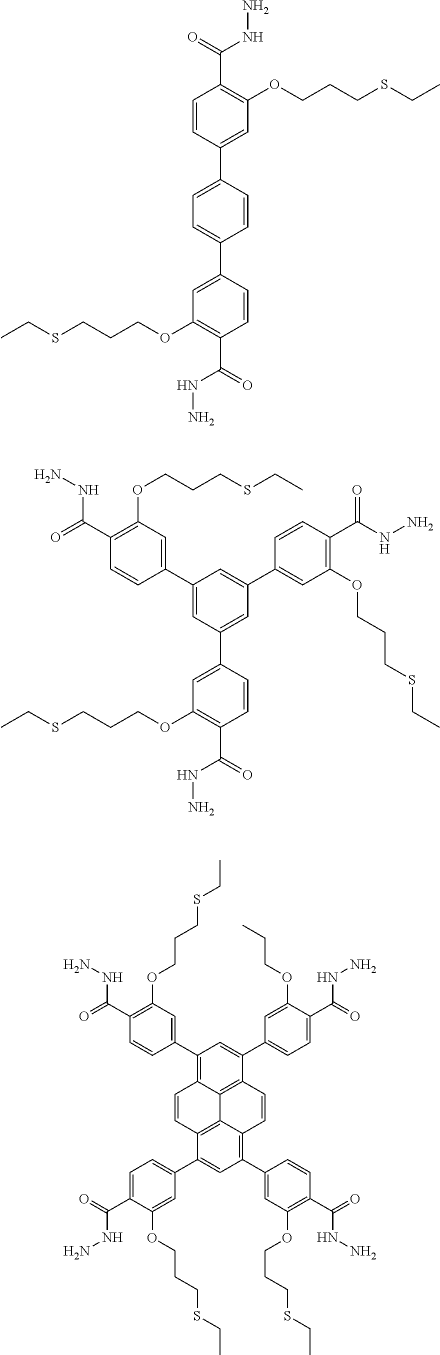

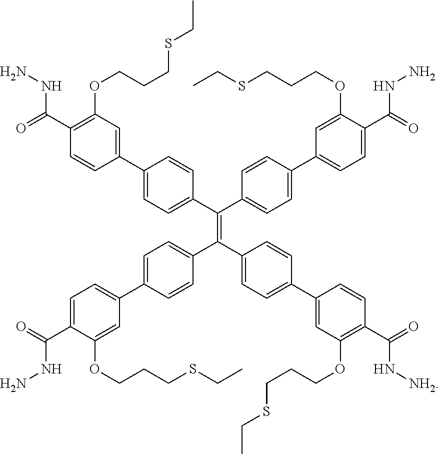 [SMILES: CCSCCCOc1cc(-c2ccc(C(=C(c3ccc(-c4ccc(C(=O)NN)c(OCCCSCC)c4)cc3)c3ccc(-c4ccc(C(=O)NN)c(OCCCSCC)c4)cc3)c3ccc(-c4ccc(C(=O)NN)c(OCCCSCC)c4)cc3)cc2)ccc1C(=O)NN]

In some embodiments, first monomer is selected from one of the following:

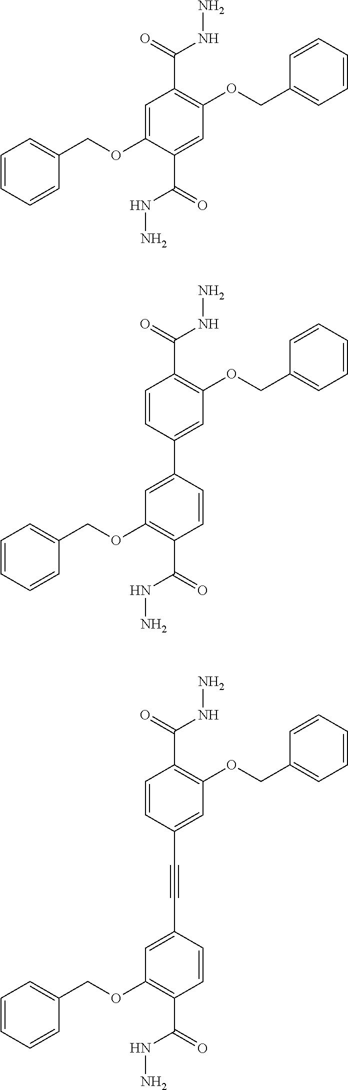 [SMILES: NNC(=O)c1cc(OCc2ccccc2)c(C(=O)NN)cc1OCc1ccccc1 ; NNC(=O)c1ccc(-c2ccc(C(=O)NN)c(OCc3ccccc3)c2)cc1OCc1ccccc1 ; NNC(=O)c1ccc(C#Cc2ccc(C(=O)NN)c(OCc3ccccc3)c2)cc1OCc1ccccc1]

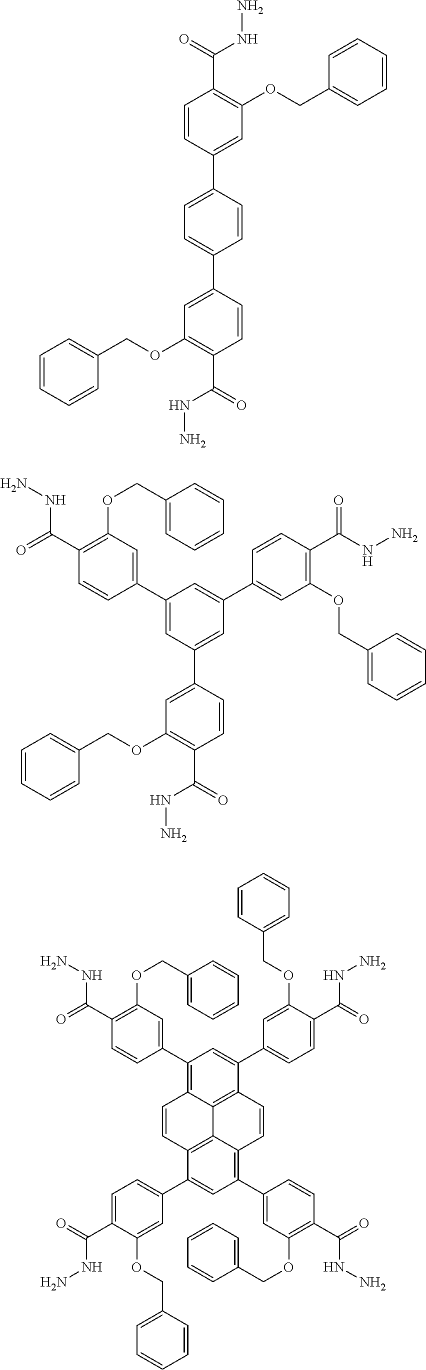

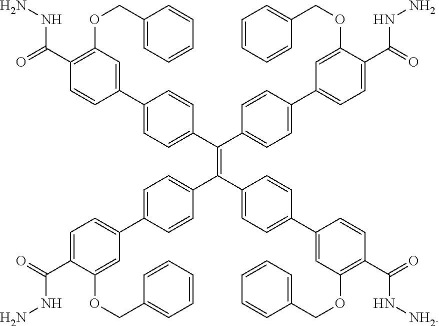 [SMILES: NNC(=O)c1ccc(-c2ccc(C(=C(c3ccc(-c4ccc(C(=O)NN)c(OCc5ccccc5)c4)cc3)c3ccc(-c4ccc(C(=O)NN)c(OCc5ccccc5)c4)cc3)c3ccc(-c4ccc(C(=O)NN)c(OCc5ccccc5)c4)cc3)cc2)cc1OCc1ccccc1]

In some embodiments, first monomer is selected from one of the following:

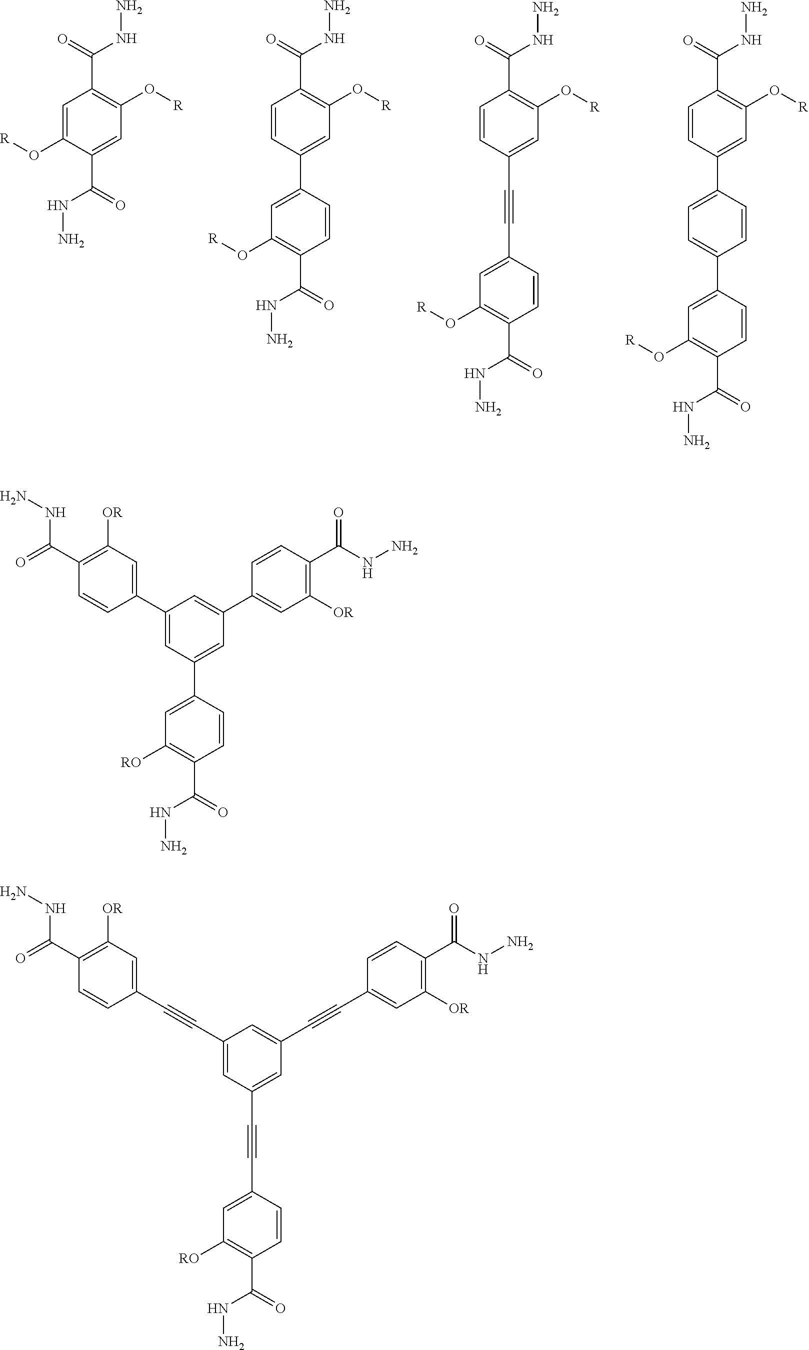

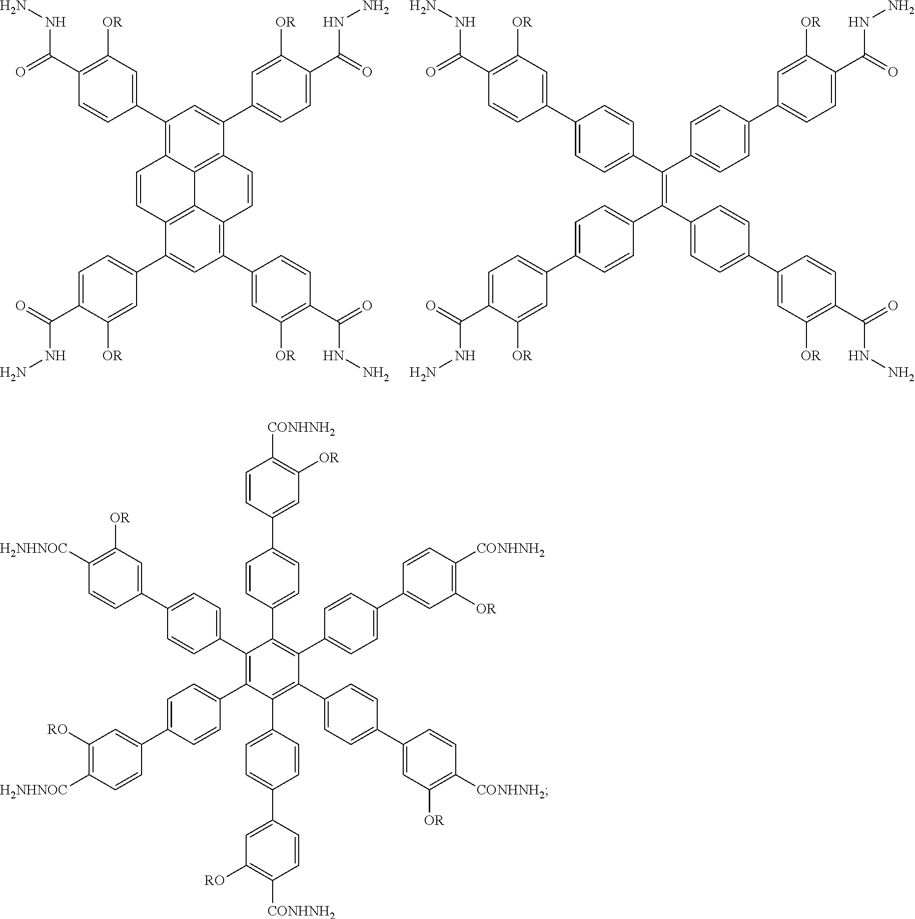

wherein R is optionally substituted (C₁-C₆)alkyl or optionally substituted benzyl. In some embodiments, R is optionally substituted (C₃-C₆)alkyl or optionally substituted benzyl.

In some embodiments, first monomer is selected from one of the following:

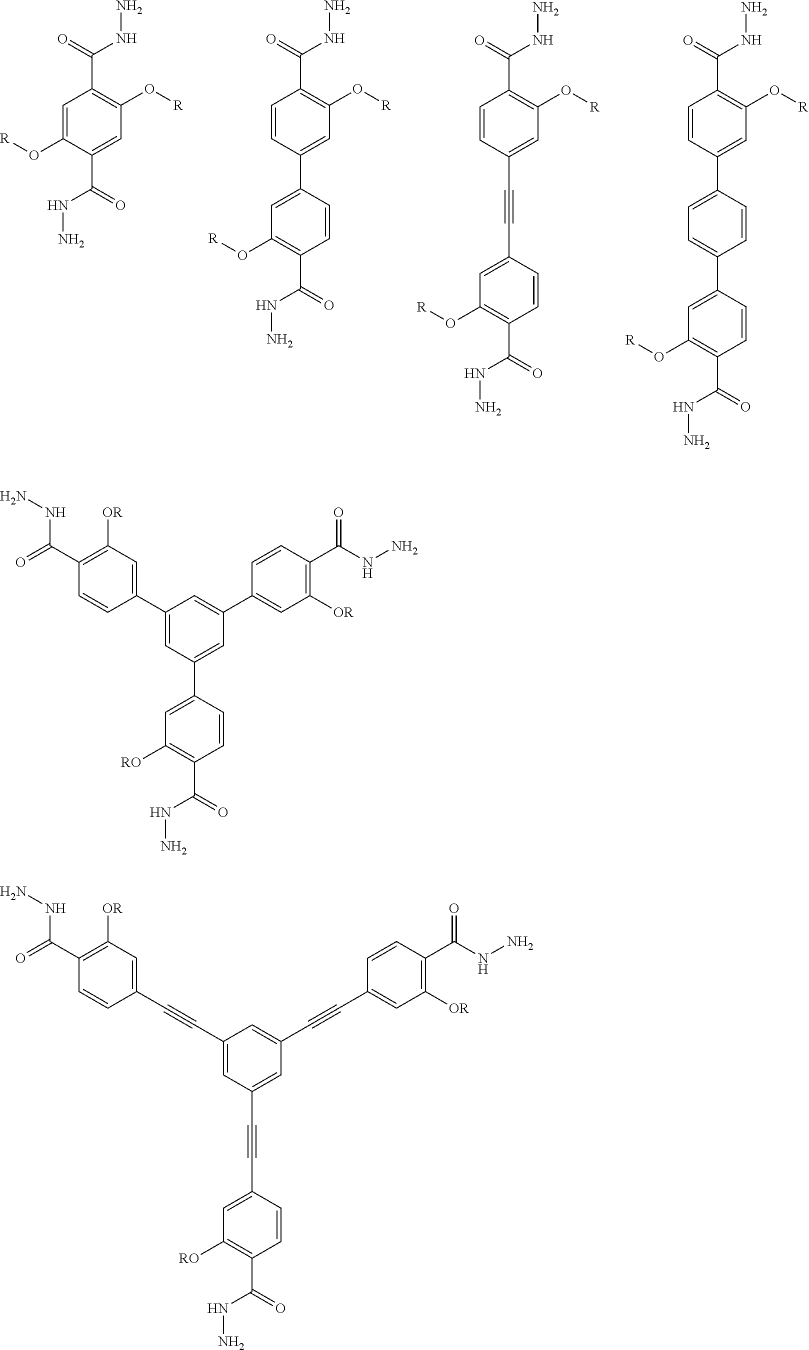

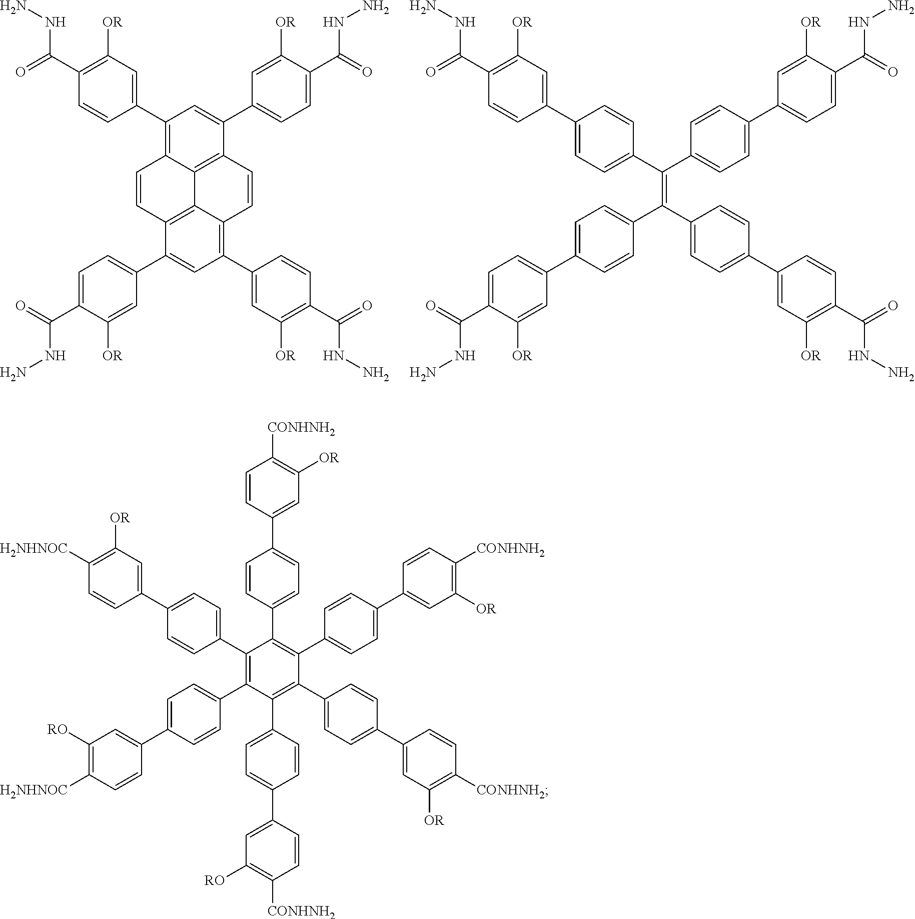

wherein R is selected from methyl, ethyl, propyl, allyl, propargyl, (ethylthio)propyl or benzyl. In some embodiments, R is selected from propyl, allyl, propargyl, (ethylthio)propyl or benzyl.

In some embodiments, the second monomer is selected from:

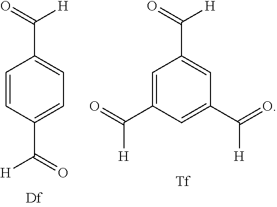

In some embodiments, the second monomer is selected from:

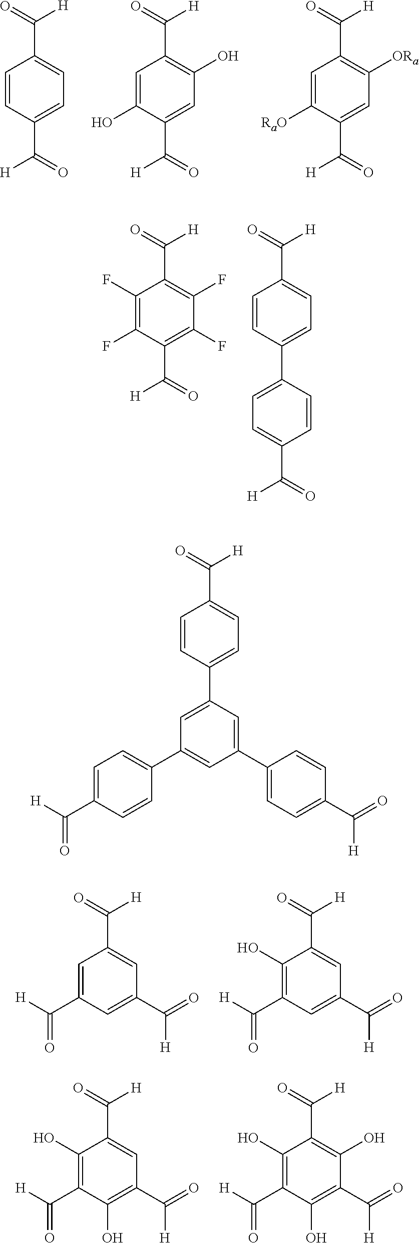

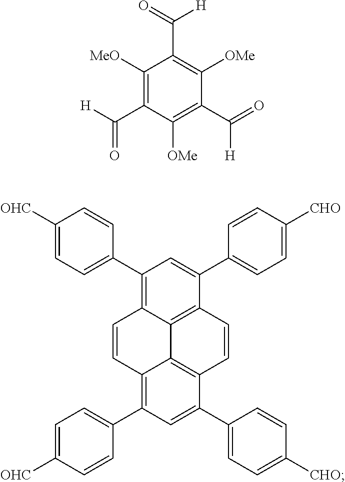

wherein Rₐ is optionally substituted C₁-C₆ alkyl.

In some embodiments, the stirring is performed at atmospheric pressure and in open air. In other embodiments, the stirring is performed under heat at not less than 100° C., 110° C. or 120° C. In other embodiments, the stirring is performed under heat at more than 100° C., 110° C. or 120° C.

In some embodiments, the stirring is performed under heat of about 60° C. to about 200° C. In other embodiments, the heat is about 70° C. to about 200° C., about 80° C. to about 200° C., about 90° C. to about 200° C., about 100° C. to about 200° C., or about 110° C. to about 200° C.

In some embodiments, the aprotic non-polar solvent is 1,2-dichlorobenzene or mesitylene.

In some embodiments, the stirring is performed in an aromatic solvent selected from toluene, xylenes, mesitylene, mono, di and trichlorobenzene, or a combination thereof.

In some embodiments, the stirring is performed in a polar protic solvent selected from water, C₁-C₄ alcohols (such as methanol, ethanol, n-propanol, iso-propanol, n-butanol), or a combination thereof.

In some embodiments, the stirring is performed in a solvent mixture, the solvent mixture selected from mesitylene/1,4-dioxane, ortho-dichlorobenzene (o-DCB)/n-butanol and mesitylene/acetonitrile.

In some embodiments, the stirring is performed in a solvent. The solvent can be added at a hydrazide:solvent mole ratio of about 1:200 to about 1:400.

In some embodiments, the stirring step further comprises a catalyst. The catalyst can be acetic acid. For example, acetic acid at about 1:50 (V/Vₛₒₗᵥₑₙₜ) can be added. Alternatively, acetic acid can be added from about 1:20 (V/Vₛₒₗᵥₑₙₜ) to about 1:100 (V/Vₛₒₗᵥₑₙₜ).

In some embodiments, the stirring is performed in the presence of acetic acid, the acetic acid having a concentration of about 1 M to about 17 M. In other embodiments, the concentration is of about 2 M to about 17 M, about 3 M to about 17 M, about 4 M to about 17 M, about 5 M to about 17 M, about 6 M to about 17 M, about 7 M to about 17 M, about 8 M to about 17 M, about 9 M to about 17 M, about 10 M to about 17 M, about 11 M to about 17 M, about 12 M to about 17 M, about 13 M to about 17 M, about 14 M to about 17 M, or about 15 M to about 17 M.

In some embodiments, the COF is formable after about 20 min, about 30 min, about 40 min or about 50 min.

In some embodiments, the first and second monomers has a total topicity of more than 4. In other embodiments, the total topicity is more than 5, 6, 7 or 8. In this regard, the first monomer can have a topicity of 2, 3, 4 or 5. The second monomer can have a topicity of 2, 3, or 4. In other embodiments, the total topicity is at least 5.

In some embodiments, the first monomer and the second monomer have a combined concentration of about 15 g L⁻¹ to about 60 g L⁻¹. In other embodiments, the combined concentration is about 20 g L⁻¹ to about 60 g L⁻¹, about 25 g L⁻¹ to about 60 g L⁻¹, about 30 g L⁻¹ to about 60 g L⁻¹, about 35 g L⁻¹ to about 60 g L⁻¹, about 40 g L⁻¹ to about 60 g L⁻¹, about 45 g L⁻¹ to about 60 g L⁻¹, or about 50 g L⁻¹ to about 60 g L⁻¹.

The present invention also provides a method of fabricating a covalent organic framework (COF), comprising:

stirring a first monomer comprising an optionally substituted 2-alkoxybenzohydrazidyl moiety with second monomer comprising a benzaldehydyl moiety under heat and in open air for at least 15 min in aprotic non-polar solvent in order to form an acylhydrazone bond;

wherein the COF is formable after about 15 min;

wherein the first monomer and the second monomer has a total topicity of at least 5;

wherein the first monomer and the second monomer both independently have a conjugated pi bond system; and

wherein the optionally substituted 2-alkoxybenzohydrazidyl moiety is selected from optionally substituted 2-(C₃-C₆)alkoxybenzohydrazidyl or 2-benzyloxybenzohydrazidyl.

In some embodiments, the method of fabricating a COF comprises:

stirring a first monomer comprising an optionally substituted 2-alkoxybenzohydrazidyl moiety with second monomer comprising a benzaldehydyl moiety under heat at not less than 100° C. and in open air for at least 15 min in aprotic non-polar solvent in order to form an acylhydrazone bond;

wherein the COF is formable after about 15 min; and

wherein the optionally substituted 2-alkoxybenzohydrazidyl moiety is selected from optionally substituted 2-(C₃-C₆)alkoxybenzohydrazidyl or 2-benzyloxybenzohydrazidyl.

In some embodiments, the method of fabricating a COF comprises:

stirring a first monomer comprising an optionally substituted 2-alkoxybenzohydrazidyl moiety with second monomer comprising a benzaldehydyl moiety under heat at not less than 100° C. and in open air for at least 15 min in aprotic non-polar solvent for forming a acylhydrazone bond;

wherein the COF is formable after about 30 min;

wherein the optionally substituted 2-alkoxybenzohydrazidyl moiety is selected from optionally substituted 2-(C₃-C₆)alkoxybenzohydrazidyl or 2-benzyloxybenzohydrazidyl.

In some embodiments, the method of fabricating a COF comprises:

stirring a first monomer comprising an optionally substituted 2-alkoxybenzohydrazidyl moiety with second monomer comprising a benzaldehydyl moiety under heat at not less than 100° C. and in open air for at least 15 min in aprotic non-polar solvent in order to form an acylhydrazone bond;

wherein the stirring step further comprises a catalyst, the catalyst is acetic acid from about 1:20 (V/Vₛₒₗᵥₑₙₜ) to about 1:100 (V/Vₛₒₗᵥₑₙₜ);

wherein the COF is formable after about 30 min; and

wherein the optionally substituted 2-alkoxybenzohydrazidyl moiety is selected from optionally substituted 2-(C₃-C₆)alkoxybenzohydrazidyl or 2-benzyloxybenzohydrazidyl.

In some embodiments, the method of fabricating a COF comprises:

stirring a first monomer comprising an optionally substituted 2-alkoxybenzohydrazidyl moiety with second monomer comprising a benzaldehydyl moiety under heat at not less than 100° C. and in open air for at least 15 min in aprotic non-polar solvent in order to form an acylhydrazone bond;

wherein the stirring step further comprises a catalyst, the catalyst is acetic acid from about 1:20 (V/Vₛₒₗᵥₑₙₜ) to about 1:100 (V/Vₛₒₗᵥₑₙₜ);

wherein the COF is formable after about 30 min; and

wherein the optionally substituted 2-alkoxybenzohydrazidyl moiety is selected from optionally substituted 2-(C₃)alkoxybenzohydrazidyl or 2-benzyloxybenzohydrazidyl.

In some embodiments, the method of fabricating a COF comprises:

stirring a first monomer comprising an optionally substituted 2-alkoxybenzohydrazidyl moiety with second monomer comprising a benzaldehydyl moiety under heat at not less than 100° C. and in open air for at least 15 min in aprotic non-polar solvent for forming a acylhydrazone bond;

wherein the stirring step further comprises a catalyst, the catalyst is acetic acid from about 1:20 (V/Vₛₒₗᵥₑₙₜ) to about 1:100 (V/Vₛₒₗᵥₑₙₜ);

wherein the COF is formable after about 30 min; and

wherein the optionally substituted 2-alkoxybenzohydrazidyl moiety is selected from 2-propoxybenzohydrazidyl, 2-allyloxybenzohydrazidyl, 2-propargyloxybenzohydrazidyl, 2-(ethylthio)propoxybenzohydrazidyl or 2-benzyloxybenzohydrazidyl.

In some embodiments, the method of fabricating a COF comprises:

stirring a first monomer comprising an optionally substituted 2-alkoxybenzohydrazidyl moiety with second monomer comprising a benzaldehydyl moiety under heat at not less than 100° C. and in open air for at least 15 min in aprotic non-polar solvent for forming a acylhydrazone bond;

wherein the stirring step further comprises a catalyst, the catalyst is acetic acid from about 1:20 (V/Vₛₒₗᵥₑₙₜ) to about 1:100 (V/Vₛₒₗᵥₑₙₜ);

wherein the COF is formable after about 30 min;

wherein the first monomer is selected from one of the following:

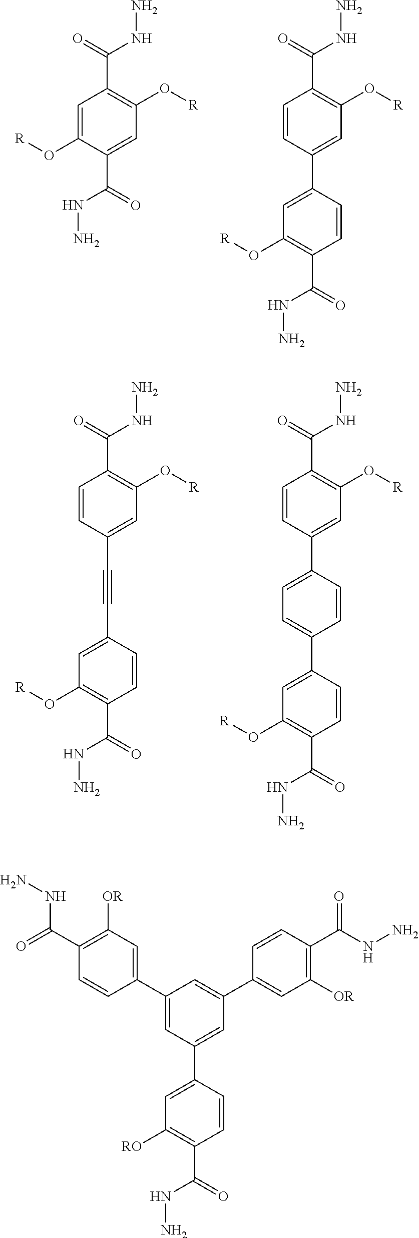

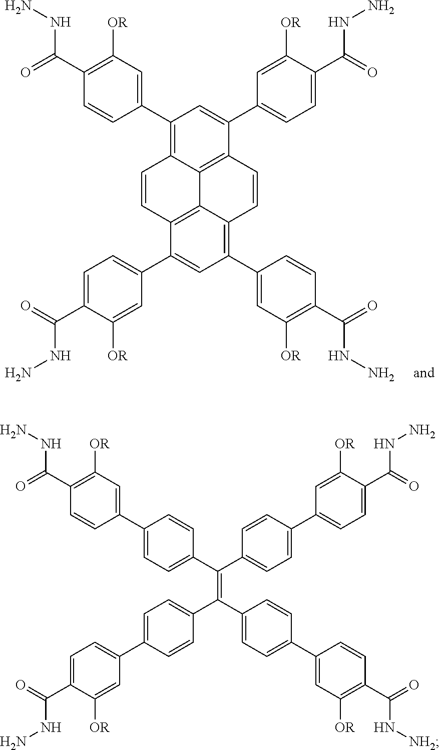

wherein R is selected from propyl, allyl, propargyl, (ethylthio)propyl or benzyl.

In some embodiments, the method of fabricating a covalent organic framework (COF), comprises:

stirring a first monomer comprising an optionally substituted 2-alkoxybenzohydrazidyl moiety with second monomer comprising a benzaldehydyl moiety under heat and in open air for at least 15 min in aprotic non-polar solvent in order to form an acylhydrazone bond;

wherein the COF is formable after about 15 min;

wherein the first monomer and the second monomer has a total topicity of at least 5;

wherein the first monomer and the second monomer both independently have a conjugated pi bond system; and

wherein first monomer is selected from one of the following:

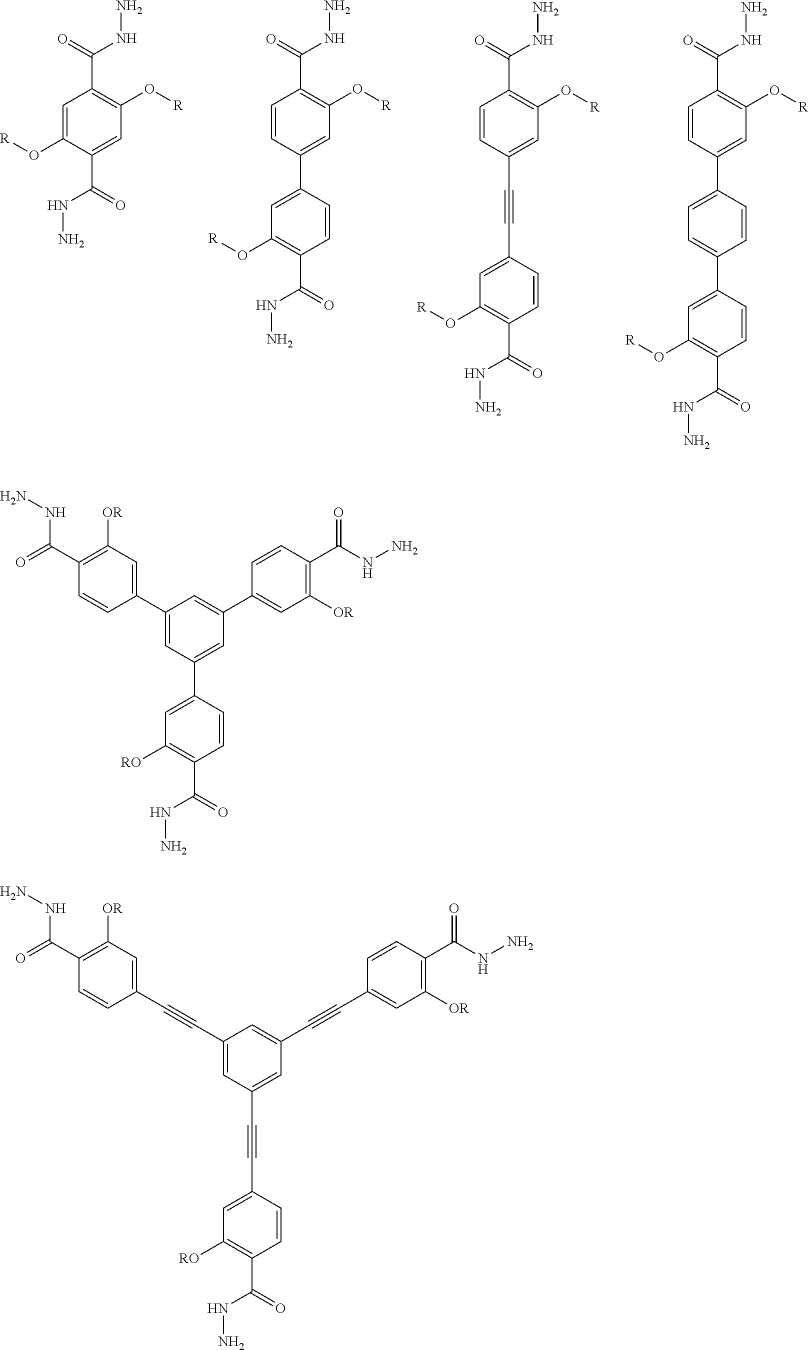

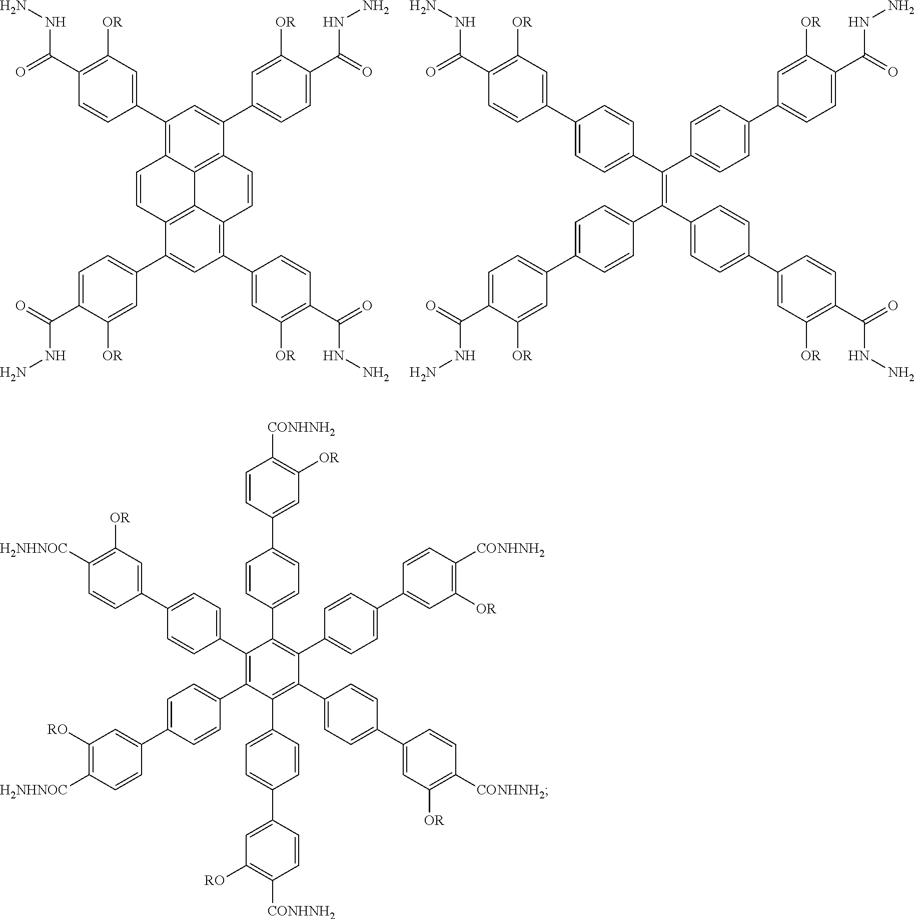

wherein R is optionally substituted (C₃-C₆)alkyl or optionally substituted benzyl.

In some embodiments, the method of fabricating a covalent organic framework (COF), comprises:

stirring a first monomer comprising an optionally substituted 2-alkoxybenzohydrazidyl moiety with second monomer comprising a benzaldehydyl moiety under heat and in open air for at least 15 min in aprotic non-polar solvent in order to form an acylhydrazone bond;

wherein the COF is formable after about 15 min;

wherein the first monomer and the second monomer has a total topicity of at least 5;

wherein the first monomer and the second monomer both independently have a conjugated pi bond system;

wherein first monomer is selected from one of the following:

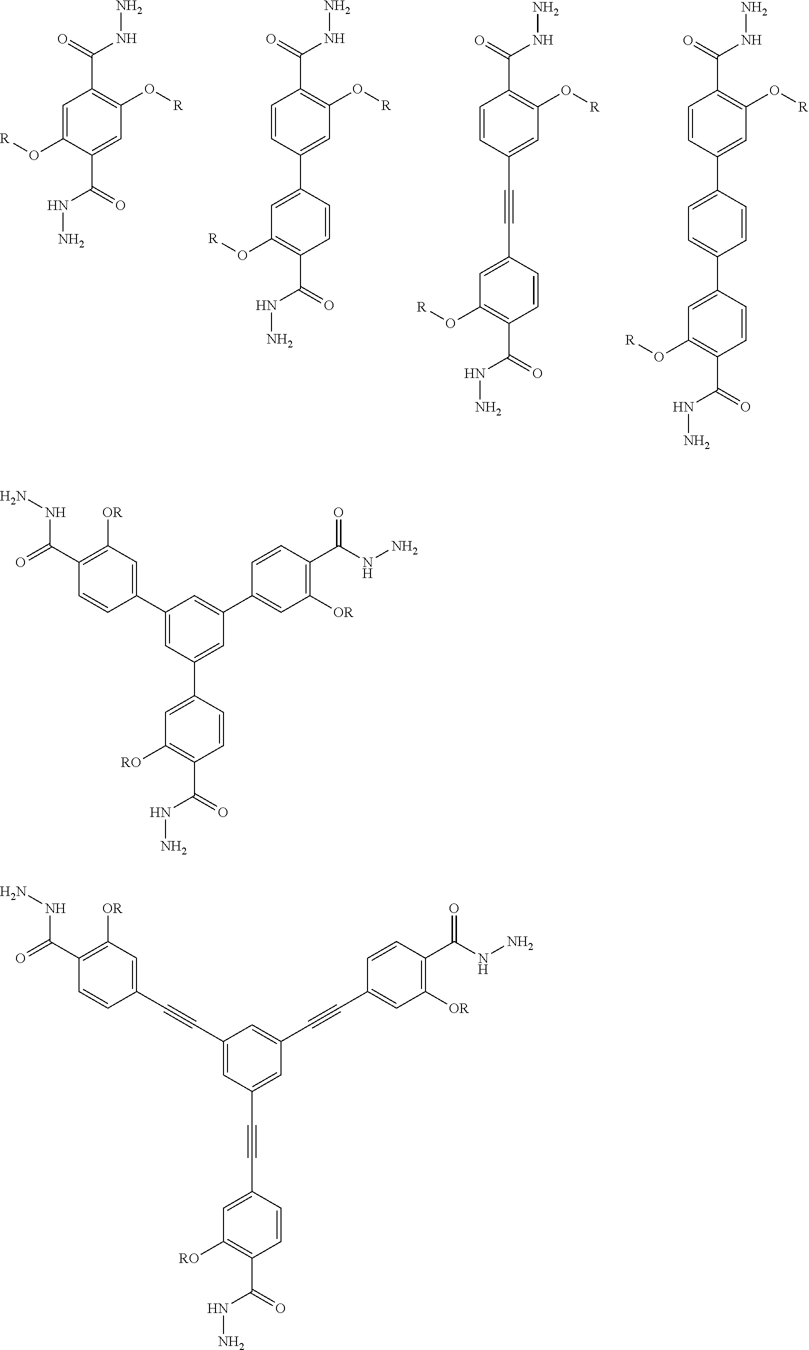

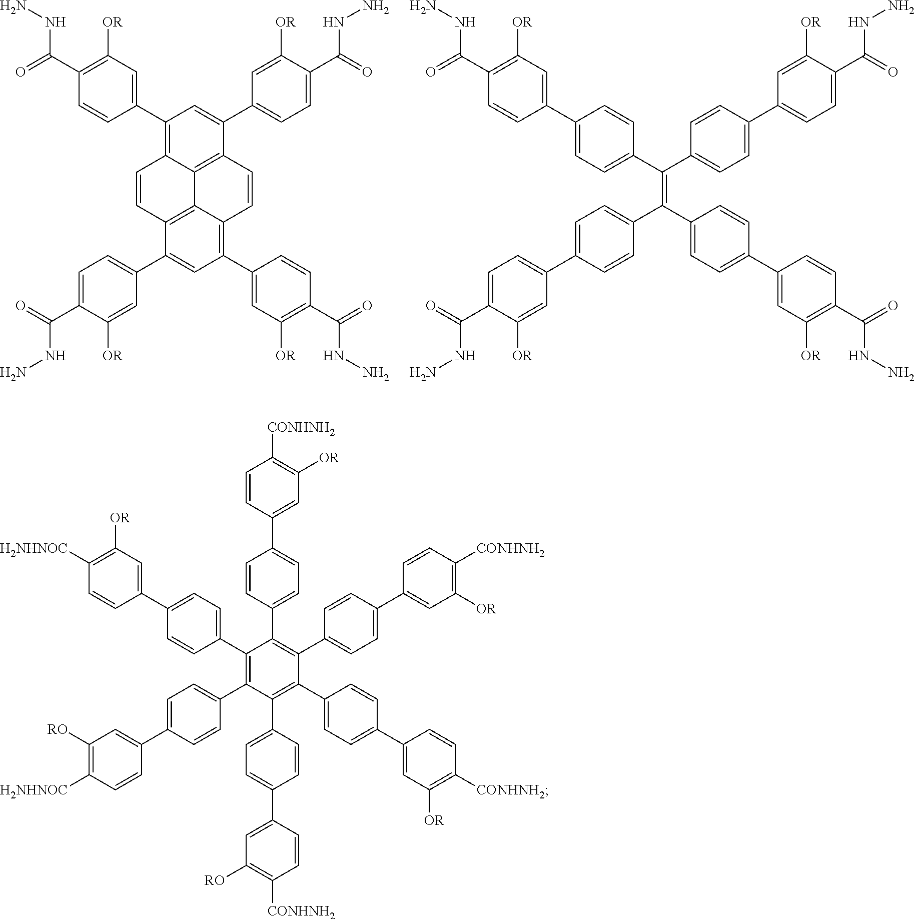

wherein R is optionally substituted (C₃-C₆)alkyl or optionally substituted benzyl; and

wherein the second monomer is selected from:

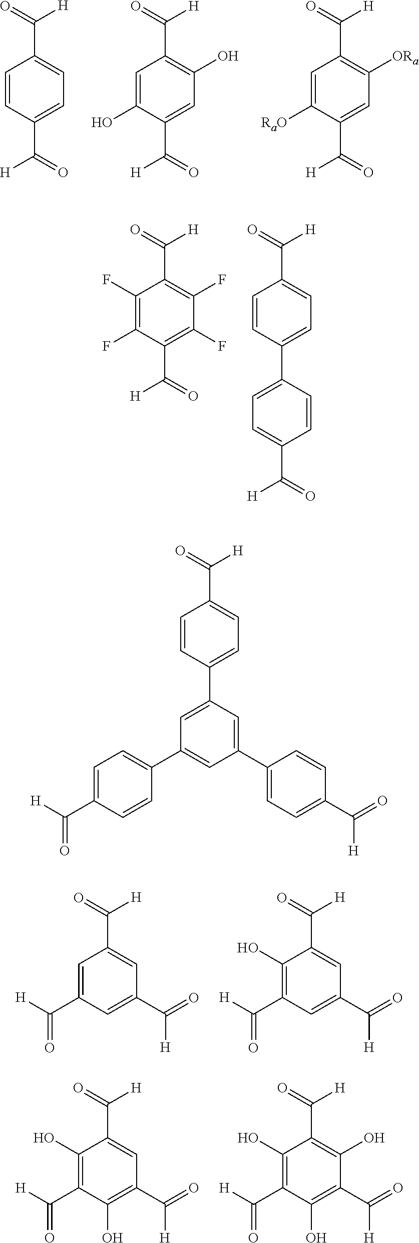

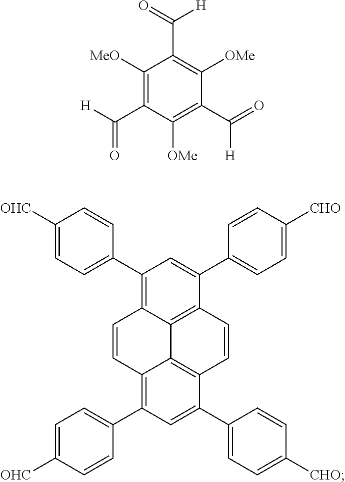

wherein Rₐ is optionally substituted C₁-C₆ alkyl.

The present invention also provides a COF comprising an optionally substituted 2-alkoxybenzohydrazonylene moiety of Formula (Ia):

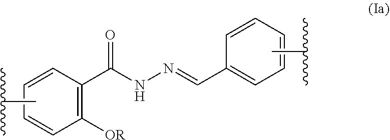

wherein R is optionally substituted (C₁-C₆)alkyl or benzyl; and

wherein [symbol] represents a linkage to the rest of the COF;

wherein the COF has a x-ray diffraction 2-theta peak at about 3° corresponding to a (100) facet with a full width half maximum (FWHM) of about 0.2° to about 0.6°.

The present invention also provides a COF comprising an optionally substituted 2-alkoxybenzohydrazonylene moiety of Formula (Ia):

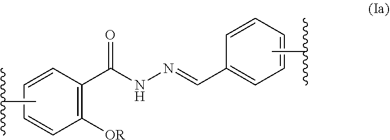

wherein R is optionally substituted (C₃-C₆)alkyl or benzyl; and

wherein [symbol] represents a linkage to the rest of the COF;

wherein the COF has a x-ray diffraction 2-theta peak at about 3° corresponding to a (100) facet with a full width half maximum (FWHM) of about 0.2° to about 0.6°.

In some embodiments, the FWHM is about 0.2° to about 0.6°, or about 0.2° to about 0.5°. In other embodiments, the FWHM is about 0.3° to about 0.5°, or about 0.3° to about 0.4°.

In some embodiments, the COF has a X-ray diffraction pattern which corresponds to (110), (200) and (001) facets. In other embodiments, the x-ray diffraction 2-theta peak corresponding to a (001) facet has a full width half maximum (FWHM) of about 1.1° to about 2.0°. In other embodiments, the X-ray diffraction pattern is indicative of an antiparallel stacked configuration.

In some embodiments, the COF has a (100) facet d spacing of about 19 Å to about 38 Å.

In some embodiments, the COF has a Brunauer-Emmett-Teller (BET) surface area of about 150 m²g⁻¹ to about 850 m²g⁻¹. In other embodiments, the BET surface area is of about 200 m²g⁻¹ to about 850 m²g⁻¹, about 250 m²g⁻¹ to about 850 m²g⁻¹, about 300 m²g⁻¹ to about 850 m²g⁻¹, about 350 m²g⁻¹ to about 850 m²g⁻¹, about 400 m²g⁻¹ to about 850 m²g⁻¹, about 450 m²g⁻¹ to about 850 m²g⁻¹, or about 500 m²g⁻¹ to about 850 m²g⁻¹.

In some embodiments, the COF is stable in 1M HCl for at least 7 days. In other embodiments, the COF is stable in 1M NAOH for at least 7 days.

Some examples of the COF are as follows:

Accordingly, in some embodiments, the COF comprises an optionally substituted 2-alkoxybenzohydrazonylene moiety of Formula (Ia):

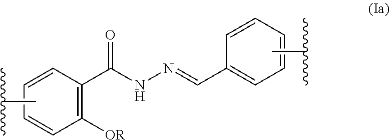

wherein R is selected from propyl, allyl, propargyl, benzyl or (ethylthio)propyl; and

wherein [symbol] represents a linkage to the rest of the COF;

wherein the COF has a x-ray diffraction 2-theta peak at about 3° corresponding to a (100) facet with a full width half maximum (FWHM) of about 0.3° to about 0.6°.

### EXAMPLES

### General Synthetic Method of COF

Corresponding 2-alkoxybenzohydrazide containing precursor and relative aldehyde in mol equivalent were mixed with solvent in mol ratio (hydrazide/solvent, 1 to 200˜400). Then 17 M acetic acid (v/vₛₒₗᵥₑₙₜ, 1:50) was added into the suspension. The mixture was stirred and heated at 100˜120° C. for 15 min to 1 h. The reaction mixture was cooled, filtered and washed extensively with THF, acetone and dried to afford highly crystalline COFs.

General Synthetic Method of 2-Alkoxybenzohydrazide Containing Building Units

Methyl 4-iodosalicylate was reacted with related alkyl (such as propyl, allyl, propargyl, benzyl and etc.) bromide or iodide to afford methyl 2-alkoxy-4-iodoebenzocarboxylate. Then the iodo group was converted to pinacol boronate, and the obtained product was connected to corresponding molecular backbones such as (1,4-dibromobenzene, 1,3,5-tribromobenzene, 1,1,2,2-tetrakis(4-bromophenyl)ethane, 1,3,6,8-tetrabromo-pyrene, etc.) via Suzuki coupling. The afforded compound after purification was refluxed with hydrazine in ethanol to give corresponding 2-alkoxybenzohydrazide containing building unit.

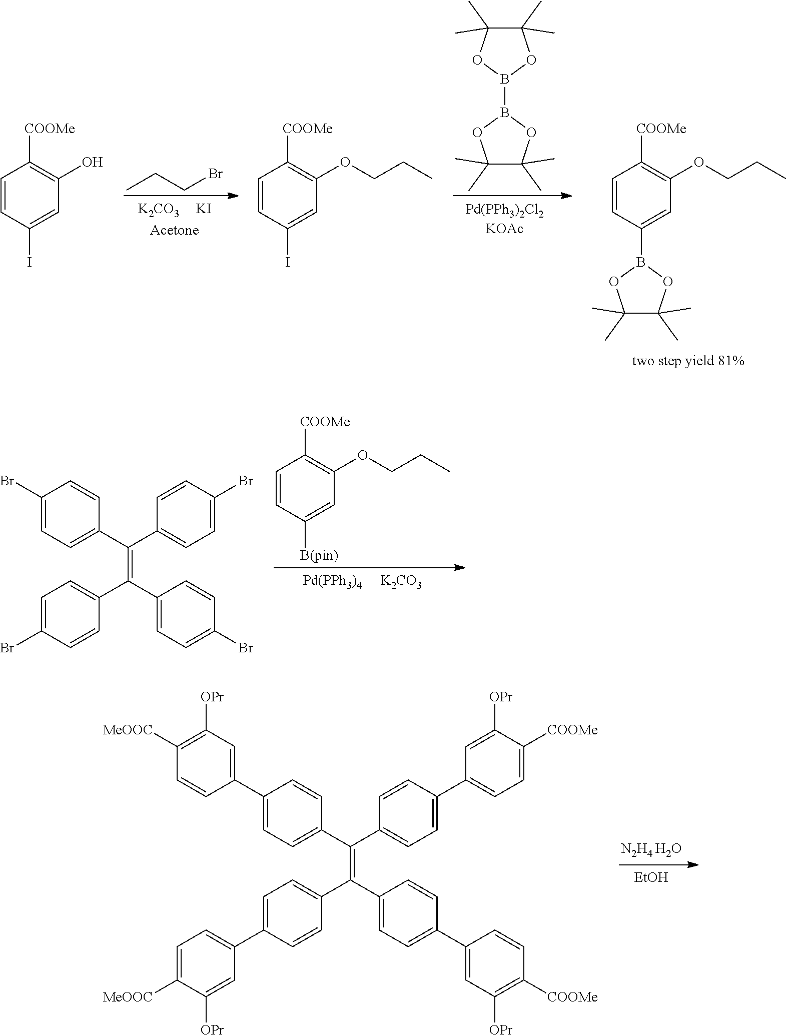

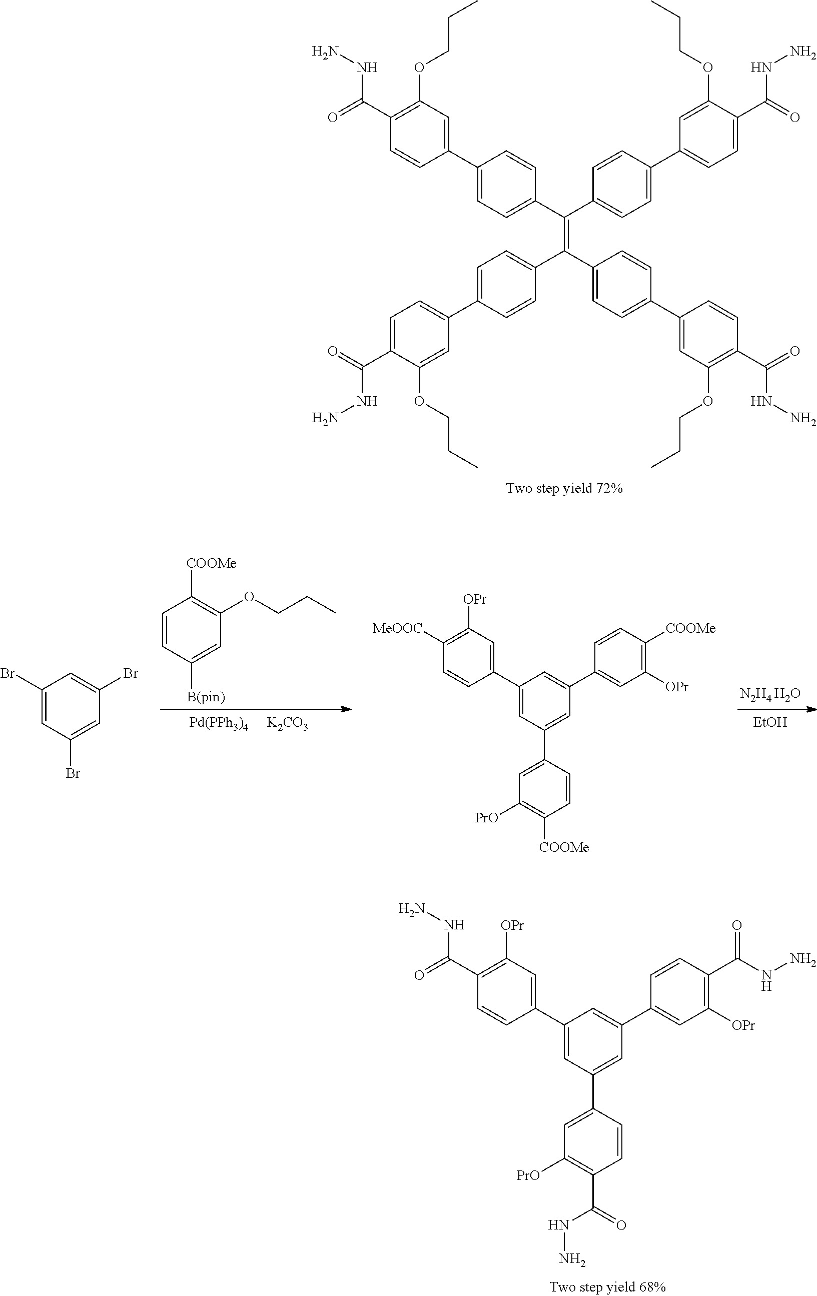

Synthetic Procedure for THzOPr

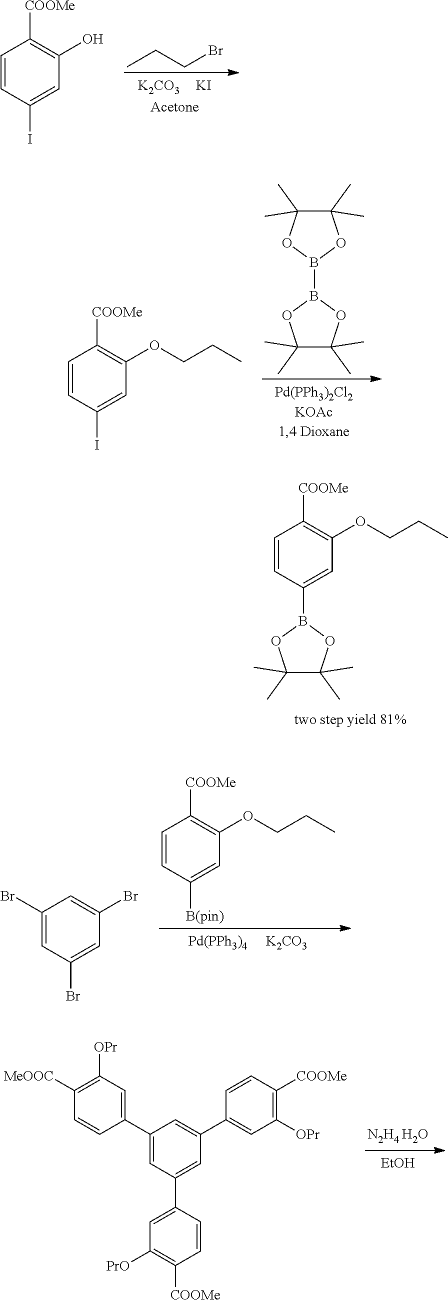

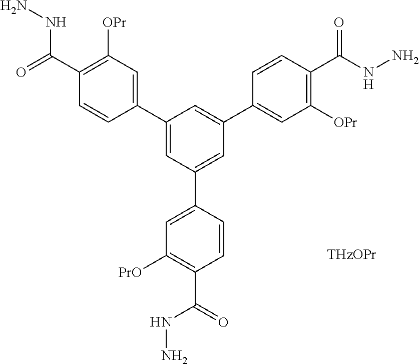

Methyl 2-propoxy-4-(4,4,5,5-tetramethyl-1,3,2-dioxaborolan-2-yl)benzoate: To a mixture of methyl 2-hydroxy-4-iodobenzoate (2.78 g, 10 mmol), K₂CO₃ (5.6 g, 40 mmol), and KI (100 mg, 0.6 mmol) in acetone (150 mL) was added with 1-propylbromide (2 mL, 22 mmol) dropwisely. The mixture was refluxed with stirring under N₂ atmosphere for 2 days and hot filtered through a Celite bed. The filtrate was evaporated and purified via flash chromatography (hexane/ethyl acetate=5:1) to give a colorless oil. The oil was then added to a mixture of bis(pinacolato)diboron (2.67 g, 10.5 mmol), potassium acetate (2.94 g, 30 mmol), PdCl₂(PPh₃)₂ (105 mg, 0.15 mmol) in 1,4-dioxane (50 mL) under N₂ atmosphere. The mixture was heated at 100° C. for 18 h. The mixture was diluted with ethyl acetate and water. The organic layer was separated, dried over Na2SO4 and evaporated via vacuum. The residue was purified by flash chromatography (hexane/ethyl=5:1) to give a colorless oil (2.59 g, 81%). 1H NMR (500 MHz, CDCl3) δ 7.73 (d, J=7.6 Hz, 1H), 7.39 (d, J=7.6 Hz, 1H), 7.36 (s, 1H), 4.05 (t, J=6.4 Hz, 2H), 3.88 (s, 3H), 1.89-1.80 (m, 2H), 1.35 (s, 12H), 1.06 (t, J=7.4 Hz, 3H).

5′-(4-(Hydrazinecarbonyl)-3-propoxyphenyl)-3,3″-dipropoxy-[1,1′:3′,1″-terphenyl]-4,4″-dicarbohydrazide (THzOPr): To a mixture of 1,3,5-tribromobenzene (315 mg, 1 mmol), K₂CO₃ (912 mg, 6.6 mmol), and Pd(PPh₃)₄ (116 mg, 0.1 mmol) in 1,4-dioxane/H₂O (18 mL, 5:1), methyl 2-propoxy-4-(4,4,5,5-tetramethyl-1,3,2-dioxaborolan-2-yl)benzoate (1 g, 3.3 mmol) was added under N₂. The mixture was refluxed for 2 days. After the reaction was cooled to room temperature, the mixture was added with ethyl acetate and water. The organic layer was separated and dried over NazSO₄. The solvent was removed by vacuum and, the residue was purified by flash chromatography (hexane:EA=10:1 then CH₂Cl₂) to give a light brown solid. The solid was suspended in ethanol (10 mL) and added with hydrazine monohydrate (1.5 mL). The mixture was refluxed for 1 day. The precipitate was filtered, washed with ethanol and dried to give a white solid (445 mg, 68%). 1H NMR (500 MHz, DMSO) δ 9.15 (s, 3H), 8.00 (s, 3H), 7.86 (d, J=7.9 Hz, 3H), 7.53 (d, J=9.6 Hz, 6H), 4.59 (s, 6H), 4.25 (t, J=6.4 Hz, 7H), 1.83 (dd, J=14.0, 6.8 Hz, 6H), 1.03 (t, J=7.4 Hz, 9H). 13C NMR (126 MHz, DMSO) δ 165.55, 157.60, 144.70, 141.91, 131.76, 126.57, 122.24, 120.51, 112.87, 71.14, 22.84, 11.44. ESI-HRMS Calcd. for [C36H43N6O6+H] 655.3239, found 655.3234.

Synthetic Procedure for DHzOPrY

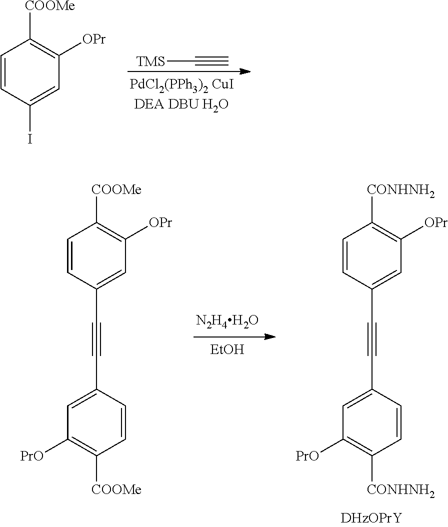

4,4′-(Ethyne-1,2-diyl)bis(2-propoxybenzohydrazide) (DHzOPrY): To a mixture of PdCl₂(PPh₃)₂ (130 mg, 0.185 mmol), CuI (70 mg, 0.368 mmol) was added with diethylamine (45 mL) and methyl 4-iodo-2-propoxybenzoate (3.92 g, 12.2 mmol) and DBU (12 mL) under N₂ atmosphere. The mixture was vigorously stirred and added with trimethylsilylacetylene (0.9 mL, 6.28 mmol) and ultrapure water (0.1 mL, 5.45 mmol). The reaction was stirred in the dark under N₂ at ambient temperature for 15 h. The reaction mixture was diluted with CH₂Cl₂ (50 mL) and washed with a saturated ammonium chloride solution for 3 times. The organic layers was separated, dried over anhydrous Na₂SO₄, and evaporated in vacuum. The crude product was purified by flash chromatography (Hexane: CH₂Cl₂=5:1) and recrystallized from Hexane/EA to afford a white crystal. The white crystal was suspended in EtOH (40 mL) and the mixture was added with hydrazine monohydrate (4 mL). The suspension was refluxed for 1 day under N₂. The solution was cooled to room temperature. A white solid was crystallized out, filtered, washed with EtOH and dried in vacuum to give a white crystalline solid (1.13 g, 45% two-step yield). 1H NMR (400 MHz, DMSO) δ 9.16 (s, 2H), 7.70 (d, J=7.9 Hz, 2H), 7.30 (d, J=1.3 Hz, 2H), 7.22 (dd, J=7.9, 1.4 Hz, 2H), 4.57 (d, J=3.6 Hz, 4H), 4.11 (t, J=6.5 Hz, 4H), 1.91-1.68 (m, 4H), 1.00 (t, J=7.4 Hz, 6H).13C NMR (101 MHz, DMSO) δ 164.18, 156.04, 130.49, 125.11, 123.68, 123.25, 115.53, 90.11, 70.19, 21.82, 10.39. ESI-HRMS Calcd. for [C22H27N4O4+H] 411.2027, found 411.2038.

Synthetic Procedure of the COFs

Undisturbed Prolonged Method for COF Synthesis

To a 10 mL Schlenk tube (15 mm×80 mm) was added with 1,3,5-triformylbenzene (0.05 mmol), respective 2,5-disubstituted terephthalohydrazide (0.075 mmol), and o-DCB (1 mL). The mixture was sonicated for 5 mins, added with 6 M acetic acid (100 μL), flash frozen at 77 K, and degassed under freeze-pump-thaw for three cycles. The tube was then sealed and heated at 120° C. in an oven for three days. The solid obtained was exchanged with THF (5 mL) for 5 times and dried under vacuum to afford corresponding COFs.

Tf-DHzOPr COF (Slow): White solid (26.1 mg, 91%). Anal. Calcd. for (C30H33N6O6·1.85H2O)n: C 58.37; H 6.09; N 13.85; found: C 58.59; H 5.30; N 13.57.

Tf-DHzOAll COF (Slow): White solid (27.2 mg, 96%). Anal. Calcd. for (C30H27N6O6·3.1H2O)n: C 57.80; H 5.37; N 13.48; found: C 57.07; H 4.60; N 13.23.

Tf-DHzOBn COF (Slow): White solid (32.5 mg, 91%). Anal. Calcd. for (C42H33N6O6·1.45H2O)n: C 67.81; H 4.86; N 11.30; found: C 67.48; H 4.45; N 11.18.

Undisturbed Prolonged Method for Synthesis of Tf-DHz/Tf-DHzPent

To a 10 mL Schlenk tube (15 mm×80 mm) was added with 1,3,5-triformylbenzene (0.05 mmol), terephthalohydrazide (DHz) or 2,5-dipentyl terephthalohydrazide (DHzPent) (0.075 mmol), and various solvents (1 mL) (FIG. S3 and S4). The mixture was sonicated for 5 mins, added with 6 M acetic acid (100 μL), flash frozen at 77 K, and degassed under freeze-pump-thaw for three cycles. The tube was then sealed and heated at 120° C. in an oven for three days. The solid obtained was exchanged with THF (5 mL) for 5 times and dried under vacuum to afford corresponding solids.

Ultrafast Robust Method for Synthesis of Tf-DHzOR COFs

1,3,5-Triformylbenzene (0.05 mmol) and respective 2,5-disubstituted terephthalohydrazide (0.075 mmol) were suspended in o-DCB (1 mL). For Tf-DHzOPr and Tf-DHzOAll, the mixture was added with 17 M AcOH (20 μL), and heated at 100° C. with stirring for 30 mins; for Tf-DHzOBn, the mixture was added with 17 M AcOH (70 μL), and heated at 120° C. with stirring for 30 mins. The solid was filtered, washed with THF and acetone, and vacuum dried to afford corresponding COFs.

Tf-DHzOPr COF (Fast): White solid (27.2 mg, 95%). Anal. Calcd. for (C30H33N6O6·1.7H2O)n: C 59.63; H 6.07; N 13.91; found: C 59.41; H 5.59; N 13.43.

Tf-DHzOAll COF (Fast): White solid (27.5 mg, 97%). Anal. Calcd. for (C30H27N6O6·2.15H2O)n: C 59.43; H 5.20; N 13.86; found: C 58.71; H 4.42; N 13.39.

Tf-DHzOBn COF (Fast): White solid (35.2 mg, 98%). Anal. Calcd. for (C42H33N6O6·1.35H2O)n: C 67.98; H 4.85; N 11.32; found: C 67.76; H 4.56; N 11.16.

Ultrafast Robust Method for Synthesis of THzOPr COFs

1,4-Diformylbenzene (6 mg, 0.045 mmol) or 1,3,5-triformylbenzene (4.9 mg, 0.03 mmol) and THzOPr (19.6 mg, 0.03 mmol) were suspended in o-DCB (1 mL). The mixture was added with 17 M AcOH (50 μL) and heated at 120° C. with stirring for 30 mins. The solid was filtered, washed with THF and acetone, and vacuum dried to afford corresponding COFs.

Df-THzOPr COF (Fast): Greenish white solid (22.9 mg, 95%). Anal. Calcd. for (C62H63N9O8·4.65 H2O)n: C 65.09; H 6.18; N 9.49; found: C 63.94; H 5.03; N 9.25.

Tf-THzOPr COF (Fast): White solid (21 mg, 92%). Anal. Calcd. for (C45H42N6O6·12.5H2O)n: C 54.70; H 6.83; N 8.51; found: C 53.51; H 5.61; N 8.20.

Ultrafast Robust Gram-Scale Synthesis of Tf-DHzOAll COF and Tf-DHzOPrY COF

Tf-DHzOAII: 1,3,5-Triformylbenzene (0.405 g, 2.5 mmol) and 2,5-diallyloxyl terephthalohydrazide (1.15 g, 3.75 mmol) were suspended in o-DCB (50 mL). The mixture was added with 17 M AcOH (1 mL), and heated at 100° C. with stirring for 30 mins. The solid was filtered, washed with THF and acetone, and vacuum dried to afford Tf-DHzOAll in white solid (1.4 g, 99%).

Tf-DHzOPrY: 1,3,5-Triformylbenzene (0.243 g, 1.5 mmol) and DHzOPrY (0.924 g, 2.25 mmol) were suspended in o-DCB (30 mL). The mixture was added with 17 M AcOH (0.6 mL), and heated at 120° C. with stirring for 30 mins. The solid was filtered, washed with THF and acetone, and vacuum dried to afford Tf-DHzOPrY in white solid (1.09 g, 99%). Anal. Calcd. for (C42H39N6O6·2.6H2O)n: C 65.46; H 5.78; N 10.91; found: C 65.29; H 5.57; N 11.07.

Ultrafast Robust Method for Synthesis of Tf-DHz/Tf-DHzPent

Terephthalohydrazide or 2,5-dipentyl terephthalohydrazide (0.075 mmol) and 1,3,5-triformylbenzene (0.05 mmol) were suspended in various solvents (1 mL) (FIG. S6 and S7). The mixture was added with 17 M AcOH (20 μL) and heated at 120° C. with stirring for 30 mins. The solid was filtered, washed with THF and acetone, and vacuum dried to afford corresponding solids.

Ultrafast Robust Method for Synthesis of Tf-DAA

Anthracene-2,6-diamine (15.6 mg, 0.075 mmol) and 1,3,5-triformylbenzene (8.1 mg, 0.05 mmol) were suspended in o-DCB/n-BuOH (1 mL, 1:1). The mixture was added with 17 M AcOH (20 μL) and heated at 120° C. with stirring for 30 mins. The solid was filtered, washed with THF and vacuum dried to afford the solid (17.8 mg. 85%). Anal. Calcd. for (C30H18N3·1.65H2O)n: C 80.03; H 4.77; N 9.33; found: C 79.63; H 4.34; N 9.13.

Synthesis and Characterization of COFs with Different Side Chain Lengths

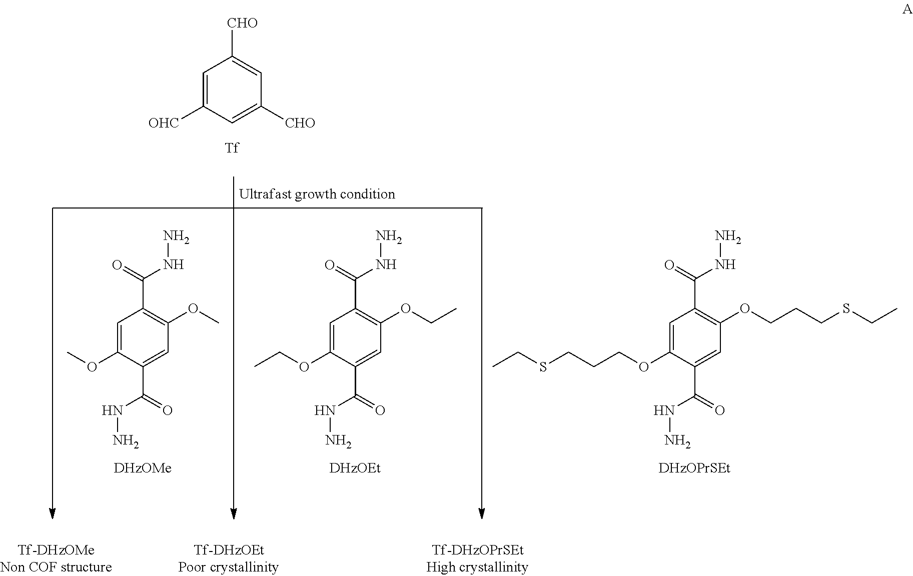

Comparison of Synthetic Conditions of COF of the Present Invention with Comparators

| | RIR* | Condition | Solvent | Time | [symbol] | Crystalline Size | [symbol] | Crystalline Size |
|---|---|---|---|---|---|---|---|---|
| Tf-DAA | Covalent bond | Sealed, undisturbed, | [symbol] | 3 d | [symbol] | [symbol] | [symbol] | 6.3 nm |
| | | 120° C. | [symbol] | | | | | |
| | | | [symbol] | 3 d | [symbol] | [symbol] | [symbol] | 7.36 nm |
| | | | [symbol] | | | | | |
| | | Open, stirred, | [symbol] | 30 min | N.A. | N.A. | N.A. | N.A. |
| | | 120° C. | [symbol] | | | | | |
| Tf-DEz | N.A. | Sealed, undisturbed, | [symbol] | 3 d | N.A. | N.A. | N.A. | N.A. |
| | | 120° C. | [symbol] | | | | | |
| | | | [symbol] | 3 d | N.A. | N.A. | N.A. | N.A. |
| | | | [symbol] | | | | | |
| | | Open, stirred, | [symbol] | 30 min | N.A. | N.A. | N.A. | N.A. |
| | | 120° C. | [symbol] | | | | | |
| | | | [symbol] | 30 min | N.A. | N.A. | N.A. | N.A. |
| | | | [symbol] | | | | | |
| [symbol] | N.A. | Sealed, undisturbed, | [symbol] | 3 d | N.A. | N.A. | N.A. | N.A. |
| | | 120° C. | [symbol] | | | | | |
| | | | [symbol] | 3 d | N.A. | N.A. | N.A. | N.A. |
| | | | [symbol] | | | | | |
| | | Open, stirred, | [symbol] | 30 min | N.A. | N.A. | N.A. | N.A. |
| | | 120° C. | [symbol] | | | | | |
| | | | [symbol] | 30 min | N.A. | N.A. | N.A. | N.A. |
| | | | [symbol] | | | | | |
| [symbol] | Hydrogen bond | Sealed, undisturbed, | [symbol] | 3 d | [symbol] | 24.26 nm | [symbol] | 7.72 nm |
| | | 120° C. | [symbol] | | | | | |
| | | Open, stirred, | [symbol] | 30 min | [symbol] | 27.32 nm | [symbol] | 6.28 nm |
| | | 100° C. | [symbol] | | | | | |
| [symbol] | Hydrogen bond | Sealed, undisturbed, | [symbol] | 3 d | [symbol] | 36.11 nm | [symbol] | 6.27 nm |
| | | 120° C. | [symbol] | | | | | |
| | | Open, stirred, | [symbol] | 30 min | [symbol] | 26.7 nm | [symbol] | 6.48 nm |
| | | 100° C. | [symbol] | | | | | |
| | | Open, stirred, | [symbol] | 30 min | [symbol] | 27.31 nm | [symbol] | 6.38 nm |
| | | 100° C. | [symbol] | | | | | |
| [symbol] | Hydrogen bond | Sealed, undisturbed, | [symbol] | 3 d | [symbol] | 15.58 nm | [symbol] | 7.36 nm |
| | | 120° C. | [symbol] | | | | | |
| | | Open, stirred, | [symbol] | 30 min | [symbol] | 18.51 nm | [symbol] | 6.29 nm |
| | | 120° C. | [symbol] | | | | | |
| [symbol] | Hydrogen bond | Open, stirred, | [symbol] | 30 min | [symbol] | 29.11 nm | [symbol] | 4.31 nm |
| | | 120° C. | [symbol] | | | | | |
| [symbol] | Hydrogen bond | Open, stirred, | [symbol] | 30 min | [symbol] | 31.08 nm | [symbol] | 4.7 nm |
| | | 120° C. | [symbol] | | | | | |
| [symbol] | Hydrogen bond | Open, stirred, | [symbol] | 30 min | [symbol] | 37.32 nm | [symbol] | 7.9 nm |
| | | 120° C. | [symbol] | | | | | |

[symbol]

indicates data missing or illegible when filed

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1-30. (canceled)

31. A method of fabricating a covalent organic framework (COF), comprising:
stirring a first monomer comprising an optionally substituted 2-alkoxybenzohydrazidyl moiety with second monomer comprising a benzaldehydyl moiety under heat and in open air for at least 15 min in order to form an acylhydrazone bond;
wherein the COF is formable after about 15 min; and
wherein the optionally substituted 2-alkoxybenzohydrazidyl moiety is selected from optionally substituted 2-(C₁-C₆)alkoxybenzohydrazidyl or 2-benzyloxybenzohydrazidyl.

32. The method according to claim 31, wherein the optionally substituted 2-alkoxybenzohydrazidyl moiety is optionally substituted 2-(C₃)alkoxybenzohydrazidyl or 2-benzyloxybenzohydrazidyl.

33. The method according to claim 31, wherein the first monomer is selected from one of the following:

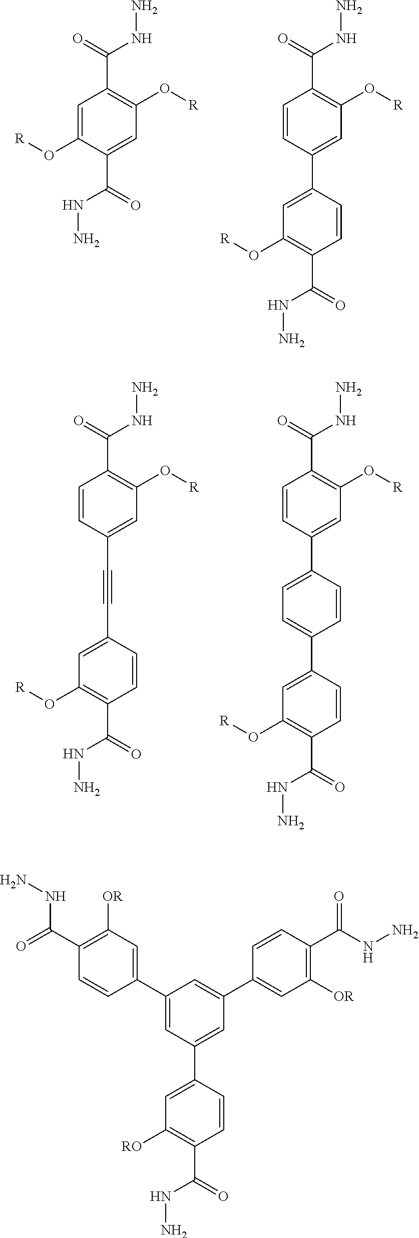

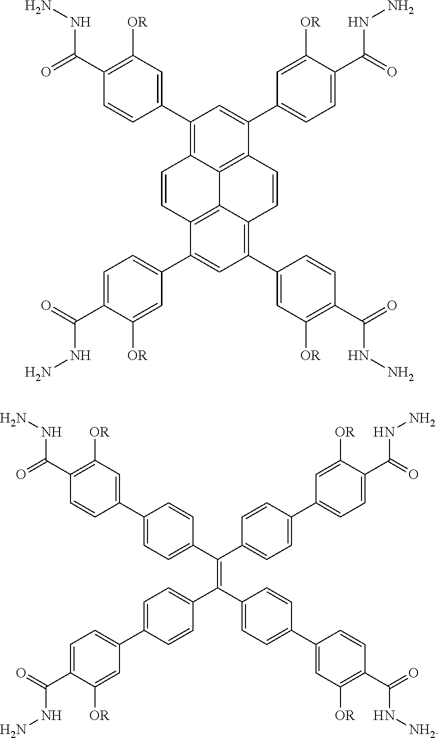

34. The method according to claim 31, wherein the optionally substituted 2-alkoxybenzohydrazidyl moiety is 2-propoxybenzohydrazidyl, 2-allyloxybenzohydrazidyl, 2-propargyloxybenzohydrazidyl or 2-benzyloxybenzohydrazidyl.

35. The method according to claim 31, wherein the second monomer is selected from:

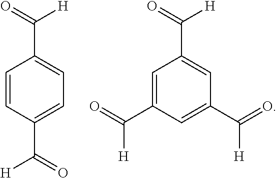

36. The method according to claim 31, wherein the stirring is performed under heat at not less than 100° C.

37. The method according to claim 31, wherein stirring is performed in the presence of 17M acetic acid at about 1:50 (V/Vₛₒₗᵥₑₙₜ).

38. A method of fabricating a covalent organic framework (COF), comprising:
stirring a first monomer comprising an optionally substituted 2-alkoxybenzohydrazidyl moiety with second monomer comprising a benzaldehydyl moiety under heat and in open air for at least 15 min in order to form an acylhydrazone bond;
wherein the COF is formable after about 15 min;
wherein the first monomer and the second monomer has a total topicity of at least 5;
wherein the first monomer and the second monomer both independently have a conjugated pi bond system; and
wherein the optionally substituted 2-alkoxybenzohydrazidyl moiety is selected from optionally substituted 2-(C₁-C₆)alkoxybenzohydrazidyl or 2-benzyloxybenzohydrazidyl.

39. The method according to claim 38, wherein first monomer is selected from one of the following: 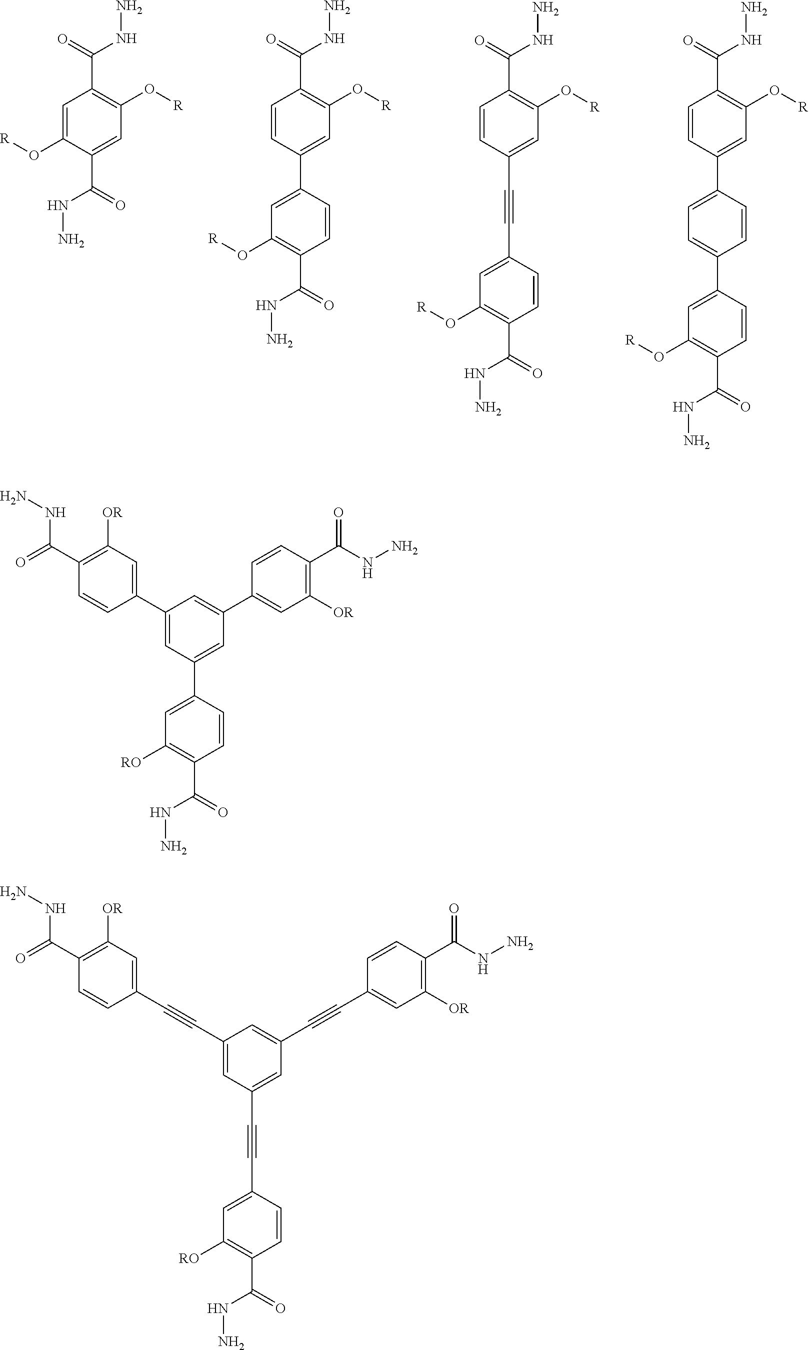 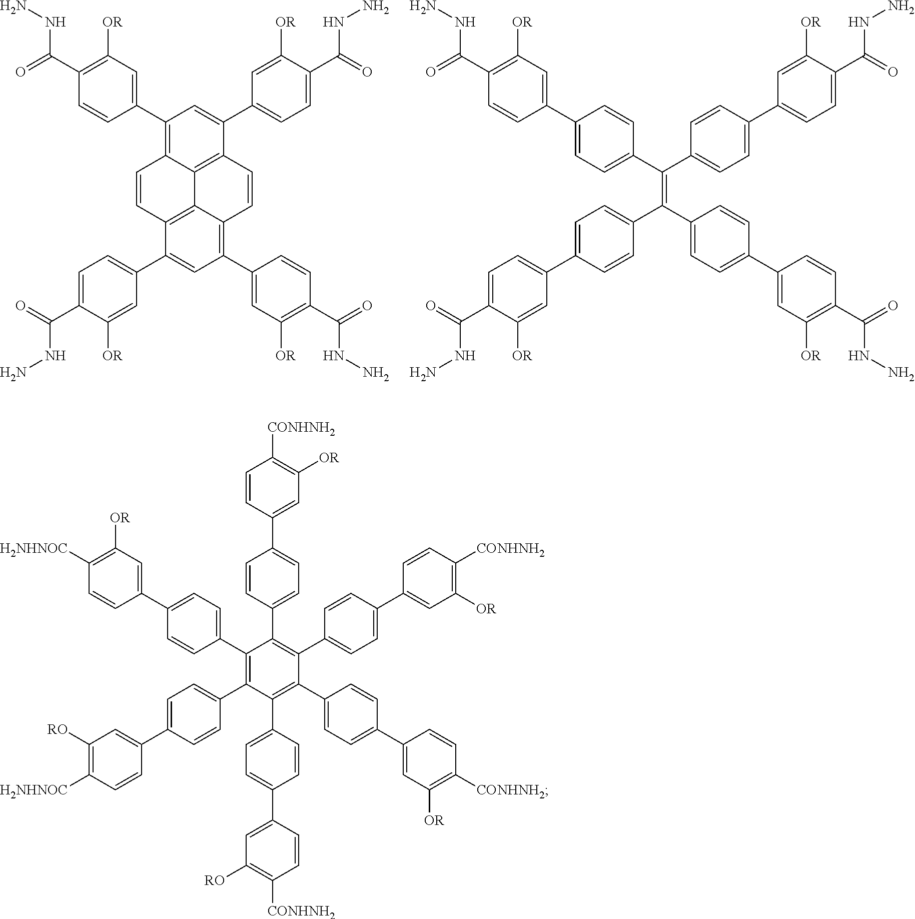
wherein R is optionally substituted (C₃-C₆)alkyl or optionally substituted benzyl.

40. The method according to claim 38, wherein the optionally substituted 2-alkoxybenzohydrazidyl moiety is selected from 2-propoxybenzohydrazidyl, 2-allyloxybenzohydrazidyl, 2-propargyloxybenzohydrazidyl, 2-benzyloxybenzohydrazidyl, and 2-(ethylthio)propoxybenzohydrazidyl.

41. The method according to claim 38, wherein the second monomer is selected from: 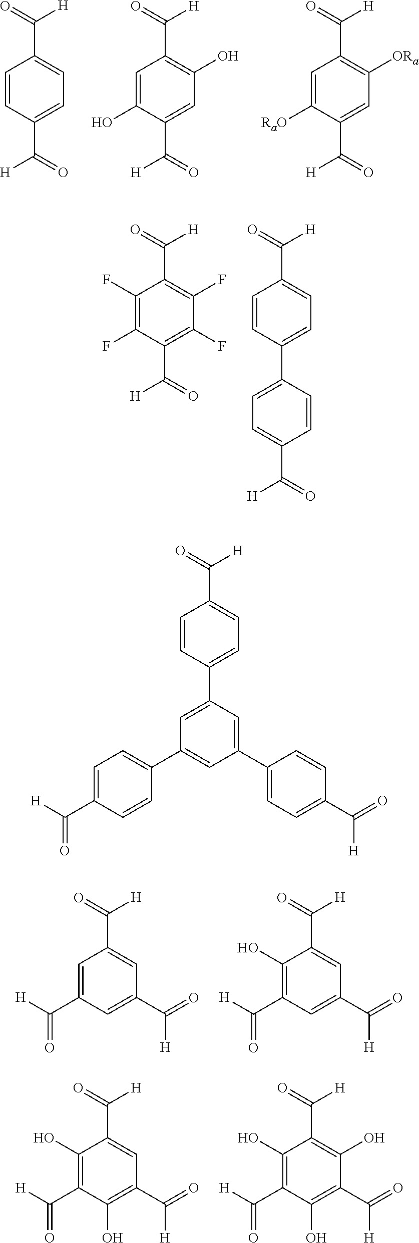 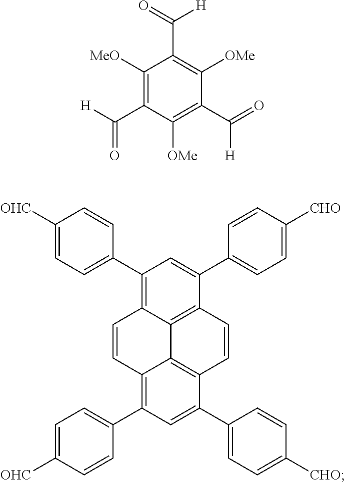
wherein Rₐ is optionally substituted C₁-C₆ alkyl.

42. The method according to claim 38, wherein the stirring is performed in the presence of acetic acid from about 1:20 (V/Vₛₒₗᵥₑₙₜ) to about 1:100 (V/Vₛₒₗᵥₑₙₜ).

43. The method according to claim 38, wherein the stirring is performed in the presence of acetic acid, the acetic acid having a concentration of about 1 M to about 17 M.

44. The method according to claim 38, wherein the first monomer and the second monomer have a combined concentration of about 15 g L⁻¹ to about 60 g L⁻¹.

45. The method according to claim 38, wherein the stirring is performed under heat of about 60° C. to about 200° C.

46. The method according to claim 38, wherein the stirring is performed in an aprotic non-polar solvent selected from 1,2-dichlorobenzene or mesitylene.

47. The method according to claim 38, wherein solvent is added at a hydrazide:solvent mole ratio of about 1:200 to about 1:400.

48. The method according to claim 38, wherein the stirring is performed in an aromatic solvent selected from toluene, xylenes, mesitylene, mono, di and trichlorobenzene, or a combination thereof, or in a polar protic solvent selected from water, C₁-C₄ alcohols, or a combination thereof, or in a solvent mixture, the solvent mixture selected from mesitylene/1,4-dioxane, ortho-dichlorobenzene (o-DCB)/n-butanol and mesitylene/acetonitrile.

49. A covalent organic framework (COF) comprising an optionally substituted 2-alkoxybenzohydrazonylene moiety of Formula (Ia): 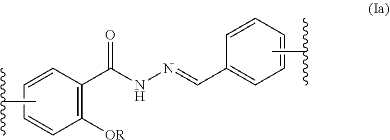
wherein R is optionally substituted (C₁-C₆)alkyl or benzyl; and
wherein [symbol] represents a linkage to the rest of the COF; and
wherein the COF has a x-ray diffraction 2-theta peak at about 3° with a full width half maximum (FWHM) of about 0.2° to about 0.4°.

50. The COF according to claim 49, selected from one of the following: [symbol]
wherein R is selected from propyl, allyl, propargyl or benzyl, or [symbol]
